(19) United States
(12) Patent Application Publication
(10) Pub. No.: US 2023/0199611 A1
(43) Pub. Date: Jun. 22, 2023

(54) POSITIONING ROUTERS OF A NETWORK AROUND NOISE SOURCES

(71) Applicant: Lutron Technology Company LLC, Coopersburg, PA (US)

(72) Inventors: Ankit Bhutani, Aston, PA (US); Richard S. Camden, Coopersburg, PA (US); Vidur Garg, Allentown, PA (US); Prasad P. Kulkarni, Allentown, PA (US)

(73) Assignee: Lutron Technology Company LLC, Coopersburg, PA (US)

(21) Appl. No.: 17/925,532

(22) PCT Filed: May 15, 2021
(86) PCT No.: PCT/US2021/032647

§ 371 Date: Nov. 15, 2022

Related U.S. Application Data
(60) Provisional application No. 63/025,861, filed on May 15, 2020.

(51) Int. Cl. H04W 40/16; H04W 40/24; H04W 40/20

(52) U.S. Cl. CPC H04W 40/16; H04W 40/20; H04W 40/244; H04W 84/18

(57) ABSTRACT

A load control system may include control devices configured to communicate via a network. The network may include router devices (e.g., a leader device and other router devices) for enabling communication of messages throughout the network. Boundary router devices may be assigned to assist with communications around a noise source. The boundary router devices may be identified as being outside of a first range from the noise source and within a second range from the noise source. Control device within the first range that are closer to the noise source may be assigned as end devices. The boundary router devices that are outside of the first range may be close enough to the end devices within the first range to assist the end devices with communication around the noise source.

### CROSS-REFERENCE TO RELATED APPLICATIONS

This application claims the benefit of U.S. Provisional Pat. Application No. 63/025,861, filed May 15, 2020, the contents of which is incorporated herein by reference in its entirety.

### BACKGROUND

A user environment, such as a residence or an office building, for example, may be configured using various types of load control systems. A lighting control system may be used to control the lighting loads providing artificial light in the user environment. A motorized window treatment control system may be used to control the natural light provided to the user environment. A heating, ventilation, and air conditioning (HVAC) system may be used to control the temperature in the user environment.

Each load control system may include various control devices, including input devices and load control devices. The control devices may receive messages, which may include load control instructions, for controlling an electrical load from one or more of the input devices. The control devices may be capable of directly controlling an electrical load. The input devices may be capable of indirectly controlling the electrical load via the load control device. Examples of load control devices may include lighting control devices (e.g., a dimmer switch, an electronic switch, a ballast, or a light-emitting diode (LED) driver), a motorized window treatment, a temperature control device (e.g., a thermostat), an AC plug-in load control device, and/or the like. Examples of input devices may include remote control devices, occupancy sensors, daylight sensors, glare sensors, color temperature sensors, temperature sensors, and/or the like. Remote control devices may receive user input for performing load control.

### SUMMARY

A load control system may include control devices configured to communicate via a network. The network may include router devices (e.g., a leader device and other router devices) for enabling communication of messages throughout the network. A control device may operate as a router device in the network. The control device may receive advertisement messages from the leader device. Based on the receipt of the advertisement messages from the leader device, the control device may determine the health of the network.

Boundary router devices may be assigned to assist with communications around a noise source. The boundary router devices may be identified as being outside of a first range from the noise source and within a second range from the noise source. Control device within the first range that are closer to the noise source may be assigned as end devices. The boundary router devices that are outside of the first range may be close enough to the end devices within the first range to assist the end devices with communication around the noise source.

The role of the router devices and the role of the end devices may be assigned in response to a user selection on a graphical user interface. A mobile device may display the first range and the second range on the graphical user interface. The first range may have a first radius. The second range may be defined by the first radius and a second radius. The role of the router devices and the role of the end devices may be defined prior to a commissioning procedure and stored in configuration data for being uploaded to control devices during the commissioning procedure. The configuration data may be uploaded from a processing device executing design software to a mobile device configured to utilize the configuration data during the commissioning procedure.

The role of the end devices may be automatically assigned to control devices. For example, the role of router device may be automatically assigned in the design software after identifying the control devices as being within the first range. The role of the router devices may be automatically assigned to control devices after identifying the control devices as being closer to other control devices in the network that are outside of the second range than other control devices in the network that are also outside of the first range and within the second range.

The roles of the control devices may be assigned based on the signal strength of radio frequency (RF) signals transmitted to and/or received from the control devices. The control devices in the first range may be identified based on a received signal strength of respective control device beacon messages from the control devices in the first range. The control devices in the second range may be identified based on a received signal strength of respective control device beacon messages from the control devices in the second range. A locating beacon message may be transmitted from an identifying device that is configured to trigger the transmission of the control device beacon messages from the control device.

After a control device is assigned the role of the router device a keepout distance may be identified from the control device. A second control device may be assigned as a router device after determining that the second control device is at least the keepout distance from the first control device in the network. The keepout distance may be used to space the router devices a predefined distance around the noise source.

The roles of the control devices may be assigned based on measurement data from the control devices. The measurement data may include a communication quality metric associated with background noise levels and/or messages received at the control devices. Thresholds may be defined for being compared to the communication quality metrics in the measurement data to determine the control devices in the first range or the second range for being assigned different roles.

### BRIEF DESCRIPTION OF THE DRAWINGS

FIG. 1A is a diagram of an example load control system.

FIG. 1B is a block diagram illustrating an example of a device capable of processing and/or communication in a load control system, such as the load control system of FIG. 1A.

FIG. 1C is a block diagram illustrating an example of a load control device capable of operating in a load control system, such as the load control system of FIG. 1A.

FIG. 2A is a diagram of an example network that may allow for communication between devices in the load control system of FIG. 1A.

FIG. 2B is a diagram of example networks or network partitions (e.g., networks or subnetworks) that allow for communication between devices in the load control system of FIG. 1A.

FIGS. 2C and 2D are diagrams of another example network that allows for communication between devices in the load control system of FIG. 1A.

FIG. 2E is a diagram of another example network that illustrates the cost and network overhead associated with communication between the devices in the load control system of FIG. 1A.

FIG. 2F is an example table that illustrates example link costs that may correspond to different link qualities on a network communication link.

FIG. 3 is a system diagram illustrating a representative control system for configuring and/or controlling one or more control devices.

FIG. 4 is a flowchart depicting an example procedure (e.g., a commissioning procedure) for commissioning a control system.

FIG. 5 is a top view of an example space of a building showing the locations of lighting fixtures and noise sources.

FIG. 6A is a flowchart of an example procedure (e.g., a router adjustment procedure) that may be executed to assign control devices to operate as router devices based on their distance from noise sources in the space in which the network is deployed.

FIG. 6B illustrates a sequence flow diagram illustrating example messages transmitted between an identifying device and control devices.

FIG. 7 is a flowchart of an example procedure (e.g., a router adjustment procedure) that may be executed to assign control devices of a network that may be located close to and/or within a predefined transmission range of noise sources to be end devices or router devices prior to installation and/or commissioning of the control devices.

FIG. 8 is a flowchart of an example procedure (e.g., a router adjustment procedure) that may be executed to assign control devices of a network that may be located close to and/or within a predefined transmission range of noise sources to be end devices or router devices after installation and/or commissioning of the control devices.

FIGS. 9A and 9B are a flowcharts of example procedures (e.g., a router adjustment procedures) that may be executed to assign roles to control devices of a network (e.g., that may be located close to or within a predefined transmission range of noise sources).

### DETAILED DESCRIPTION

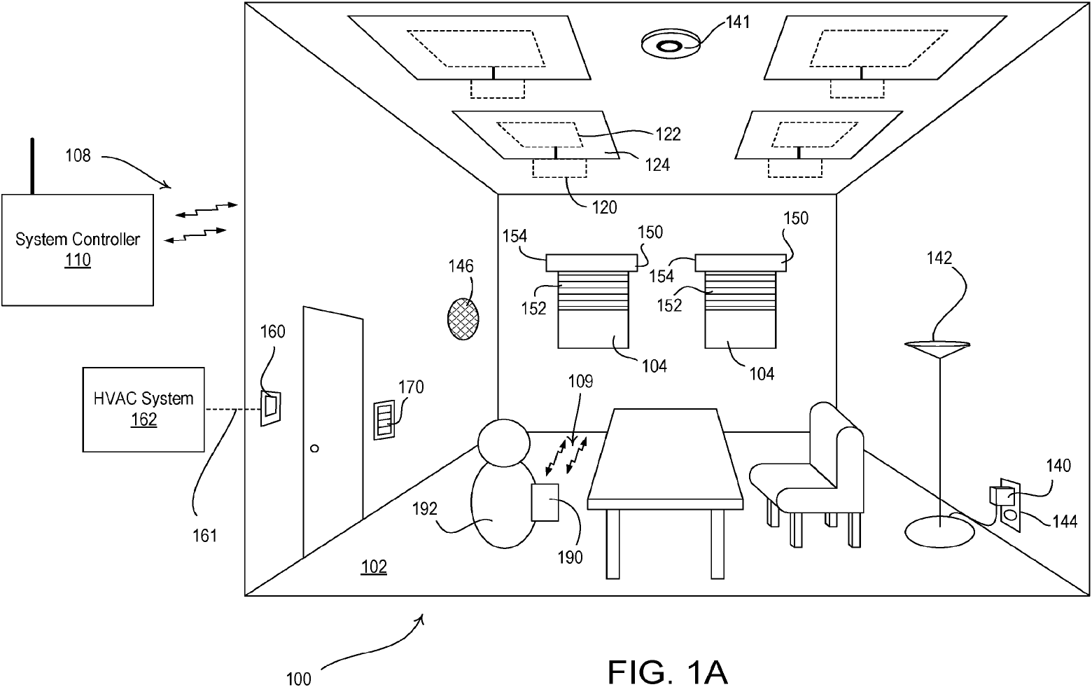

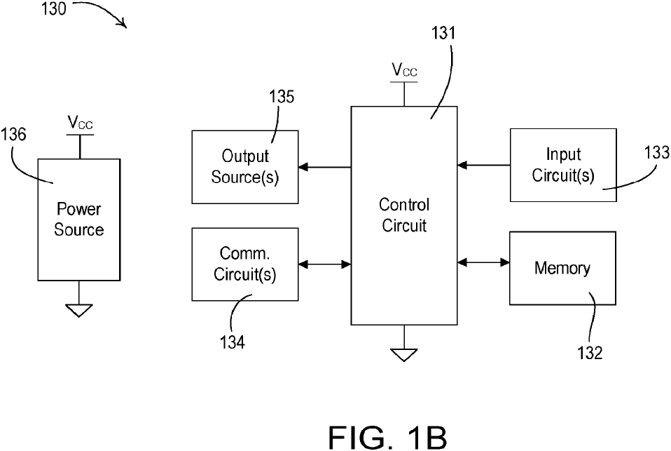

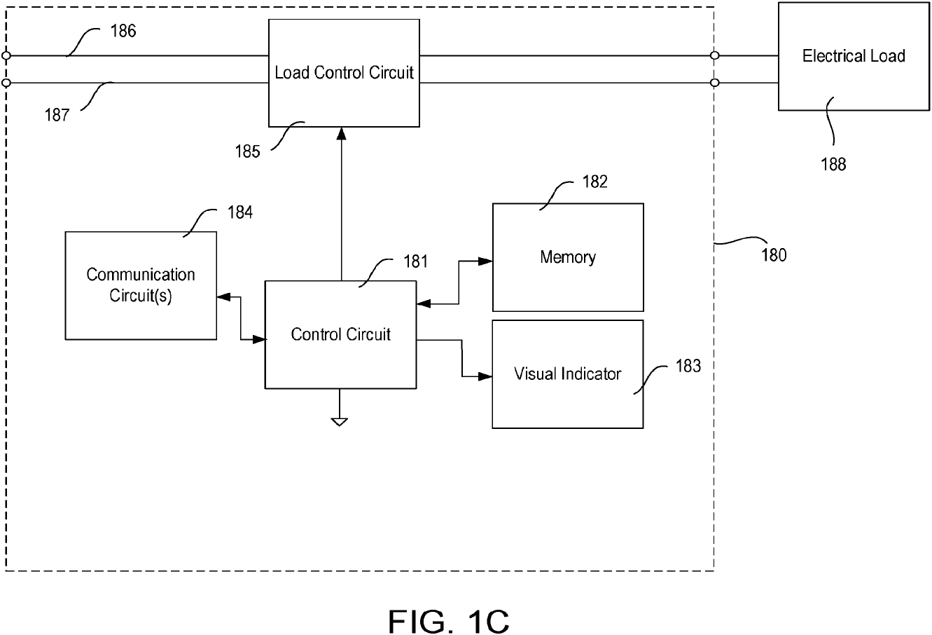

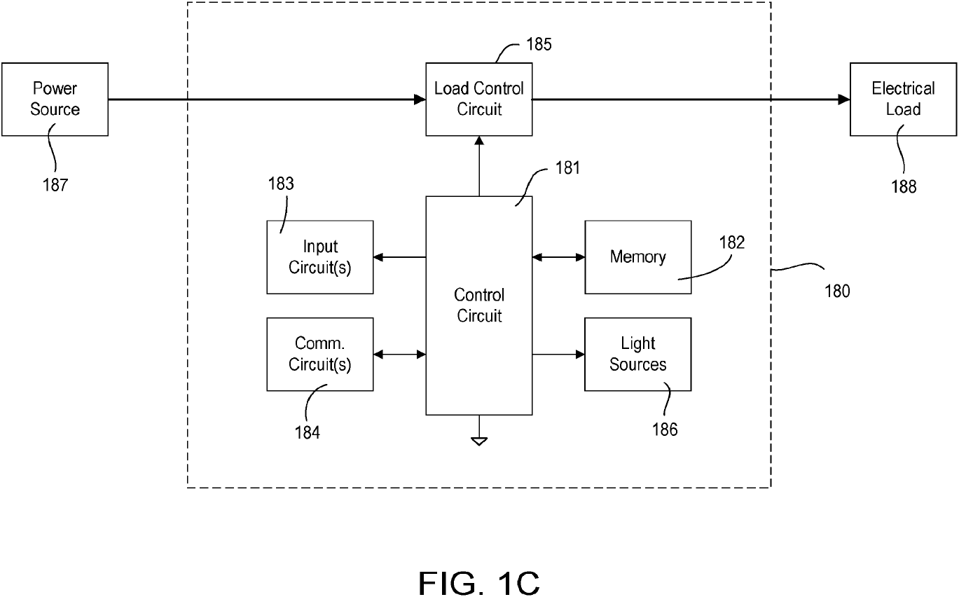

FIG. 1A is a diagram of an example load control system 100 for controlling the amount of power delivered from an alternating-current (AC) power source (not shown) to one or more electrical loads. The load control system 100 may be installed in a load control environment 102. The load control environment 102 may include a space in a residential or commercial building. For example, the load control system 100 may be installed in one or more rooms on one or more floors in the building.

The load control system 100 may comprise a plurality of control devices. The control devices may include load control devices that are configured to control one or more electrical loads in the load control environment 102 (also referred to as a user environment). For example, the load control devices may control the one or more electrical loads in response to input from one or more input devices or other devices in the load control system 100.

The load control devices in the load control system 100 may include lighting control devices. For example, the load control system 100 may include lighting control devices 120 for controlling lighting loads 122 in a corresponding lighting fixture 124. The lighting control devices 120 may comprise light-emitting diode (LED) drivers and the lighting loads 122 may comprise LED light sources. While each lighting fixture 124 is shown having a single lighting load 122, each lighting fixture may comprise one or more individual light sources (e.g., lamps and/or LED emitters) that may be controlled individually and/or in unison by the respective lighting control device. Though an LED driver is provided as an example lighting control device, other types of lighting control devices may be implemented as load control devices in the load control system 100. For example, the load control system 100 may comprise dimmer switches, electronic dimming ballasts for controlling fluorescent lamps, or other lighting control devices for controlling corresponding lighting loads. The lighting control device 120 may be configured to directly control an amount of power provided to the lighting load 122. The lighting control device 120 may be configured to receive (e.g., via wired or wireless communications) messages via radio-frequency (RF) signals 108, 109 and to control the lighting load 122 in response to the received messages. One will recognize that lighting control device 120 and lighting load 122 may be integral and thus part of the same fixture or bulb, for example, or may be separate.

The load control devices in the load control system 100 may comprise one or more appliances that are able to receive the RF signals 108 (e.g., wireless signals) for performing load control. In an example, the load control system may include a speaker 146 (e.g., part of an audio/visual or intercom system), which is able to generate audible sounds, such as alarms, music, intercom functionality, etc. in response to RF signals 108.

The load control devices in the load control system 100 may comprise one or more daylight control devices, e.g., motorized window treatments 150, such as motorized cellular shades, for controlling the amount of daylight entering the load control environment 102. Each motorized window treatment 150 may comprise a window treatment fabric 152 hanging from a headrail 154 in front of a respective window 104. Each motorized window treatment 150 may further comprise a motor drive unit (not shown) located inside of the headrail 154 for raising and lowering the window treatment fabric 152 for controlling the amount of daylight entering the load control environment 102. The motor drive units of the motorized window treatments 150 may be configured to receive messages via the RF signals 108 and adjust the position of the respective window treatment fabric 152 in response to the received messages. For example, the motorized window treatments may be battery-powered. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Examples of battery-powered motorized window treatments are described in greater detail in U.S. Pat. No. 8,950,461, issued Feb. 10, 2015, entitled MOTORIZED WINDOW TREATMENT, and U.S. Pat. No. 9,488,000, issued Nov. 8, 2016, entitled INTEGRATED ACCESSIBLE BATTERY COMPARTMENT FOR MOTORIZED WINDOW TREATMENT, the entire disclosures of which are hereby incorporated by reference.

The load control devices in the load control system 100 may comprise a plug-in load control device 140 for controlling a plug-in electrical load, e.g., a plug-in lighting load (such as a floor lamp 142 or a table lamp) and/or an appliance (such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108 and to turn on and off or adjust the intensity of the floor lamp 142 in response to the received messages.

The load control devices in the load control system 100 may comprise one or more temperature control devices, e.g., a thermostat 160 for controlling a room temperature in the load control environment 102. The thermostat 160 may be coupled to a heating, ventilation, and air conditioning (HVAC) system 162 via a control link 161 (e.g., an analog control link or a wired digital communication link). The thermostat 160 may be configured to wirelessly communicate messages with a controller of the HVAC system 162. The thermostat 160 may comprise a temperature sensor for measuring the room temperature of the load control environment 102 and may control the HVAC system 162 to adjust the temperature in the room to a setpoint temperature. The load control system 100 may comprise one or more wireless temperature sensors (not shown) located in the load control environment 102 for measuring the room temperatures. The HVAC system 162 may be configured to turn a compressor on and off for cooling the load control environment 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the load control environment 102. The thermostat 160 may be configured to receive messages via the RF signals 108 and adjust heating, ventilation, and cooling in response to the received messages.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off; a controllable electrical receptacle, or controllable power strip for controlling one or more plug-in loads; a motor control unit for controlling a motor load, such as a ceiling fan or an exhaust fan; a drive unit for controlling a projection screen; motorized interior or exterior shutters; a thermostat for a heating and/or cooling system; a temperature control device for controlling a setpoint temperature of an HVAC system; an air conditioner; a compressor; an electric baseboard heater controller; a controllable damper; a variable air volume controller; a fresh air intake controller; a ventilation controller; a hydraulic valves for use radiators and radiant heating system; a humidity control unit; a humidifier; a dehumidifier; a water heater; a boiler controller; a pool pump; a refrigerator; a freezer; a television or computer monitor; a video camera; an audio system or amplifier; an elevator; a power supply; a generator; an electric charger, such as an electric vehicle charger; and/or an alternative energy controller.

The load control system 100 may comprise one or more input devices capable of receiving an input event for controlling one or more load control devices in the load control system 100. The input devices and the load control devices may be collectively referred to as control devices in the load control system 100. The input devices in the load control system 100 may comprise one or more remote control devices, such as a remote control device 170. The remote control device may be battery-powered. The remote control device 170 may be configured to transmit messages via RF signals 108 to one or more other devices in the load control system 100 in response to an input event, such as an actuation of one or more buttons or a rotation of a rotary knob of the remote control device 170. For example, the remote control device 170 may transmit messages to the lighting control device 120, the plug-in load control device 140, the motorized window treatments 150, and/or the temperature control device 160 via the RF signals 108 in response to actuation of one or more buttons located thereon. The remote control device 170 may also communicate with other devices in the load control system 100 via a wired communication link. In response to an input event at the remote control device 170, a devices to which the remote control device 170 is wired may be triggered to transmit messages to one or more other devices in the load control system 100. The remote control device 170 may comprise a keypad. In another example, the remote control device 170 may comprise a rotary knob configured to transmit messages to one or more other devices in response to a rotation on the rotary knob (e.g., rotation of a predefined distance or for a predefined period of time). The remote control device 170 may be mounted to a structure, such as a wall, a toggle actuator of a mechanical switch, or a pedestal to be located on a horizontal surface. In another example, the remote control device 170 may be handheld. The remote control device 170 may provide feedback (e.g., visual feedback) to a user of the remote control device 170 on a visual indicator, such as a status indicator. The status indicator may be illuminated by one or more light emitting diodes (LEDs) for providing feedback. The status indicator may provide different types of feedback. The feedback may include feedback indicating actuations by a user or other user interface event, a status of electrical loads being controlled by the remote control device 170, and/or a status of the load control devices being controlled by the remote control device 170. The feedback may be displayed in response to user interface event and/or in response to messages received that indicate the status of load control devices and/or electrical loads. Examples of battery-powered remote control devices are described in greater detail in commonly-assigned U.S. Pat. No. 8,330,638, issued Dec. 11, 2012, entitled WIRELESS BATTERY-POWERED REMOTE CONTROL HAVING MULTIPLE MOUNTING MEANS, and U.S. Pat. Application Publication No. 2012/0286940, published Nov. 15, 2012, entitled CONTROL DEVICE HAVING A NIGHTLIGHT, the entire disclosures of which are hereby incorporated by reference.

The input devices of the load control system 100 may comprise one or more sensor devices, such as a sensor device 141. The sensor device 141 may be configured to transmit messages via the RF signals 108 to one or more other devices in the load control system 100 in response to an input event, such as a sensor measurement event. The sensor device 141 may also or alternatively be configured to transmit messages via a wired communication link to one or more other devices in the load control system 100 in response to an input event, such as a sensor measurement event. The sensor device 141 may operate as an ambient light sensor or a daylight sensor and may be capable of performing a sensor measurement event by measuring a total light intensity in the space around the sensor device 141. The sensor device 141 may transmit messages including the measured light level or control instructions in response to the measured light level via the RF signals 108. Examples of RF load control systems having daylight sensors are described in greater detail in commonly assigned U.S. Pat. No. 8,410,706, issued Apr. 2, 2013, entitled METHOD OF CALIBRATING A DAYLIGHT SENSOR; and U.S. Pat. No. 8,451,116, issued May 28, 2013, entitled WIRELESS BATTERY POWERED DAYLIGHT SENSOR, the entire disclosures of which are hereby incorporated by reference.

The sensor device 141 may operate as an occupancy sensor configured to detect occupancy and vacancy conditions in the load control environment 102. The sensor device 141 may be capable of performing the sensor measurement event by measuring an occupancy condition or a vacancy condition in response to occupancy or vacancy, respectively, of the load control environment 102 by the user 192. For example, the sensor device 141 may comprise an infrared (IR) sensor capable of detecting the occupancy condition or the vacancy condition in response to the presence or absence, respectively, of the user 192. The sensor device 141 may transmit messages including the occupancy conditions or vacancy conditions, or control instructions generated in response to the occupancy/vacancy conditions, via the RF signals 108. Again, the sensor device 141 may also or alternatively transmit messages including the occupancy conditions or vacancy conditions, or control instructions generated in response to the occupancy/vacancy conditions via a wired communication link. Examples of load control systems having occupancy and vacancy sensors are described in greater detail in commonly-assigned U.S. Pat. No. 8,228,184, issued Jul. 24, 2012, entitled BATTERY-POWERED OCCUPANCY SENSOR, U.S. Pat. No. 8,009,042, issued Aug. 30, 2011 Sep. 3, 2008, entitled RADIO-FREQUENCY LIGHTING CONTROL SYSTEM WITH OCCUPANCY SENSING, and U.S. Pat. No. 8,199,010, issued Jun. 12, 2012, entitled METHOD AND APPARATUS FOR CONFIGURING A WIRELESS SENSOR, the entire disclosures of which are hereby incorporated by reference.

The sensor device 141 may operate as a visible light sensor (e.g., including a camera or other device capable of sensing visible light). The sensor device 141 may be capable of performing the sensor measurement event by measuring an amount of visible light within the load control environment 102. For example, the sensor device 141 may comprise a visible light sensing circuit having an image recording circuit, such as a camera, and an image processing circuit. The image processing circuit may comprise a digital signal processor (DSP), a microprocessor, a programmable logic device (PLD), a microcontroller, an application specific integrated circuit (ASIC), a field-programmable gate array (FPGA), or any suitable processing device capable of processing images or levels of visible light. The sensor device 141 may be positioned towards the load control environment 102 to sense one or more environmental characteristics in the load control environment 102. The image recording circuit of the sensor device 141 may be configured to capture or record an image. The image recording circuit of the sensor device 141 may provide the captured image to the image processor. The image processor may be configured to process the image into one or more sensed signals that are representative of the sensed environmental characteristics. The sensed environmental characteristics may be interpreted from the sensed signals by the control circuit of the sensor device 141 or the sensed signals may be transmitted to one or more other devices via the RF signals 108, 109 (e.g., a computing device in the load control environment) for interpreting the sensed environmental characteristics. For example, the sensed environmental characteristics interpreted from the sensed signals may comprise an occurrence of movement, an amount of movement, a direction of movement, a velocity of movement, a counted number of occupants, an occupancy condition, a vacancy condition, a light intensity, a color of visible light, a color temperature of visible light, an amount of direct sunlight penetration, or another environmental characteristic in the load control environment 102. In another example, the sensor device 141 may provide a raw image or a processed (e.g., preprocessed) image to one or more other devices (e.g., computing devices) in the load control system 100 for further processing. The sensor device 141 may operate as a color temperature sensor when sensing the color temperature of the visible light. Examples of load control systems having visible light sensors are described in greater detail in commonly-assigned U.S. Pat. No. 10,264,651, issued Apr. 16, 2019, entitled LOAD CONTROL SYSTEM HAVING A VISIBLE LIGHT SENSOR, and U.S. Pat. App. Pub. No. 2018/0167547, published Jun. 14, 2018, entitled CONFIGURATION OF A VISIBLE LIGHT SENSOR, the entire disclosures of which are hereby incorporated by reference.

The sensor device 141 may be external to the lighting fixtures 124 (e.g., affixed or attached to a ceiling or a wall of the load control environment 102). The sensor device 141 may be positioned towards the load control environment 102 and may be capable of performing sensor measurement events in the load control environment 102. In one example, the sensor device 141 may be affixed or attached to a window 104 of the load control environment 102 and operate as a window sensor that is capable performing sensor measurement events on light that is entering the load control environment 102 through the window 104. For example, the sensor device 141 may comprise an ambient light sensor capable of detecting when sunlight is directly shining into the sensor device 141, is reflected onto the sensor device 141, and/or is blocked by external means, such as clouds or a building based on the measured light levels being received by the sensor device 141 from outside the window. The sensor device 141 may send messages indicating the measured light level. Though illustrated as being external to the lighting fixtures 124, one or more sensor devices 141 may be mounted to one or more of the lighting fixtures 124 (e.g., on a lower or outward-facing surface of the lighting fixture 124). For example, one or more sensor devices 141 may be electrically coupled to a control circuit or a load control circuit of the load control devices 120 for performing control in response to the sensor measurement events of the sensor devices 141.

The load control system 100 may comprise other types of input devices, such as, for example, temperature sensors, humidity sensors, radiometers, cloudy-day sensors, shadow sensors, pressure sensors, smoke detectors, carbon monoxide detectors, air-quality sensors, motion sensors, security sensors, proximity sensors, fixture sensors, partition sensors, keypads, multi-zone control units, slider control units, kinetic or solar-powered remote controls, key fobs, cell phones, smart phones, tablets, personal digital assistants, personal computers, laptops, timeclocks, audio-visual controls, safety devices, power monitoring devices (e.g., such as power meters, energy meters, utility submeters, utility rate meters, etc.), central control transmitters, residential, commercial, or industrial controllers, and/or any combination thereof.

The input devices and the load control devices may be configured to communicate messages between one another on a communication link within the load control system 100. The communication link between control devices in the load control system may comprise one or more network communication links through which messages may be transmitted for performing end-to-end communications in the load control system 100. For example, the input devices and the load control devices may be capable of communicating messages directly to one another via the RF signals 108. The RF signals 108 may be transmitted using a proprietary RF protocol, such as the CLEAR CONNECT protocol (e.g., CLEAR CONNECT TYPE A and/or CLEAR CONNECT TYPE X protocols). Alternatively, the RF signals 108 may be transmitted using a different RF protocol, such as, a standard protocol, for example, one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, near-field communication (NFC), for a different protocol. In an example, the input devices may transmit messages to the load control devices via the RF signals 108 that comprise input events (e.g., button presses, sensor measurement events, or other input event) or control instructions generated in response to the input events for performing control of the electrical loads controlled by the load control devices. The input devices and the load control devices may be configured to communicate via the RF signals 108 on a first wireless communication link via a first wireless communication protocol (e.g., THREAD, CLEAR CONNECT TYPE A, CLEAR CONNECT TYPE X, WIFI, cellular, etc) and communicate via the RF signals 109 on a second wireless communication link via a second wireless communication protocol (e.g., a short-range wireless communication protocol, such as BLUETOOTH, BLE, NFC, etc.). Though communication links may be described as a wireless communication links, wired communication links may similarly be implemented for enabling communications herein.

For devices in the load control system 100 to recognize messages directed to the device and/or to which to be responsive, the devices may be associated with one another by performing an association procedure. For example, for a load control device to be responsive to messages from an input device, the input device may first be associated with the load control device. As one example of an association procedure, devices may be put in an association mode for sharing a unique identifier for being associated with and/or stored at other devices in the load control system 100. For example, an input device and a load control device may be put in an association mode by the user 192 actuating a button on the input device and/or the load control device. The actuation of the button on the input device and/or the load control device may place the input device and/or the load control device in the association mode for being associated with one another. In the association mode, the input device may transmit an association message(s) to the load control device (directly or through one or more other devices as described herein). The association message from the input device may include a unique identifier of the input device. The load control device may locally store the unique identifier of the input device in association information, such that the load control device may be capable of recognizing messages (e.g., subsequent messages) from the input device that may include load control instructions or commands. The association information stored at the load control device may include the unique identifiers of the devices with which the load control device is associated. The load control device may be configured to respond to the messages from the associated input device by controlling a corresponding electrical load according to the load control instructions received in the messages. The input device may also store the unique identifier of the load control device with which it is being associated in association information stored locally thereon. A similar association procedure may be performed between other devices in the load control system 100 to enable each device to perform communication of messages with associated devices. This is merely one example of how devices may communicate and be associated with one another and other examples are possible.

According to another example, one or more devices may receive system configuration data (e.g., or subsequent updates to the system configuration data) that is uploaded to the devices and that specifies the association information comprising the unique identifiers of the devices for being associated. The system configuration data may comprise a load control dataset that defines the devices and operational settings of the load control system 100. The system configuration data may include information about the devices in the user environment 102 and/or the load control system 100, including configuration identifiers (e.g., fixture identifiers or load control device identifiers, groups, zones, areas, and/or location identifiers) of the control devices. For example, the system configuration data may include association information that indicates defined associations between devices in the load control system 100. The association information may be updated using any of the association procedures described herein.

One or more intermediary devices may also maintain association information that includes the unique identifiers that make up the associations of other devices in the load control system 100. For example, the input devices and the load control devices may communicate on a communication link in the load control system 100 through one or more other intermediary devices, such as router devices or other devices in a network. The intermediary devices may comprise input devices, load control devices, a central processing device, or another intermediary device capable of enabling communication between devices in the load control system. The association information that is maintained on the intermediary devices may comprise the unique identifiers of the devices that are associated with one another for identifying and/or enabling communication of messages between devices in the load control system 100. For example, an intermediary device may identify the unique identifiers being transmitted in association messages between devices during the association procedure and store the unique identifiers of the devices as an association in the association information. The intermediary devices may use the association information for monitoring and/or routing communications on a communication link between devices in the load control system 100. In another example, the association information of other devices may be uploaded to the intermediary device and/or communicated from the intermediary device to the other devices for being locally stored thereon (e.g., at the input devices and/or load control devices).

The load control system 100 may comprise a system controller 110. The system controller 100 may operate as an intermediary device, as described herein. For example, the system controller 110 may operate as a central processing device for one or more other devices in the load control system 100. The system controller 110 may operable to communicate messages to and from the control devices (e.g., the input devices and the load control devices). For example, the system controller 110 may be configured to receive messages from the input devices and transmit messages to the load control devices in response to the messages received from the input devices. The system controller 110 may route the messages based on the association information stored thereon. The input devices, the load control devices, and the system controller 110 may be configured to transmit and receive the RF signals 108 and/or over a wired communication link. The system controller 110 may be coupled to one or more networks, such as a wireless or wired local area network (LAN), e.g., for access to the Internet. The system controller 110 may be wirelessly connected to the networks using one or more wireless protocols. The system controller 110 may be coupled to the networks via a wired communication link, such as a network communication bus (e.g., an Ethernet communication link).

The system controller 110 may be configured to communicate via the network with one or more computing devices, e.g., a mobile device 190, such as, a personal computing device and/or a wearable wireless device. The mobile device 190 may be located on an occupant 192, for example, may be attached to the occupant’s body or clothing or may be held by the occupant. The mobile device 190 may be characterized by a unique identifier (e.g., a serial number or address stored in memory) that uniquely identifies the mobile device 190 and thus the occupant 192. Examples of personal computing devices may include a smart phone, a laptop, and/or a tablet device. Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.).

The mobile device 190 may be configured to transmit messages to the system controller 110, for example, in one or more Internet Protocol packets. For example, the mobile device 190 may be configured to transmit messages to the system controller 110 over the LAN and/or via the Internet. The mobile device 190 may be configured to transmit messages over the Internet to an external service, and then the messages may be received by the system controller 110. The mobile device 190 may transmit and receive RF signals 109. The RF signals 109 may be the same signal type and/or transmitted using the same protocol as the RF signals 108. Alternatively, or additionally, the mobile device 190 may be configured to transmit RF signals according to another signal type and/or protocol. The mobile device 190 and/or the system controller 110 may be capable of communicating on communication links with other devices via RF signals 108, 109.

The load control system 100 may comprise other types of computing devices coupled to the network, such as a desktop personal computer (PC), a wireless-communication-capable television, or any other suitable Internet-Protocol-enabled device. Examples of load control systems operable to communicate with mobile and/or computing devices on a network are described in greater detail in commonly-assigned U.S. Pat Application Publication No. 2013/0030589, published Jan. 31, 2013, entitled LOAD CONTROL DEVICE HAVING INTERNET CONNECTIVITY, the entire disclosure of which is hereby incorporated by reference.

The operation of the load control system 100 may be programmed and configured using, for example, the mobile device 190 or other computing device (e.g., when the mobile device is a personal computing device). The mobile device 190 may execute a graphical user interface (GUI) configuration software for allowing a user 192 to program how the load control system 100 will operate. For example, the configuration software may run as a PC application or a web interface. The configuration software and/or the system controller 110 (e.g., via instructions from the configuration software) may generate the system configuration data that may include the load control dataset that defines the operation of the load control system 100. For example, the load control dataset may include information regarding the operational settings of different load control devices of the load control system (e.g., the lighting control device 120, the plug-in load control device 140, the motorized window treatments 150, and/or the thermostat 160). The load control dataset may comprise information regarding how the load control devices respond to inputs received from the input devices. Examples of configuration procedures for load control systems are described in greater detail in commonly-assigned U.S. Pat. No. 7,391,297, issued Jun. 24, 2008, entitled HANDHELD PROGRAMMER FOR A LIGHTING CONTROL SYSTEM; U.S. Pat. Application Publication No. 2008/0092075, published Apr. 17, 2008, entitled METHOD OF BUILDING A DATABASE OF A LIGHTING CONTROL SYSTEM; and U.S. Pat. Application Publication No. 2014/0265568, published Sep. 18, 2014, entitled COMMISSIONING LOAD CONTROL SYSTEMS.

FIG. 1B is a block diagram illustrating an example of a device 130 capable of processing and/or communication in a load control system, such as the load control system 100 of FIG. 1A. In an example, the device 130 may be a control device capable of transmitting or receiving messages. The control device may be in an input device, such as a sensor device 141 (e.g., an occupancy sensor or another sensor device), a remote control device 170, or another input device capable of transmitting messages to load control devices or other devices in the load control system 100. The device 130 may be a computing device, such as the mobile device 190, the system controller 110, a processing device, or another computing device in the load control system 100.

The device 130 may include a control circuit 131 for controlling the functionality of the device 130. The control circuit 131 may include one or more general purpose processors, special purpose processors, conventional processors, digital signal processors (DSPs), microprocessors, integrated circuits, a programmable logic device (PLD), application specific integrated circuits (ASICs), or the like. The control circuit 131 may perform signal coding, data processing, image processing, power control, input/output processing, or any other functionality that enables the device 131 to perform as one of the devices of the load control system (e.g., load control system 100) described herein.

The control circuit 131 may be communicatively coupled to a memory 132 to store information in and/or retrieve information from the memory 132. The memory 132 may comprise a computer-readable storage media or machine-readable storage media that maintains a device dataset of associated device identifiers, network information, and/or computer-executable instructions for performing as described herein. For example, the memory 132 may comprise computer-executable instructions or machine-readable instructions that include one or more portions of a router adjustment procedure for assigning the roles of control devices on a network or a commissioning procedure, as described herein. The control circuit 131 may access the instructions from memory 132 for being executed to cause the control circuit 131 to operate as described herein, or to operate one or more devices as described herein.

The memory 132 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 132 may be implemented as an external integrated circuit (IC) or as an internal circuit of the control circuit 131.

The device 130 may include one or more communication circuits 134 that are in communication with the control circuit 131 for sending and/or receiving information as described herein. The communication circuit 134 may perform wireless and/or wired communications. The communication circuit 134 may be a wired communication circuit capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 134 may be configured to communicate via power lines (e.g., the power lines from which the device 130 receives power) using a power line carrier (PLC) communication technique. The communication circuit 134 may be a wireless communication circuit including one or more RF or infrared (IR) transmitters, receivers, transceivers, or other communication circuits capable of performing wireless communications.

Though a single communication circuit 134 may be illustrated, multiple communication circuits may be implemented in the device 130. The device 130 may include a communication circuit configured to communicate via one or more wired and/or wireless communication networks and/or protocols and at least one other communication circuit configured to communicate via one or more other wired and/or wireless communication networks and/or protocols. For example, a first communication circuit may be configured to communicate via a wired or wireless communication link, while another communication circuit may be capable of communicating on another wired or wireless communication link. The first communication circuit may be configured to communicate via a first wireless communication link (e.g., a wireless network communication link) using a first wireless protocol (e.g., a wireless network communication protocol, such as the CLEAR CONNECT (e.g., CLEAR CONNECT A and/or CLEAR CONNECT X) and/or THREAD protocols), and the second communication circuit may be configured to communicate via a second wireless communication link (e.g., a short-range or direct wireless communication link) using a second wireless protocol (e.g., a short-range wireless communication protocol, such as the BLUETOOTH, BLUETOOTH LOW ENERGY (BLE), or NFC protocols).

One of the communication circuits 134 may comprise a beacon transmitting and/or receiving circuit capable of transmitting and/or receiving beacon messages via a short-range RF signal. The control circuit 131 may communicate with beacon transmitting circuit (e.g., a short-range communication circuit) to transmit beacon messages. The beacon transmitting circuit may communicate beacons via RF communication signals, for example. The beacon transmitting circuit may be a one-way communication circuit (e.g., the beacon transmitting circuit is configured to transmit beacon messages) or a two-way communication circuit capable of receiving information on the same network and/or protocol on which the beacons are transmitted (e.g., the beacon transmitting circuit is configured to transmit and receive beacon messages). The information received at the beacon transmitting circuit may be provided to the control circuit 131.

The control circuit 131 may be in communication with one or more input circuits 133 from which inputs may be received. The input circuits 133 may be included in a user interface for receiving inputs from the user. For example, the input circuits 133 may include an actuator (e.g., a momentary switch that may be actuated by one or more physical buttons) that may be actuated by a user to communicate user input or selections to the control circuit 131. In response to an actuation of the actuator, the control circuit 131 may enter an association mode, transmit association messages from the device 130 via the communication circuits 134, and/or receive other information (e.g., control instructions for performing control of an electrical load). In response to an actuation of the actuator to perform control by transmitting control instructions indicating the actuation on the user interface and/or the control instructions generated in response to the actuation. The actuator may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from a user. The control circuit 131 of the device 130 may enter the association mode, transmit an association message, transmit control instructions, or perform other functionality in response to an actuation or input from the user on the touch sensitive surface.

The input circuits 133 may include a sensing circuit (e.g., a sensor). The sensing circuit may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the device 130). The control circuit 131 may receive information from the one or more input circuits 133 and process the information for performing functions as described herein.

The control circuit 131 may be in communication with one or more output sources 135. The output sources 135 may include one or more indicators (e.g., visible indicators, such as LEDs) for providing indications (e.g., feedback) to a user. The output sources 135 may include a display (e.g., a visible display) for providing information (e.g., feedback) to a user. The control circuit 131 and/or the display may generate a graphical user interface (GUI) generated via software for being displayed on the device 130 (e.g., on the display of the device 130).

The user interface of the device 130 may combine features of the input circuits 133 and the output sources 135. For example, the user interface may have buttons that actuate the actuators of the input circuits 133 and may have indicators (e.g., visible indicators) that may be illuminated by the light sources of the output sources 135. In another example, the display and the control circuit 131 may be in two-way communication, as the display may display information to the user and include a touch screen capable of receiving information from a user. The information received via the touch screen may be capable of providing the indicated information received from the touch screen as information to the control circuit 131 for performing functions or control.

Each of the hardware circuits within the device 130 may be powered by a power source 136. The power source 136 may include a power supply configured to receive power from an alternating-current (AC) power supply or direct-current (DC) power supply, for example. In addition, the power source 136 may comprise one or more batteries. The power source 136 may produce a supply voltage Vcc for powering the hardware within the device 130.

FIG. 1C is a block diagram illustrating an example load control device 180. The load control device 180 may be a lighting control device (e.g., the lighting control device 120), a motorized window treatment (e.g., the motorized window treatments 150), a plug-in load control device (e.g., the plug-in load control device 140), a temperature control device (e.g., the temperature control device 160), a dimmer switch, an electronic switch, an electronic ballast for lamps, and/or another load control device.

The load control device 180 may include a control circuit 181 for controlling the functionality of the load control device 180. The control circuit 181 may include one or more general purpose processors, special purpose processors, conventional processors, digital signal processors (DSPs), microprocessors, integrated circuits, a programmable logic device (PLD), application specific integrated circuits (ASICs), or the like. The control circuit 181 may perform signal coding, data processing, image processing, power control, input/output processing, or any other functionality that enables the load control device 180 to perform as one of the devices of the load control system (e.g., load control system 100) described herein.

The load control device 180 may include a load control circuit 185 that may be electrically coupled in series between a power source 187 (e.g., an AC power source and/or a DC power source) and an electrical load 188. The control circuit 181 may be configured to control the load control circuit 185 for controlling the electrical load 188, for example, in response to received instructions. The electrical load 188 may include a lighting load, a motor load (e.g., for a ceiling fan and/or exhaust fan), an electric motor for controlling a motorized window treatment, a component of a heating, ventilation, and cooling (HVAC) system, a speaker, or any other type of electrical load. The electrical load may 188 be included in or external to the load control device 180. For example, the load control device 180 may be a dimmer switch or an LED driver capable of controlling an external lighting load. The electrical load 188 may be integral with the load control device 180. For example, the load control device 180 may be included in LEDs of a controllable light source, a motor of a motor drive unit, or a speaker in a controllable audio device.

The control circuit 181 may be communicatively coupled to a memory 182 to store information in and/or retrieve information from the memory 182. The memory 182 may comprise a computer-readable storage media or machine-readable storage media that maintains a device dataset of associated device identifiers, network information, and/or computer-executable instructions for performing as described herein. For example, the memory 132 may comprise computer-executable instructions or machine-readable instructions that include one or more portions of a router adjustment procedure for assigning the roles of control devices on a network or a commissioning procedure, as described herein. The control circuit 181 may access the instructions from memory 182 for being executed to cause the control circuit 181 to operate as described herein, or to operate one or more devices as described herein. The memory 182 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 182 may be implemented as an external integrated circuit (IC) or as an internal circuit of the control circuit 181.

The load control device 180 may include one or more communication circuits 184 that are in communication with the control circuit 181 for sending and/or receiving information as described herein. The communication circuit 184 may perform wireless and/or wired communications. The communication circuit 184 may be a wired communication circuit capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 184 may be configured to communicate via power lines (e.g., the power lines from which the device 180 receives power) using a power line carrier (PLC) communication technique. The communication circuit 184 may be a wireless communication circuit including one or more RF or IR transmitters, receivers, transceivers, or other communication circuits capable of performing wireless communications.

Though a single communication circuit 184 may be illustrated, multiple communication circuits may be implemented in the device 180. The device 180 may include a communication circuit configured to communicate via one or more wired and/or wireless communication networks and/or protocols and at least one other communication circuit configured to communicate via one or more other wired and/or wireless communication networks and/or protocols. For example, a first communication circuit may be configured to communicate via a wired or wireless communication link, while another communication circuit may be capable of communicating on another wired or wireless communication link. The first communication circuit may be configured to communicate via a first wireless communication link (e.g., a wireless network communication link) using a first wireless protocol (e.g., a wireless network communication protocol, such as the CLEAR CONNECT (e.g., CLEAR CONNECT A and/or CLEAR CONNECT X) and/or THREAD protocols), and the second communication circuit may be configured to communicate via a second wireless communication link (e.g., a short-range or direct wireless communication link) using a second wireless protocol (e.g., a short-range wireless communication protocol, such as the BLUETOOTH, BLUETOOTH LOW ENERGY (BLE), or NFC protocols).

One of the communication circuits 184 may comprise a beacon transmitting and/or receiving circuit capable of transmitting and/or receiving beacon messages via a short-range RF signal. A control circuit 181 may communicate with beacon transmitting circuit (e.g., a short-range communication circuit) to transmit beacon messages. The beacon transmitting circuit may communicate beacon messages via RF communication signals, for example. The beacon transmitting circuit may be a one-way communication circuit (e.g., the beacon transmitting circuit is configured to transmit beacon messages) or a two-way communication circuit capable of receiving information on the same network and/or protocol on which the beacon messages are transmitted (e.g., the beacon transmitting circuit is configured to transmit and receive beacon messages). The information received at the beacon transmitting circuit may be provided to the control circuit 181.

The control circuit 181 may be in communication with one or more input circuits 183 from which inputs may be received. The input circuits 183 may be included in a user interface for receiving inputs from the user. For example, the input circuits 183 may include an actuator (e.g., a momentary switch that may be actuated by one or more physical buttons) that may be actuated by a user to communicate user input or selections to the control circuit 181. In response to an actuation of the actuator, the control circuit 181 may enter an association mode, transmit association messages from the load control device 180 via the communication circuits 184, and/or receive other information. In response to an actuation of the actuator may perform control by controlling the load control circuit 185 to control the electrical load 188, and/or by transmitting control instructions indicating the actuation on the user interface and/or the control instructions generated in response to the actuation. The actuator may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from a user. The control circuit 181 of the load control device 180 may enter the association mode, transmit an association message, control the load control circuit 185, transmit control instructions, or perform other functionality in response to an actuation or input from the user on the touch sensitive surface.

The input circuits 183 may include a sensing circuit (e.g., a sensor). The sensing circuit may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the load control device 180). The control circuit 181 may receive information from the one or more input circuits 183 and process the information for performing functions as described herein.

The control circuit 181 may illuminate a light sources 186 (e.g., LEDs) to provide feedback to a user. The control circuit 181 may be operable to illuminate the light sources 186 different colors. The light sources 186 may be illuminated by, for example, one or more light-emitting diodes (LEDs).

Referring again to FIG. 1A, a network may be used to facilitate communication between the respective devices (e.g., control devices) of the load control system 100. For a respective control device to communicate via the network, the control devices may join the network, for example, by initiating a commissioning procedure. The commission procedure may include a claiming procedure, a joining procedure, and/or an attachment procedure. The claiming procedure may be used to discover and claim control devices for being added to the network. For example, control devices in the load control system (e.g., the load control system 100 shown in FIG. 1A) may be claimed using a user’s mobile device (e.g., the mobile device 190). Each control device may be claimed by a user’s mobile device 190 for joining the network (e.g., via a joining procedure, as described herein), and/or attaching to other devices on the network. Each control device may transmit a beacon (e.g., a control device beacon) via a short-range wireless communication link. The mobile device 190 may discover (e.g., receive) beacons transmitted by the control devices in the load control system. Each beacon may include a unique beacon identifier of the control device that transmitted the respective beacon. The unique beacon identifier may include a unique device identifier (e.g., serial number) of the control device itself.

The mobile device 190 may identify one or more control device beacons from which a respective beacon was received at a communication quality metric (e.g., received signal strength indicator (RSSI) or other communication quality metric) above a predefined value. For example, the mobile device 190 may identify one or more of the beacons transmitting the beacons that are received having the strongest receives signal strength indicators, and the mobile device 190 may transmit a connection message to the control device(s). The control device may receive the connection message from the mobile device 190 may be configured to establish a connection (e.g., a two-way communication connection) with the mobile device 190.

The connection message may indicate to the control device that the control device has been selected for claiming. The connection message may operate as a claiming message, or a separate claiming message may be sent after the connection is established between the mobile device 190 and the control device. The claiming message may indicate that the control device has been claimed for being added to the network. In response to receiving the claiming message, the control device may transmit a claim confirmation message to the mobile device 190. The claim confirmation message may include a configuration information that may be used to join the control device to the network. For example, the configuration information may include a unique device identifier (e.g., serial number) of the control device and/or network credentials for joining a network. The network credentials may include a network key for the network, a network address for the control device (e.g., a network address) and/or a joiner identifier for the control device. The network address and/or the joining identifier may be used during the joining procedure to allow the control device to join the network.

The user 192 may continue to move the mobile device 190 around the load control environment 102 in which the load control system is installed to perform the claiming procedure with additional control devices. When the user 192 is done claiming control devices (e.g., the mobile device 190 has claimed each of the control devices or a portion of the control devices of the load control system), the mobile device 190 may upload the configuration information from the claimed devices to a central processing device, such as a system controller (e.g., the system controller 110). The uploaded configuration information may be used to identify the devices for being joined to the network. As described herein, the system controller 110 may be installed at the space being commissioned, or may be a remote computing device. Though the mobile device 190 is described as the device performing communications with the control device(s), other devices in the load control system 100 may perform similar communications with the control device(s) during the claiming procedure. For example, the system controller 110, or another computing device in the load control system 100 may be implemented as described herein.

During the j oining procedure, the control device may look for a network to join. For example, the control device may begin the joining procedure after being claimed using the claiming procedure. As described herein, during the joining procedure, the control device may transmit and/or receive joining messages (e.g., message to join a wireless network, such as joining request messages and/or joining response messages). As a result of the joining procedure, and as further described herein, the control device may be configured with a network key that may allow the device to send and/or receive messages over the network.

After the control device joins the network, the control device may, for example, attempt to attach to another device (e.g., a leader device or a router device) on the network to form the mesh network (e.g., formation of the network). In order to attach to another device on the network, the control device may send and receive a number of attachment messages via the network.

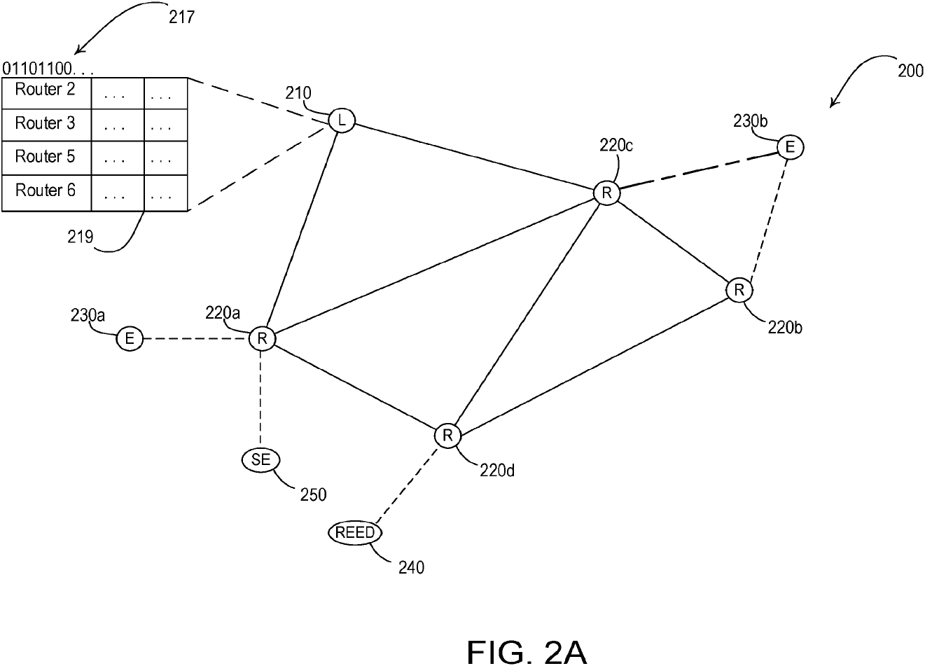

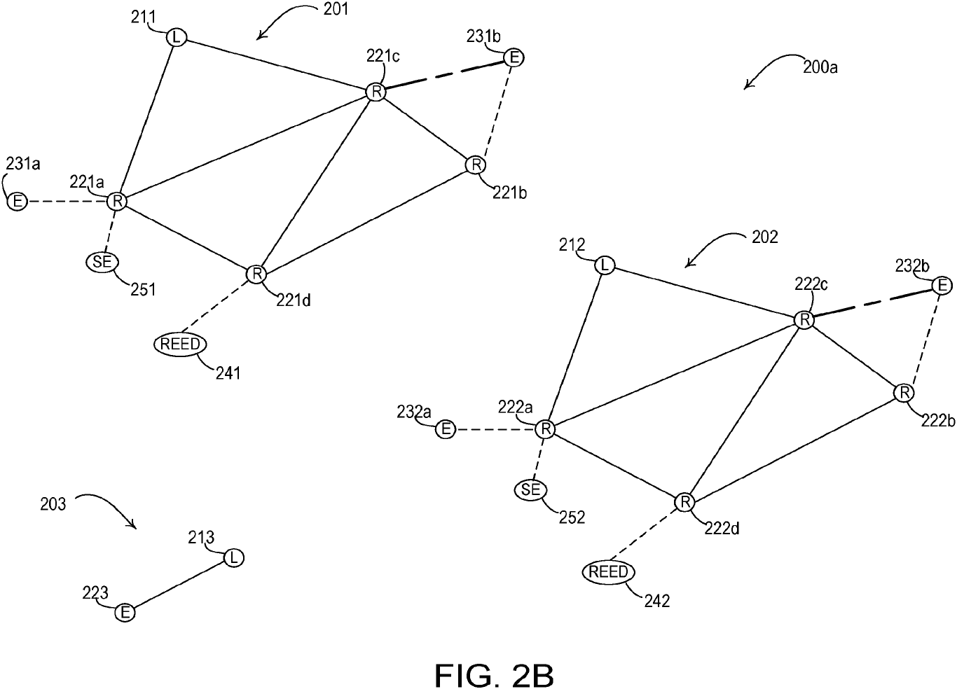

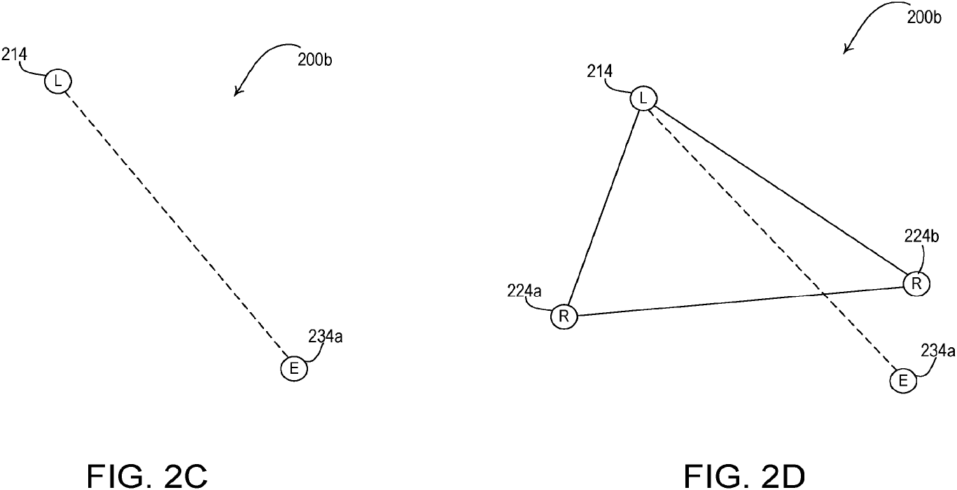

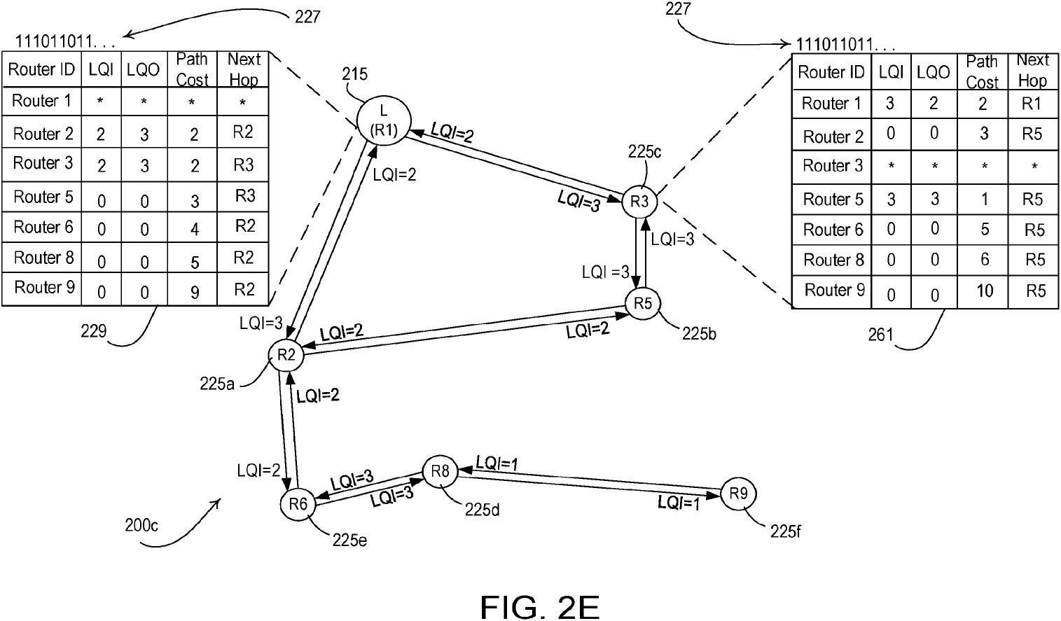

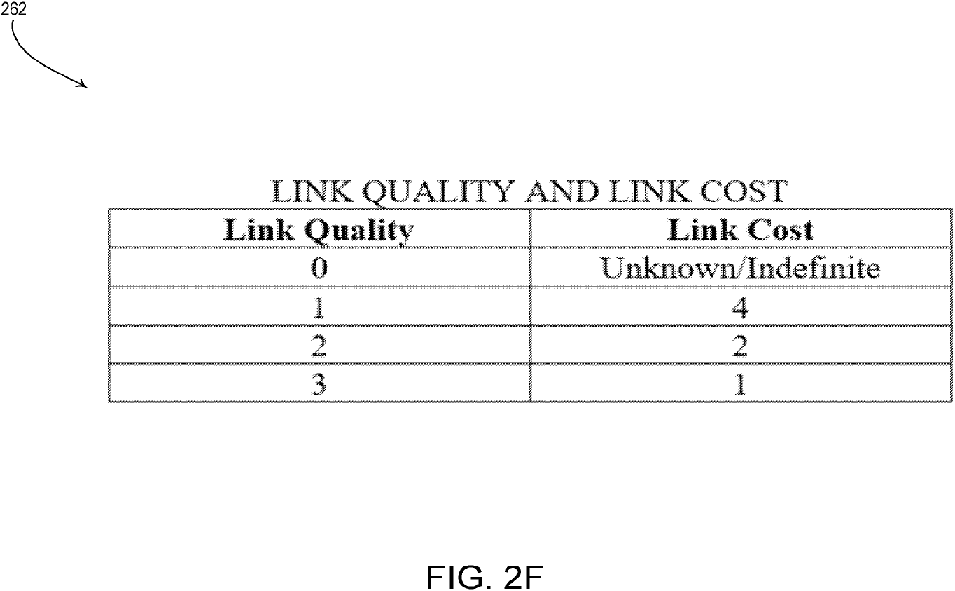

FIG. 2A is an illustration of an example network 200 that may allow for communication between control devices in a load control system (e.g., the load control system 100). The network 200 may include any suitable network to facilitate communications in a load control system. For example, the network 200 may be a mesh network on which control devices communicate using a mesh network wireless communication protocol (e.g., the THREAD protocol or other suitable protocol). The various control devices of the load control system 100 may communicate with each other via the network 200. As shown in FIG. 2A, the network 200 may comprise a single network partition. In addition, the network 200 may be an example of a network partition (e.g., a subnetwork or subnet) within a larger network. For example, the network 200 may be an example of a network partition within a larger network composed of a plurality of network partitions. The network 200 is an example network and the techniques described herein may be applied to other networks, for example, that include more control devices or fewer control devices than the network 200.

The circled nodes of FIG. 2A may represent devices that are attached to other devices on the network 200 (e.g., the various control devices of the load control system 100). A control device that is attached to at least one other control device on the network 200 may communicate with the other control devices (e.g., that are attached to another control device on the network 200). Communication within the network 200 may be facilitated by the network communication links (e.g., attachments) established within the network 200. Referring to FIG. 2A, the network communication links between the devices may be indicated by lines (e.g., solid and dashed lines) that connect the respective control devices.

The control devices that are attached to at least one other device on the network 200 may take on and/or be assigned a respective role in the network. For example, the roles may include: a leader device (e.g., leader device 210), a router device (e.g., router devices 220a-220d), an end device (e.g., end devices 230a and 230b), a router eligible end device (REED) (e.g., router eligible end device 240), a parent device, a child device and/or a sleepy end device (e.g., sleepy end device 250). The role of a control device may indicate the functions and/or capabilities of the control device with respect to the network 200. As described herein, end devices may include end devices (e.g., end devices 230a and 230b), router eligible end devices (e.g., router eligible end device 240), and/or a sleepy end devices (e.g., sleepy end device 250).

As illustrated in FIG. 2A, the network 200 may include a leader device 210 and one or more router devices 220a-220d. The leader device 210 may manage other control devices on the network 200. For example, the leader device 210 may assign and maintain router identifiers (e.g., router IDs) for each of the router devices 220. For example, each of the router devices 220a-220d may be assigned a unique router identifier. The leader device 210 may assign and maintain the roles of other devices. The leader device 210 may be configured as the gateway for the network 200. For example, the leader device may be a control device that facilitates communication (e.g., routes and receives messages to and from) between the network 200 and other networks or network partitions. Referring to FIG. 1A, a system controller (e.g., the system controller 110 shown in FIG. 1A) may be an example of a leader device 210. In addition, a control device within a load control system that is capable of being assigned to the role of a router device may be assigned to the role of the leader device.

The leader device 210 may support and be attached to multiple router devices (e.g., 64 router devices, 32 router devices, or another number of router devices may be defined for the network 200). The leader device 210 may operate as a router device. The router devices 220a-220d on the network 200 (e.g., attached to the leader device 210 on the network 200) may be in communication with each other, for example, to form a mesh network. The router devices 220a-220d may be in communication with one another via network communication links (e.g., as indicated by the solid lines connecting the router devices 220a-220d). The router devices 220a-220d may be in communication with the leader device 210, either directly or through one or more other router devices (e.g., as indicated by the solid lines connecting the leader device 210 to the router devices 220a and 220c). The router devices 220a-220d may receive and route messages to other devices on the network 200 (e.g., the end devices 230a, 230b, the router eligible end device 240, and/or the sleepy end device 250). For example, the router devices 220a-220d may receive and/or transmit messages between devices, or between each other for communicating messages received from an attached device to another device attached to another router device. Referring now to the load control system 100, a device that is, for example, externally powered (e.g., a device that is not battery powered) may be assigned to the role of a router device, such as, the system controller 110, the dimmer switch 120, the LED driver 130, the plug-in load control device 140, the motorized window treatments 150, and/or the thermostat 160.

The network 200 may include one or more end devices 230a, 230b (e.g., full or minimal end devices). The end devices 230a, 230b may be attached to another device (e.g., a parent device, such as the leader device 210 and/or the router devices 220a, 220b, 220c, 220d) on the network 200 and may transmit and/or receive messages via its attached parent device (e.g., leader device and/or router device). Though two end devices 230a, 210b are shown in FIG. 2A, and each is attached to different router devices, each router device 220a-220d may support multiple end devices (e.g., more than 500 end devices). The system controller 110, input devices (e.g., the remote control device 170), and/or load control devices (e.g., the dimmer switch 120, the LED driver 130, the plug-in load control device 140, the motorized window treatments 150, and/or the thermostat 160) may be examples of the end devices 230a, 230b.

Referring again to FIG. 2A, the network 200 may include the router eligible end device 240. The router eligible end device 240 may be an end device that is capable (e.g., hardware capable and/or software capable) of becoming a leader device and/or a router device. In certain situations, the role of the router eligible end device 240 may be updated to a leader device and/or a router device. For example, when the router eligible end device 240 identifies itself as being within reach of an end device attempting to attach to the network 200, the router eligible end device 240 may upgrade itself to the role of a router device. The router eligible end device 240 may transmit and/or receive messages via the attached router device 220d. As shown in FIG. 2A, the router eligible end device 240 may be one of the end devices that is attached to the router device 220d. The system controller 110, the dimmer switch 120, the LED driver 130, the plug-in load control device 140, the motorized window treatments 150, and/or the thermostat 160 may be examples of the router eligible end device 240. Referring now to the load control system 100, a control device that is, for example, externally powered (e.g., a control device that is not battery powered) may be assigned to the role of a router eligible end device, such as, the system controller 110, the dimmer switch 120, the LED driver 130, the plug-in load control device 140, the motorized window treatments 150, and/or the thermostat 160.

The network 200 may include the sleepy end device 250. The sleepy end device 250 may include, or may be similar to, an end device. For example, the sleepy end device 250 may be an end device that is powered by a finite power source (e.g., a battery). The sleepy end device 250 may be aware of its role as a sleepy end device based on, for example, an indication that is stored at the sleepy end device 250. Communication with the sleepy end device 250 may be performed such that the finite power source is preserved and/or is efficiently consumed. For example, the sleepy end device 250 may periodically disable its communication circuit(s) in between message transmissions. The sleepy end device 250 may transmit and/or receive messages via an attached router device 220a. As shown in FIG. 2A, the sleepy end device 250 may be one of the end devices that is attached to the router device 220a. Input devices (e.g., the remote control device 170) and/or load control devices (e.g., the motorized window treatments 150 when battery powered) may be examples of the sleepy end device 250. In addition, sensors and/or battery powered devices may be examples of the sleepy end device 250.

The leader device 210 may update the roles (e.g., or confirm role updates) of the devices communicating within the network 200, for example, based on changes to the network 200. In an example, a control device may be assigned to a certain role when the device attaches to the network 200, and the leader device 210 may update the role of the device based on changes in network conditions. Changes in network conditions may include: increased message traffic, attachment of other devices, changes in signal strength, etc. Updates to the assigned role of a control device may be based on the capabilities of the device. For example, the leader device 210 may update the role of a control device from a router eligible end device to a router device (e.g., as a router eligible end device is an end device that is eligible to perform the role of a router device). The leader device 210 may update the role of a control device to a router device by assigning a router identifier (ID) to the device.

As the leader device 210 updates the roles of the devices in the network 200, the leader device may maintain the number of router devices in the network 200 and/or the router identifiers in use in the network 200. For example, the leader device 210 may store and/or maintain a bitmap 217 that may be used to indicate the number of router devices and/or the router identifiers being used in the network 200. The bitmap 217 may include a number of bits that each correspond to a different router identifier being used in the network 200. In an example, the leader device 210 may support 64 router devices and the leader device 210 may store a 64-bit bitmap for tracking the router identifiers in use in the network 200. Each bit in the bitmap may indicate whether a router identifier is identified by the leader device 210 as being used (e.g., with a value of “1”) or unused (e.g., with a value of “0”). The leader device 210 may determine that a device should be upgraded to a router device and, so long as a router identifier is available, assign a router identifier to the router device. The leader device 210 may downgrade router devices (e.g., to end devices) or remove router devices from the network 200. As router devices are added or removed, the bitmap 217 may be updated to indicate the number of router devices and/or router identifiers that are in use in the network 200.

The leader device 210 may send the bitmap 217 to the other router devices in the network 200. Each router device, including the leader device 210, may maintain network information about each of the router devices identified as being used in the network 200. For example, each router device may maintain network information about each of the router devices in a router table, such as the router table 219. For example, the network information in the router table 219 may identify the router devices in the network 200 and the quality of communications that a corresponding router device has with the other router devices being maintained in the router table stored locally thereon. Each router table, such as the router table 219, may include a row for each router identifier indicated in the bitmap 217. Each router device in the network, including the leader device 210, may perform communications on the network 200 based on the network information being stored and maintained in the locally stored router table. For example, a router device, such as the router devices 220a-220d and/or the leader device 210, may transmit messages differently within the network 200 based on the quality of the communications with corresponding router devices identified in the router table stored locally thereon.

The control devices attached to the network 200 may further operate as parent devices and/or child devices. Leader devices (e.g., the leader device 210) and router devices (e.g., the router devices 220a-220d) that are attached to one or more end devices (e.g., the end devices 230a, 230b, the router eligible end device 240, and/or the sleepy end device 250) may operate as parent devices. End devices (e.g., the end devices 230a, 230b, the router eligible end device 240, and/or the sleepy end device 250) that are attached to a leader device (e.g., the leader device 210) or a router device (e.g., one of the router devices 220a-220d) may operate as child devices. As a parent device, the leader device 210 and the router devices 220a-220d may each be attached to one or more child devices (e.g., one or more of the end devices 230a, 230b, the router eligible end device 240, and/or the sleepy end device 250, as described herein). In addition, the leader device 210 and the router devices 220a-220d may store and/or relay messages that are sent by their respective attached child devices. For example, the leader device 210 and the router devices 220 may receive messages from their respective child devices and route the received messages to the intended recipient device (e.g., either directly to the intended recipient device, via the respective parent device of the intended recipient device, and/or to a router device or leader device this is on the path to the intended recipient). Similarly, the leader device 210 and the router devices 220a-220d may receive messages intended for their respective child device and route the message to the appropriate child device. The parent of a respective sleepy end device may schedule communications with the sleepy end device when the communication circuit of the sleepy end device is enabled.

As indicated in FIG. 2A, the relationship (e.g., attachment) between a child device and a respective parent device may be indicated by dashed lines. For example, the router device 220a may be configured as the parent device of the end device 230a and the sleepy end device 250. Similarly, the router device 220b may be configured as the parent device of the end device 230b. The router device 220a may receive messages intended for the end device 230a and forward the message to the end device 230a. As the router device 220a is configured as the parent device of the end device 230a, the end device 230a may transmit messages to the router device 220a, and the router device 220a may route the message to the intended recipient. For example, when the end device 230a intends to transmit a message to the end device 230b, the end device 230a may initially transmit the message to the router device 220a. The router device 220a may route the message to the router device 220b (e.g., the parent device of the end device 230b). For example, the router device 220a may route the message to router device 220b via router device 220c or router device 220d, and the router device 220b may then forward to message to the end device 230b. In addition, as described herein and illustrated in FIG. 2A, the router device 220a may route the message to the end device 230b via the router device 220c (e.g., the auxiliary parent device of the router device 230b).

Child devices may be configured to transmit unicast messages to their respective parent device. A control device may transmit unicast messages to another control device in the network directly or via hops through other devices in the network. Each unicast message may be individually addressed to another control device by including a unique identifier of the control device to which the unicast message being transmitted. Control devices may generate separate unicast messages for each control device with which they are communicating and address the unicast messages to each control device independently. The unicast messages may also include the unique identifier of the control device that is transmitting the unicast message. A control device may determine that it is the intended recipient of a unicast message by identifying its own unique identifier in the unicast message.

Messages may be sent in the network using multicast messages and/or broadcast messages. Multicast messages may be sent to a group of control devices in the network. A multicast message may include a group identifier. The control devices that are members of the group may recognize the group identifier and process the message accordingly. Broadcast messages may be sent to each control device in the network capable of receiving the message. The broadcast messages may include an indication that the message is a broadcast message (e.g., a broadcast address). Each device that receives a broadcast message may process the message accordingly. A network may use either multicast messages or broadcast messages, and the two terms may be used unteachably herein.

The messages transmitted by a child device to its respective parent device may include an indication (e.g., a unique identifier) of the intended recipient, and the parent device may route the message accordingly. Referring again to FIG. 2A, the end device 230a may transmit messages to the router device 220a (e.g., the parent device of the end device 230a), and the router device 220a may route the message based on the intended recipient. For example, if the end device 230a transmits a message intended for the end device 230b, the router device 220a may route the message to the router device 220b (e.g., the parent device of the router eligible end device 230b) via the router device 220c or the router device 220d. For example, if the router device 220a routes the message via the router device 220d, the router device 220d may forward the message to the router device 220b, which may forward the message to the end device 230b. The router device 220a may identify that the router device 220b is the parent device to which the end device 230b is attached via a lookup table. As illustrated in FIG. 2A, multiple paths may exist to route messages over the network 200, and router devices may identify the shortest path (e.g., lowest number of hops) to transmit messages to a respective device.

Child devices may be configured to communicate with an auxiliary parent device (e.g., configured to communicate with more than one parent device). Referring to FIG. 2A, for example, the end device 230b may be configured to communicate with (e.g., transmit message to and receive messages from) a parent device (e.g., a primary parent device), such as the router device 220b. The end device 230b may also be configured to communicate with (e.g., receive messages from) an auxiliary parent device, such as the router device 220c (e.g., as illustrated by the long and short dashed lines in FIG. 2A). A child device may receive unicast messages from its parent device (e.g., primary parent device). A child device may also receive multicast messages (e.g., and/or broadcast messages) from its parent device (e.g., primary parent device) and one or more auxiliary parent devices, which may increase the efficiency and reliability of child device receiving the messages. For example, the child device may receive network advertisement messages via an auxiliary parent device. The number of auxiliary parents that a child device is synchronized with may be limited to a threshold number of auxiliary parents (e.g., 3, 5, 10, etc.).

A child device may be attached to a single parent device and synchronized with one or more auxiliary parent devices. For example, the child device may send and/or receive unicast messages via the parent devices. Similarly, the child device may receive multicast messages via the one or more synchronized auxiliary parent devices. The number of auxiliary parent devices that a respective child device is synchronized with may be limited to a threshold number of synchronized auxiliary parents, which may be pre-defined and/or configured. A child device may attempt to synchronize with an auxiliary parent device by transmitting a message (referred to herein as a link request message) to the auxiliary parent device. For example, referring to FIG. 2A, the end device 230b may have transmitted a link request message to router 220c. The link request message may be used to request a network communication link between two devices. As descried herein, messages may be communicated between devices that share a network communication link. In response to receiving the link request message, the router device 220c may transmit a message (referred to herein as a link accept message) to the end device 230b. The link accept message may include information that allows the respective child device to decrypt messages from the auxiliary parent device (e.g., a frame counter). As described herein, when a child device is synchronized with an auxiliary parent device, the child device may receive multicast messages via the synchronized auxiliary parent device. For example, referring to FIG. 2A, the end device 230b may receive multicast messages via the parent device (e.g., router device 220b) and the auxiliary parent device (e.g., router device 220c), which may increase the efficiency and reliability of the child device 230b receiving multicast messages.

A child device may receive advertisement messages from a router device other than the parent device of the child device or a router device other than an auxiliary parent device of the child device. For example, the router device may transmit advertisement messages to enable other control devices to determine that a network has been formed and that the device hearing the advertisement message may attempt to attach to the router device (e.g., to communicate via the network). Devices may receive and track the advertisement messages transmitted by router devices to determine whether the device is able to communicate via the network. Also, or alternatively, the advertisement messages transmitted by a respective router device may provide other router devices with the ability to measure a communication quality metric of the communication signal (e.g., via the received signal strength indicator value) between the respective routers attached to the network (e.g., which the router devices may use to update their respective routing tables or routing information). As described herein, the child device may measure the received signal strength indicator (RSSI) or another communication quality metric of the received advertisement messages.

Certain messages may be propagated and broadcast by multiple devices in the network 200, which may increase the likelihood that a respective child device hears a message. For example, rather than sending multiple transmissions, multicast messages that are substantially similar (e.g., messages that include the same load control instructions that are sent to multiple load control devices) may be broadcasted. Referring again to the load control system 100, an actuation of a button of the remote control device 170 may adjust the intensity of multiple lighting loads (e.g., the lighting load 122 and the plug-in lighting load 142) and a message may be broadcasted to adjust the respective lighting loads. In addition, the devices that receive the broadcast transmission may be configured to process and repeat (e.g., forward the message over the network or otherwise acting as a repeater) the message in response to receiving the broadcast transmission.

Child devices may create and maintain an auxiliary parent table. The auxiliary parent table may include a list of auxiliary parents with which a respective child device is configured to communicate (e.g., synchronized with and/or able to receive multicast messages from). In addition, the auxiliary parent table may include an indication of the communication quality metric (received signal strength (e.g., an RSSI) for each of the auxiliary parent devices of the child device. For example, the auxiliary parent table may include a rolling average of the received signal strength indicators for each of the auxiliary parent devices of the child device. Child devices may similarly create and/or maintain a router table. The router table may include the router devices that a respective child device has received messages from (e.g., advertisement messages). In addition, the router table may include an indication of the RSSI or other communication quality metric of messages received from each of the router devices in the router table. Also, or alternatively, child devices may maintain a generic router table. The router table may include each of the router devices that a respective child device has received messages from and a received signal strength indicator for each of the respective router devices. The router table may also include an indication of whether a respective router device is a parent of the child device or an auxiliary parent of the child device. As used herein, the term auxiliary parent table may refer to a separate table from the router table or a subset of the router table that includes the router devices that are synchronized auxiliary parents of the child device.

As described herein, the network 200 may allow for communication between devices in a load control system (e.g., the load control system 100 shown in FIG. 1A). The end devices 230a, 230b may include load control devices and/or input devices (e.g., input devices) that communicate with other devices in the load control system. For example, the end device 230a may communicate with another end device and/or a router device in the load control system via RF communications.

Referring to FIG. 1A, the remote control device 170 may operate as an end device or a sleepy end device for communicating messages comprising indications of user input and/or control instructions for controlling another end device (e.g., the dimmer switch 120, the LED driver 130, the plug-in load control device 140, the motorized window treatment 150, and/or the thermostat 160). The remote control device 170 may communicate via one or more intermediary parent devices, such as a leader device and/or a router device, for example. The leader device and/or the router device may communicate with one or more other leader devices and/or router devices in the network to route the messages to the other end device (e.g., the dimmer switch 120, the LED driver 130, the plug-in load control device 140, the motorized window treatment 150, and/or the thermostat 160) for performing load control.

A control device may attach to another control device on a network or network partition (e.g., the network 200 shown in FIG. 2A) to enable the device to communicate (e.g., transmit and/or receive messages) via the network. A control device may initiate attachment to another control device on a network by transmitting a parent request message (e.g., a multicast parent request message) to discover potential parent devices. A parent request message may be transmitted by a control device to discover and/or attach to a parent device (e.g., router devices and/or leader devices). A control device may transmit the parent request message as a multicast message, for example, to identify devices that are attached to a network that can act as a parent device of the control device.

Potential parent devices (e.g., the leader device 210 and/or the router devices 220 of the network 200) that receive a parent request message (e.g., a multicast parent request message) may respond by transmitting a parent response message. For example, potential parent devices that receive a multicast parent request message may each transmit a parent response message (e.g., as a unicast message) to the control device that transmitted the parent request message. A parent response message may indicate that the control device that transmits the parent response message is available to act as a parent device. Accordingly, a control device that transmits a parent request message may receive a plurality of responses to the parent request message and determine a parent to synchronize with based on the received parent response messages. The control device transmitting the parent request message may identify the received communication quality metric (e.g., RSSI) associated with the response messages and attempt attachment to the parent device having the largest received signal strength indicator for the response message.

FIG. 2B is an example illustration of a network 200a having a plurality of network partitions 201, 202, 203 (e.g., separate network partitions). As illustrated in FIG. 2B, the network partition 201 may include the following parent devices: a leader device 211 and router devices 221a, 221b, 221c, 221d. In addition, the network 201 may include child devices, such as: end devices 231a, 231b; router eligible end device 241; and sleepy end device 251. For example, each of the router devices 221a-221d in the network partition 201 may be assigned a unique router identifier. The network partition 202 may include the following parent devices: a leader device 212 and router devices 222a, 222b, 222c, 222d. In addition, the network 202 may include child devices, such as: end devices 232a, 232b; router eligible end device 242; and sleepy end device 252. For example, each of the router devices 222a-222d in the network partition 202 may be assigned a unique router identifier. The network partition 203 may include a single parent device, leader device 213, and a single end device, end device 223.

As illustrated in FIG. 2B, the network partition 203 may include a leader device 213 and an end device 223. The network partition 203, however, may fail to include a router device. Rather, the leader device 213 may function as the sole router device within the network partition 203. A leader device that is not connected or synchronized with a router device may be referred to as a singleton device. For example, the leader device 213 may be a singleton device. As illustrated in FIG. 2B, a singleton device may be connected to one or more child devices (e.g., the end device 223). The network partition 203 may be a singleton partition. As illustrated in FIG. 2B, a singleton partition may include a leader device (e.g., the leader device 213). In addition, a singleton partition may include one or more end devices (e.g., the end device 223). However, as illustrated in FIG. 2B, a singleton partition may not include a router device.

The network 200a may allow for communication between control devices in a load control system (e.g., the load control system 100). In addition, the network partitions 201, 202, 203 may be formed as a result of certain control devices being unable to attach to an already formed network partition. For example, as described herein, a control device may attempt to attach to another control device on a network partition by transmitting a parent request message (e.g., a multicast parent request message). If, however, the control device fails to receive a response to the parent request message (e.g., because the control device is outside of a communication range of the router devices of an already formed network partition), the control device may attempt to form its own network partition (e.g., become a leader device of a new network partition).

A control device that is unable to attach to a network partition may form another network partition. For example, referring to FIG. 2B, the leader device 213 may have been unable to attach to a router device on the network partitions 201, 202 (e.g., because the leader device 213 was outside of communication range of the router devices on the network partitions 201, 202). Accordingly, the leader device 213 may form the network partition 203 and the end device 223 may attach to the network partition 203. Similarly, the leader device 212 may have been unable to attach to the network partitions 201, 203 (e.g., because the leader device 212 is outside of communication range of the router devices of the network partitions 201, 203) and formed the network partition 202.

A network partition may be associated with a partition identifier (e.g., a partition ID). The partition identifier may be randomly or pseudo-randomly assigned (e.g., randomly assigned from a range or list of identifiers). For example, a priority of the respective network partition may be based on the partition identifier for the network partition. The partition identifier may be assigned by randomly selecting a number from a range of partition identifier values. The partition identifier may be selected at a leader device and transmitted in advertisement messages to other devices that may attach to the leader device. Referring now to FIG. 2B, the network partitions 201, 202, 203 may each be associated with a respective partition identifier. For example, the network partition 202 may be assigned a partition identifier of 1, the network partition 203 may be assigned a partition identifier of 2, and the network partition 201 may be assigned a partition identifier of 3. Although the partition identifiers of the network partitions 201, 202, 203 are sequential (e.g., in order to provide for a simplified explanation), the assignment of the partition identifiers to the network partition may be sequential, non-sequential, and/or randomized. As described herein, a partition identifier may also be an indication of a priority of the respective network partition 201, 202, 203. For example, the partition identifier may also be a priority value of the respective network partition 201, 202, 203 (e.g., respective priorities of the network partitions 201, 202, 203 may be 3, 1, and 2). A higher or lower partition identifier may indicate a higher priority value for the network partition priority (e.g., then network partition 201 may be a higher-priority network partition than the network partitions 202, 203 based on the partition identifier).

A priority may be assigned to a respective network partition based on the control devices (e.g., router devices and/or end devices) in the network partition. For example, a network partition having at least one router device in addition to the leader device may be given a higher priority than a network partition having only a leader device and no other router devices. Referring to FIG. 2B, the network partition 201 may be given a higher priority than the network partition 203 since the network partition 201 has router devices 221a-221d and the network partition 203 has no router devices in addition to the leader device. In addition, a priority may be assigned to a respective network partition based on a number of control devices (e.g., router devices and/or end devices) in the network partition. Referring to FIG. 2B, the network partition 201 may be given higher priority than the network partition 203 since the network partition 201 may have a greater number of control devices in the network partition. Each control device in a network partition may have stored locally thereon the number of control devices in the network partition. Network partitions that have the same number of control devices may be given different priorities using different partition identifiers, as described herein. For example, as shown in FIG. 2B, the network partition 201 and the network partition 202 may have the same number of control devices (e.g., router devices and/or end devices). The network partition 201 may have a higher priority based on network partition 201 having a higher or lower partition identifier.

As control devices attach to each of the network partitions 201, 202, 203, the effective communication range of each of the network partitions may increase. In addition, control devices that were initially unable to attach to one or more of the network partitions 201, 202, 203 (e.g., because the control device was previously outside of the communication ranges of all of the network partitions), may subsequently be able to attach to one of the network partitions 201, 202, 203. Moreover, communication within a load control system may be better facilitated when a single network partition is formed (e.g., the network 200 having a single network partition as illustrated in FIG. 2A) as compared to when multiple network partitions are formed (e.g., the network 200a having multiple network partitions 201, 202, 203 as illustrated in FIG. 2B). For example, communication within a load control system may be better facilitated when a single network partition is formed because a device in a network partition may be unable to transmit messages to control devices attached to another network partition (e.g., a device in a network partition may be unable to communicate with other devices outside the network partition). Accordingly, if a control device attached to a first network partition is also within the communication range of a second network partition, the device may attempt to detach from the first network partition and attach to the second network partition. For example, a control device may detach from the first network partition and attach to a second network partition when the priority of the second network partition is higher than the priority of the first network partition.

The router devices attached to each of the network partitions 201, 202 may each be associated with a communication range. The communication range of each of the respective router devices may be pre-defined and/or pre-configured. For example, the communication range of each of the respective router devices may be pre-defined and/or pre-configured based on the hardware components of each of the respective router devices. The effective communication range of a respective network or network partition may be based on the communication range of the router devices attached the respective network (e.g., a summation of the communication range of each of the router devices attached to the respective network). As a result, the communication range of a respective network or network partition may increase as the number of router devices attached to the respective network increases.

As described herein, the control devices attached to a lower-priority network partition may attempt to attach to a higher-priority network partition. For example, the control devices attached to the network partition 202 may attempt to attach to the network partition 201 (e.g., as the network partition 201 has a priority value of 3 and the network partition 202 has a priority value of 1). The router device 222a may receive an advertisement message from a device attached to the network partition 201 (e.g., from the router device 221d). The advertisement message may include an indication of the partition identifier of the network 201 (e.g., 3), which may be greater than the partition identifier of the network partition 202 and may indicate that the network partition 201 is a higher-priority network partition than the network 202. The router device 222a may determine to attach to the network partition 201 (e.g., as the network partition 201 has a higher priority).

The router device 222a may attempt to attach to the network partition 201 by transmitting a request to the leader device of the network partition 201 (e.g., the leader device 211). The request may include a request to attach to the network partition 201 as a router device, for example, by requesting to attach to the network partition 201 and be assigned a certain router identifier. For example, the router device 222a may request to attach to the network partition 201 and be assigned the router identifier that the router device 222a is assigned in the network partition 202. In response, the leader device 211 may reject the request if another router device 212a-212d attached to the network partition 201 is already assigned the requested router identifier. The leader device 211 may accept the request if none of the router devices 212a-212d attached to the network partition 201 are assigned the requested router identifier. If the router device 222a attaches to the network partition 201 and is assigned the requested router identifier, the child devices of the router device 222a (e.g., the end device 232a and the sleepy end device 252) may automatically attach to the network partition 201. For example, as the child devices communicate with the router device 222a using the router identifier. If the router device 222a is assigned the requested identifier by the leader device 211 of the network partition 201 (e.g., the router identifier as assigned in the network partition 202), the child devices may continue to communicate with router device 222a using the same router identifier.

FIGS. 2C and 2D are illustrations of an example network 200b as the network 200b advances or progresses in network formation. As illustrated in FIG. 2C, the network 200b may include a leader device 214 and an end device 234a. As the network 200b is in the initial stages of network formation, the network 200b may not yet include a router device. The end device 234a may, as a result, attach to the leader device 214 (e.g., as other router devices not yet exist on the network 200b). However, the network communication link (e.g., the parent/child link) between the leader device 214 and the end device 234a may be weak (e.g., the received signal strength indicator of messages received by the end device 234a may be approximately -60 dB). For example, the network communication link between the leader device 214 and the end device 234a may be weak because the leader device 214 and the end device 234a are not proximately positioned to each other. If the network communication link between the leader device 214 and the end device 234a is weak, the likelihood of message transmission and/or reception failures between the leader device 214 and the end device 234a may increase.

FIG. 2D illustrates the network 200b during a later stage of network formation than the stage of network formation illustrated in FIG. 2C. As illustrated in FIG. 2D., the network 200b may grow to include additional control devices as network formation advances (e.g., as time progresses). For example, the network 200b may grow to include router devices 224a, 224b. In addition, the router devices 224a, 224b may be positioned proximate to the end device 234a (e.g., positioned closer to the end device 234a than the leader device 214). In addition, the received signal strength indicators of messages transmitted by the router devices 224a, 224b and received by the end device 234a may be strong (e.g., stronger than the received signal strength indicators transmitted by the leader device 214 and received by the end device 234a, such as -35 dB and -30 dB, respectively). Thus, potential network communication links (e.g., potential parent/child links) between the router devices 224a, 224b and the end device 234a may be stronger than the network communication link between the leader device 214 and the end device 234a. Moreover, as illustrated in FIG. 2D, a potential network communication link between the router device 224b and the end device 234a may be stronger than a potential network communication link between the router device 224a and the end device 234a (e.g., as the router device 224b is positioned closer to the end device 234a than the router device 224a).

As network formation progresses or advances additional devices may attach to the network. As a result, the end device 234a may experience better communication over the network 200b if the end device 234a determines to detach from an initial parent device (e.g., the leader device 214) and to attach to an updated parent device (e.g., the router device 224a or the router device 224b). For example, as described herein, the updated parent device may be positioned closer to the end device 234a than the initial parent device (e.g., such that the updated parent device and the end device 234a may have a stronger network communication link), which may increase the likelihood that message transmission and/or receptions are successful. As a result, as network formation advances, the end device may determine whether to attach to an updated parent device. Although FIGS. 2C and 2D are described using an example where the relative positioning of devices may increase or decrease the network communication link shared between two devices, other conditions may affect the network communication link shared between two devices (e.g., line of sight, interference, signal obstructions, etc.). To that extent, the scenarios of FIGS. 2C and 2D are merely examples to illustrate that a network may change over time and that changes to network may be considered in attempts to improve communications over the network.

FIG. 2E is an illustration of an example network 200c. As illustrated in FIG. 2E, the network 200c may include a leader device 215 and router devices 225a, 225b, 225c, 225d, 225e, 225f. In the network 200c, the router devices (e.g., the leader device 215 and router devices 225a, 225b, 225c, 225d, 225e, 225f) may periodically transmit advertisement messages that may be used for calculating cost and/or quality of communications in the network 200c. For example, router device 225c may send an advertisement message that is received by leader device 215 and leader device 215 may send an advertisement message that is received by router device 225c. Each router device may measure the received communication quality metric (e.g., RSSI) of the received advertisement message and calculate a link quality at which the advertisement message is received (e.g., link quality in (LQI)).

Each router device (e.g., leader device 215 and router devices 225a, 225b, 225c, 225d, 225e, 225f) may send an advertisement message as a multicast message. The advertisement messages transmitted by a router device may be received by neighboring router devices that share a single-hop network communication link with the router device transmitting the advertisement messages. A single-hop network communication link may be capable of communicating messages from a router device via a unicast and/or multicast communication directly to another router device. For example, the router devices 225a, 225c may be neighboring devices that share a single-hop communication link with the leader device 215, as the router devices 225a, 225c are capable of sending messages directly to and/or receiving messages directly from the leader device 215. The single-hop network communication link may be a network communication link on which router devices may be capable of directly receiving the advertisement messages above a given link quality (e.g., LQI greater than 0).

After a router device receives a periodic advertisement message from another router device, the router device may calculate the link quality (e.g., LQI) of the network communication link via which the advertisement message is received. The LQI may be calculated as a predefined number that is within a range indicating different link qualities for the network communication link between two devices. For example, the LQI may be indicated by values of 0, 1, 2, or 3. The different indicators of LQI may be assigned based on the RSSI of the received advertisement message and a link margin relative to a predefined receive level. The receive level may be a predefined minimum receive level. The receive level may be established as a predefined RSSI value for communications on the network. For example, the receive level may be defined by a noise floor that is set to an average RSSI value for noise generated on the network over a period of time. In an example using the receive level as a noise floor, a router device (e.g., leader device 215 or router device 225c) may calculate an LQI of 1 for communications received on a link from a neighboring router device when the RSSI value of one or more advertisement messages (e.g., average RSSI for advertisement messages over a period of time) is at least a link margin of 2 dB above the noise floor. The router device (e.g., leader device 215 or router device 225c) may calculate a link quality of 2 for communications received on a network communication link with a neighboring router device when the RSSI value of one or more advertisement messages (e.g., average RSSI for advertisement messages over a period of time) is at least a link margin of 10 dB above the noise floor. The router device (e.g., leader device 215 or router device 225c) may calculate a link quality of 3 for communications received on a network communication link with a neighboring router device when the RSSI value of one or more advertisement messages (e.g., average RSSI for advertisement messages over a period of time) is at least a link margin of 20 dB above the noise floor. A link quality value of zero may indicate that the link quality is unknown or infinite when the RSSI value of one or more advertisement messages (e.g., average RSSI value for advertisement messages over a period of time) is unable to be determined above the noise floor. Though examples are provided for predefined numbers indicating different levels of link quality, and/or different link margins that may be assigned to those levels, other indicators and/or values may be used to define link quality between two routing devices. Additionally, though individual routing devices may be provided as an example (e.g., leader device 215 or router device 225c), other routing devices may similarly calculate link quality for network communication links between neighboring routing devices.

The LQI of the network communication links measured locally at each control device (e.g., the leader device 215 and the router device 225c) may be exchanged with the other device on the network communication link. For example, the LQI may be measured locally at each control device and transmitted to the other device via an advertisement message. The LQI that is measured by another router device (e.g., on the other side of the network communication link) and received at a router device may be stored as the link quality out (LQO) for the network communication link. The LQI and/or the LQO may be stored in a local router table at each routing device. For example, the leader device 215 may store the LQI and/or the LQO for the network communication link with each router device in the network 200c in a router table 229. Similarly, the router device 225c may store the LQI and the LQO for communicating with each router device in the network 200c in a router table 261.

As described herein, the router tables 229, 261 may each identify network information for communicating with each router in the network 200c from the perspective of the devices at which the router tables 229, 261 are stored. The number of router devices in the network 200c and/or the router identifiers in use in the network 200c may be determined from a bitmap 227, as described herein. The bitmap 227 may be maintained by the leader device 215 and distributed to the other routing devices for locally maintaining their router tables. For example, the router devices 225a, 225c may receive the bitmap 227 and update their local router tables. The bitmap 227 may indicate the number of rows in the router tables (e.g., indicating the number of identified router devices in the network) and/or the router identifiers to include in the router tables. The router devices may maintain updated network information for the indicated router identifiers in the router tables. The updated network information in the router tables may include the LQI and/or LQO for the network communication link between the router devices identified in the bitmap 227. For example, the router 225c may receive the bitmap 227 from the leader device 215 and update the router table 261 to include router devices in the table 261 that are indicated in the bitmap 277, or remove router devices in the table 261 that are indicated in the bitmap 277 as failing to be used in the network.

The leader device 215 and router devices 225a, 225b, 225c, 225d, 225e, 225f may each use the LQI and LQO in their respective router tables to calculate a link cost for communicating on a network communication link with other router devices. The link quality for the network communication link between the two router devices may be the lesser of the value of the link quality for messages being transmitted out (e.g., LQO) and the value of the link quality for messages being received (e.g., LQI) on a single-hop network communication link between two devices. An LQO or an LQI of zero may indicate that the router device fails to have a direct network communication link with the router device listed in the router table.

A link cost for sending communications between devices on a network communication link may correspond directly to the link quality of communications on the network communication link. The link cost may indicate a relative cost or loss of communications on the network communication link. FIG. 2F is an example table 262 that illustrates example link costs that may correspond to different link qualities. As shown in FIG. 2F, a greater link quality may correspond to a lower link cost for communications on the network communication link between two neighboring devices.

The link cost for each network communication link may be used by a router device to calculate a path cost for communications between the router device and another router device in the network 200c. The path cost may indicate the relative cost or loss of communications on an entire communication path that may include one or more router devices. The path cost for one communication path may be compared to another to determine a higher quality communication path for sending digital communications that may have a lower relative cost associated with transmission of messages.

The path cost may indicate the overall cost for communicating a message from a starting router device to an ending router device. For example, the path cost may be calculated as the total of the link costs for each hop between the starting router device from which a message may originate and the ending router device at which the message may be received in the network 200c. Each router device may calculate the path cost to a neighboring device on a single-hop network communication link as being equal to the link cost and store the path cost in the locally-stored router table. For example, the router device 225c may set the path cost for communications with the leader device 215 equal to the link cost (e.g., lower of LQI and LQO) on the network communication link and store the path cost in the router table 261. Similarly, the router device 225c may set the path cost for communications with the router device 225b equal to the link cost (e.g., lower of LQI and LQO) on network communication link and store the path cost in the router table.

Each router device (e.g., leader device 215 and router devices 225a, 225b, 225c, 225d, 225e, 225f) may update the path cost for communicating messages to/from each router device in their respective router table based on the path cost information received from another router device. For example, as the router device 225b may be unable to directly communicate with the leader device 215, the router device 225b may receive path cost information for communicating messages through another router in the network 200c. The router 225c may transmit the path cost for communicating messages to/from the leader device 215 (e.g., path cost = 2) in a multicast message that is received by other router devices. The multicast message may be an advertisement message, for example. The router device 225b may receive the path cost for communicating messages between the leader device 215 and the router device 225c (e.g., path cost = 2). To calculate the total path cost for communicating messages between the router device 225b and the leader device 215 through the router device 225c, the router device 225b may add the link cost for communications between the router device 225b and the router device 225c (e.g., link cost = 1) to the path cost received from the router device 225c (e.g., path cost = 1) to get a total path cost (e.g., path cost = 3). The link cost for communications between the router device 225b and the router device 225c may be determined from the link quality of the network communication link between the router device 225b and the router device 225c, which may be the smaller of the LQI and LQO of the network communication link (e.g., link quality = 3).

Each router device may send/broadcast an advertisement message that includes the path cost to one or more other router devices in the network 200c. The router devices that receive the path cost information from the router device that sent the advertisement message may update their respective path cost information in their local router tables (e.g., by adding their link cost for communications with the router device that sent the advertisement message to the path cost in the received message). Each router device may use the locally-stored path cost information to identify the path through with messages may be communicated. For example, messages transmitted from the router device 225b to the leader device 215 may be communicated through the router device 225a or the router device 225c. The router device 225b may receive respective advertisement messages from the router device 225a and the router device 225c that indicate the path cost for communication of messages between the router device 225a and the leader device 215 is the same as the path cost for communication of messages between the router device 225c and the leader device 215 (e.g., path cost = 2 on each network communication link). The router device 225b may add the link cost calculated for communicating messages between the router device 225b and the router device 225c (e.g., link cost = 1) to the path cost information received in the advertisement message from the router 225c (e.g., path cost = 2) to determine the total path cost for communicating with the leader device 215 through the router device 225c (e.g., total path cost = 3). The router device 225b may similarly add the link cost calculated for communicating messages between the router 225b and the router 225a (e.g., link cost = 2) to the path cost information received in the advertisement message from the router 225a (e.g., path cost = 2) to determine the total path cost for communicating with the leader device 215 through the router device 225a (e.g., total path cost = 4). The router device 225b may update a locally-stored router table with the lowest calculated path cost for communicating with the leader device 215 and/or the identifier of the router device through which messages are to be transmitted (e.g., router 225c). Each router device may similarly update their respective locally-stored router table with the lowest calculated path cost for communicating with the other router devices in the network 200c. For example, as shown in FIG. 2E, the leader device 215 and the router device 225c may each calculate the lowest path cost for communicating to other router devices in the network 200c and store the path cost in the respective router tables 229, 261. The router tables 229, 261 may also have stored therein the router identifier of the next hop from the respective devices 215, 225c through which messages are to be communicated to achieve the calculated path cost for communications to the destination router device.

Through periodically updating the link quality (e.g., LQI and/or LQO), link cost, and/or path cost, and communicating the path cost to other router devices in periodic advertisement messages, each router device may have up-to-date path cost information for communicating messages to other router devices in the network 200c. The router device may use the best communication path (e.g., lowest cost path) for communicating messages to another device. This routing mechanism may allow router devices to detect when other router devices have dropped off the network 200c, or a path cost between router devices has changed, and calculate the next lowest cost path to maintain connectivity to other router devices in the network 200c.

In an effort to distinguish relatively older data being transmitted in the periodic advertisement messages from relatively newer data transmitted in the periodic advertisement messages, the advertisement messages may be communicated with a sequence number. The leader device, such as leader device 215, may be responsible for updating the sequence number and distributing the updated sequence number to the other router devices in the network (e.g., router devices 225a, 225b, 225c, 225d, 225e, 225f in network 200c). For example, the leader device 215 may increment the sequence number periodically (e.g., after transmission of one or more advertisement messages) and/or after a router device is added to the network. The sequence number may be updated to allow router devices in the network (e.g., leader device 215 and/or router devices 225a, 225b, 225c, 225d, 225e, 225f in network 200c) to identify updated network information transmitted in advertisement messages. For example, as router devices (e.g., leader device 215 and/or router devices 225a, 225b, 225c, 225d, 225e, 225f in network 200c) may be periodically communicating advertisement messages that include path cost information that indicates the path cost for communicating with other router devices in the network, the sequence number may be updated to identify the updated path cost information.

After the leader device 215 updates the sequence number, the leader device 215 may distribute the sequence number to other router devices in the network. For example, the leader device 215 may use the sequence number in its own advertisement messages. After receiving the updated sequence number, each router device may use the updated sequence number for subsequent advertisement messages transmitted from the router device on the network. Each sequence number transmitted from the leader device 215 to the other router devices may be used in the advertisement messages for the router devices until a subsequent sequence number is distributed by the leader device 215. For example, the router device 225c may receive the sequence number directly from the leader device 215 and use the sequence number in subsequent advertisement messages. The router device 225b may receive the sequence number in the advertisement messages transmitted from the router device 225c and use the sequence number in subsequent advertisement messages transmitted from the router device 225b. The router devices may each use the current sequence number until an updated sequence number is received that is originated at and distributed from the leader device 215. Each router device may update the locally-stored network information in the router table when the router device receives an advertisement message from a non-leader router device (e.g., router devices 225a, 225b, 225c, 225d, 225e, 225f) that has an updated sequence number. If a router device receives an advertisement message that has the same sequence number as a previously received advertisement message, and/or previously received from the same non-leader router device, the router device may fail to process the advertisement message. If a router device fails to receive an updated sequence number within a predefined period of time (e.g., minutes, seconds, etc.), the router may assume the leader device 215 is unavailable for communications (e.g., offline, powered off, dropped from the network, changed roles, or is otherwise unable to communicate with the router device) and attempt to form another network or network partition having another leader device 215.

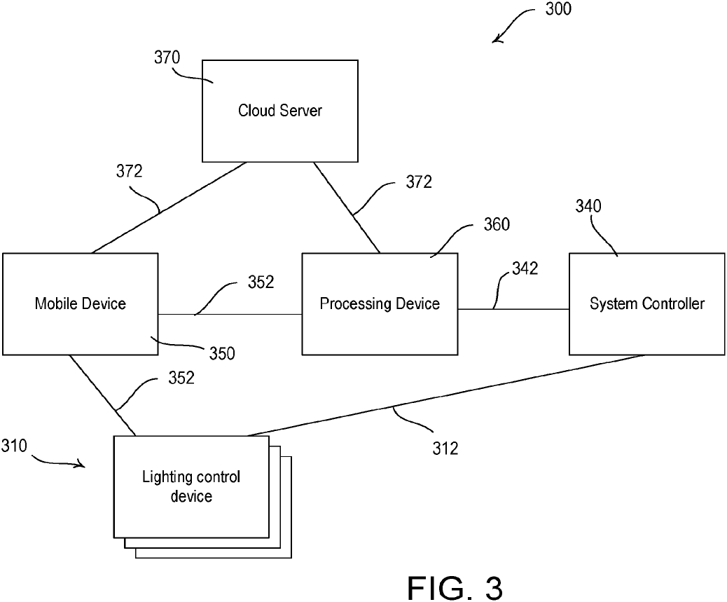

FIG. 3 is a system diagram illustrating an example control system 300 (e.g., the load control system 100 shown in FIG. 1A). As shown in FIG. 3, the control system 300 may include load control devices, such as lighting control devices 310 (e.g., the LED driver 130), for being commissioned. The lighting control devices 310 may be commissioned by configuring the lighting control devices 310 for lighting control. The lighting control devices 310 may be configured for lighting control by being claimed, assigned to different fixtures, groups, zones and/or locations in configuration data of the control system 300 and/or joined to a communication link 312, such as a wireless communication network. The lighting control devices 310 may be configured by defining preset scenes or other lighting control parameters by which the lighting control devices 310 may be controlled.

The control system 300 may include a system controller 340 (e.g., the system controller 140). The system controller 340 may be in communication with the lighting control devices 310 via the communication link 312 for performing lighting control according to lighting control configuration information that may be previously stored thereon (e.g., on the system controller 340) during operation. The lighting control configuration information may include preset configurations, zone configurations, occupancy configurations, and/or timing schedule configurations for controlling the lighting control devices 310.

The lighting control configuration information may be generated by a computing device, such as a processing device 360 (e.g., a personal computer or a laptop). The processing device 360 may be a computing device on which design software may be executed for configuring (e.g., claiming, diagnostics, association, etc.) and/or controlling the design of the load control system within a load control environment. The processing device 360 may generate a control database including the lighting control configuration information (e.g., load control parameters) based on the floorplan and design of the lighting control system. The processing device 360 may generate a project code identifier for identifying the project within which the floorplan and/or control database for controlling devices in the floorplan are stored. The lighting control configuration information of the control database may be stored at the lighting fixtures 310 or at the system controller 340 for enabling lighting control according to the information. The processing device 360 may be in communication with the system controller 340 via communication link 342. The communication link 342 may be a wired or wireless communication link, such as an Ethernet link and/or a local network HTTPS communication link, for example. The system controller 340 may send the lighting control configuration information to the lighting control devices 310 and/or control the lighting control devices 310 according to the lighting control configuration information (e.g., via the communication link 312).

After generating the lighting control configuration information at the processing device 360, the processing device 360 may share the lighting control configuration information with other devices for being updated and/or to assist in commissioning of the control system 300. For example, the processing device 360 may store the lighting control configuration information on a remote data source, such as a cloud server 370, for access by other devices. The processing device 360 may communicate with the cloud server 370 via a communication link 372. The communication link 372 may enable communications via wired and/or wireless signals (e.g., using Internet protocol (IP) and/or Hypertext Transfer Protocol (HTTP) communications). The lighting control configuration information may be stored at the processing device 360 and/or the cloud server 370 with a project identifier for being differentiated from other projects.

The control system 300 may include a computing device, such as a mobile device 350 (e.g., a smart phone or a tablet), which may be implemented to claim (e.g., discover) control devices (e.g., the lighting control devices 310) for commissioning the control system 300. The mobile device 350 may allow a user to access a control database for a project in the control system 300 and discover the lighting control devices 310 for being configured for the project. The lighting control devices 310 may be discovered by the mobile device 350 via a wireless communication link 352 (e.g., a short-range wireless communication link). The wireless communication link 352 may allow for the communication of beacon messages or other short-range RF communications. The wireless communication link 352 may comprise RF signals that are communicated using a short-range RF protocol communication protocol.

The mobile device 350 may access the lighting control configuration information of the control database from the cloud server 370 and/or from the processing device 360. The mobile device 350 may be in communication with the cloud server 370 via the communication link 372. The mobile device 350 may be in communication with the processing device 360 via a wireless communication link 352. The mobile device 350 may also, or alternatively, access the lighting control configuration information of the control database via a direct wired connection, such as a universal serial bus (USB) cable, and/or a computer-readable medium, such as a USB drive or other external memory.

The mobile device 350 may execute an application locally thereon to assist in commissioning the control system 300. The user may select a button on the application to synchronize the lighting control configuration information in the application with the lighting control configuration information stored for a project in the cloud server 370. A user of the mobile device 350 may access area and zone information in the lighting control configuration information for assigning lighting control devices 310 that have been discovered.

As the lighting control devices 310 are assigned to fixtures, groups, zones, and/or locations at the mobile device 350, the lighting control configuration information may be updated and sent to the cloud server 370. For example, the lighting control device identifiers and/or beacon identifiers of each lighting control device 310 may be stored with an associated area, zone and/or position within a zone for being controlled accordingly. The lighting control configuration information may then be accessed by the processing device 360 for being sent to the system controller 340 and/or the lighting control devices 310 for enabling lighting control according to the updated assignments.

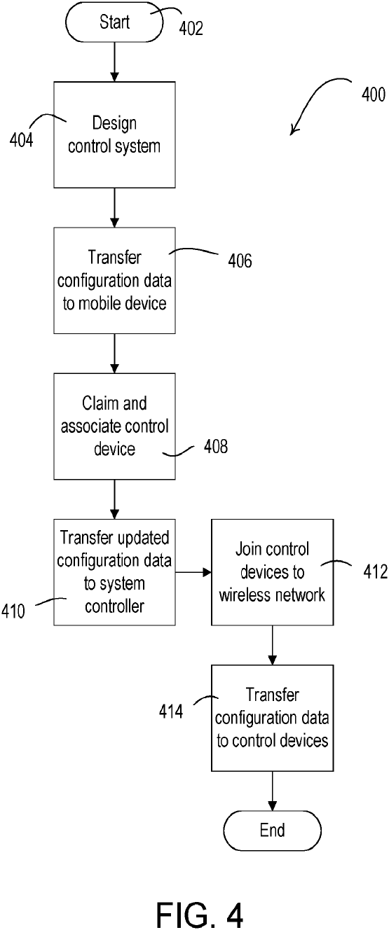

FIG. 4 is a flowchart depicting an example method 400 (e.g., a commissioning procedure) for commissioning a control system, such as a load control system (e.g., the load control system 100, 300). The method 400 may be implemented by one or more devices. For example, the method 400 may be implemented by a system controller (e.g., the system controller 110, 340), a cloud server (e.g., the cloud server 370), and/or a computing device, such as a mobile device (e.g., the mobile device 190, 350) and/or a processing device (e.g., such as the processing device 360). The method 400 may begin at 402.

At 404, the load control system may be designed (e.g., as part of a design procedure). For example, the load control system may be designed using a design software running on the processing device. The design software may be configured to generate configuration data that may define the operation and/or functionality of the load control system. The configuration data may be stored in a configuration database (e.g., on the processing device, the cloud server, the mobile device, and/or the system controller). The processing device may store the configuration data (e.g., the configuration database) in a project (e.g., which may include other identifying information of a building in which the load control system may be installed). The configuration data may include representations of the control devices (e.g., lighting fixtures, occupancy sensors, remote control devices, etc.) in the load control system, as well as configuration identifiers (e.g., fixtures, groups, zones, areas, and/or location identifiers) of the control devices. For example, the configuration data may define functionality of the control devices (e.g., how lighting fixtures respond to the occupancy sensors and/or the remote-control devices). The configuration data may indicate the roles of one or more control devices on the network. The configuration data may define lighting control configuration information including control parameters that may be stored in the control devices and/or the system controller (e.g., as will be described below at 414). The control parameters may be used by the control devices and/or system controller to control electrical loads during normal operation (e.g., after the method 400 is complete).

At 406, the configuration data (e.g., all or portions of the configuration database) may be transferred from the processing device to the mobile device (e.g., as part of a configuration data transfer procedure). For example, the processing device may be configured to transfer the configuration data to the mobile device via the cloud server. When the configuration data is ready to be transferred (e.g., when the control devices of the control system are ready to be claimed and/or associated with configuration identifiers (e.g., zone or group identifiers for being joined to a network) of the configuration data), the processing device may transmit the configuration data to the cloud server via the Internet (e.g., via the communication link 372 using IP and/or HTTP communications). The processing device may display a project code (e.g., a code unique to the project of the load control system being commissioned). For example, the project code may comprise an alphanumeric sequence. A user may enter the project code into a configuration application running on the mobile device. The mobile device may transmit the project code to the cloud server, which may transmit the configuration data to the mobile device. In addition, the processing device may display a machine-readable code, such as a barcode and/or a quick response (QR) code, and the mobile device may scan the machine-readable code to determine the project code. When the processing device and/or the mobile device do not have Internet access, the configuration data may be transferred (e.g., directly transmitted) from the processing device to the mobile device via a direct wired connection, such as a universal serial bus (USB) cable, and/or a computer-readable medium, such as a USB drive or other external memory at 406. Further, the configuration data may be transmitted (e.g., directly transmitted) from the processing device to the mobile device via a short-range wireless communication link.

At 408, the control devices of the load control system may be claimed and/or associated with configuration identifiers of the configuration data (e.g., fixtures, groups, zones, areas, and/or locations that may be defined by the configuration data). For example, the mobile device may claim and/or associate the control devices with the configuration identifiers of the configuration data as part of a configuration procedure (e.g., a claiming procedure and/or an association procedure) at 408. For example, the mobile device may begin to transmit (e.g., periodically transmit) a mobile device beacon message via a short-range wireless communication link (e.g., via the communication link 352 using BLE technology). The control devices that receive the mobile device beacon message and are within a discovery range of the mobile device may be configured to transmit a respective control device beacon message. The mobile device may receive control device beacon messages from multiple control devices and may choose a control device from which a control device beacon message was received to claim (e.g., the control device from which a control device beacon message was received with the strongest received signal strength indicator). The installer may choose the configuration identifier to which to associate the present control device from the mobile device to initiate claiming of the control device. The installer may move the mobile device around the building in which the load control system is installed to claim and associate each of the control devices. As each of the control devices are claimed, the control device that is being claimed may transmit a unique identifier (e.g., a serial number) to the mobile device, and the mobile device may store the unique identifier as well as information about the association between the configuration identifier and the control device in the configuration data. When the installer is done claiming control devices (e.g., the mobile device has claimed all or a portion of the control devices of the load control system), the configuration procedure may end.

Before being claimed at 408, the control devices may listen (e.g., continuously listen) for the mobile device beacon message on the short-range wireless communication link (e.g., the communication link 352). After being claimed at 408, the control devices may enter a joining mode. In the joining mode, the control devices may periodically switch between listening for the mobile device beacon message (e.g., using BLE technology) and listening for a request to join a wireless communication network (e.g., the communication link 312). Switching between listening for the mobile device beacon message and listening for the request to join the wireless communication network may allow the control devices to be ready to join the wireless communication network while still allowing the mobile device to connect to one or more of the control devices (e.g., to correct mistakes made while claiming a control device, or to unclaim a control device).

At 410, the configuration data (e.g., as updated during the configuration procedure of 408) may be transferred from the mobile device to the system controller. For example, the configuration data may be transferred from the mobile device to the system controller via the processing device. For example, the mobile device may be configured to transfer the configuration data to the processing device via the cloud server, via a direct wired connection, and/or via a short-range wireless communication link (e.g., as described above at 406). The processing device may then transmit the configuration data (e.g., all or a portion of the configuration database) to the system controller or another commissioner device (e.g., via the communication link 342). The commissioner device may be a device on a wireless communications network that is used to join other devices to the network. For example, the commissioner device may be a system controller, a lighting control device, an input device, etc. In addition, the mobile device may be configured to transmit the configuration data to the system controller via the cloud server (e.g., without transmitting the configuration data to the processing device). Further, the mobile device may be configured to transmit (e.g., directly transmit) the configuration data to the system controller via a direct wired connection and/or via a short-range wireless communication link.

The configuration data may include device identification data received from control devices, such as lighting fixtures. The configuration data may include the roles of devices on a network for being stored locally thereon for operating on the network. The system controller or other commissioner device may receive the device identification data of multiple devices. For example, multiple devices may have participated in the claiming procedure performed at 408. For each device that participated in the claiming procedure, the computing device may transfer device identification data to the system controller or other commissioner device. The device identification data for each device may be transferred separately (e.g., not at the same time). The system controller or other commissioner device may indicate to a user (e.g., via an application executing on a separate computing device) how many devices have been claimed for being joined to the network and/or how many devices remain to be claimed for being joined to the network. For example, the computing device may display a list of each control device in the area (e.g., in textual or graphic form). The color of a lighting fixture may change once the system controller or other commissioner device has received device identification data for that lighting fixture. The system controller or other commissioner device may aggregate the device identification data received from the devices and may generate a single list of lighting fixtures.

The system controller or other commissioner device may be operating in an offline mode (e.g., the commissioner device may be disconnected from the Internet or otherwise unable to access a particular online service used during commissioning). The computing device may transfer the device identification data to the system controller or other commissioner device (e.g., directly to the commissioner device) via, for example, an RF signal, a USB transfer, and/or the like. In addition, the computing device may transfer the device identification data to the system controller or other commissioner device via a processing device. The computing device may be physically connected to the processing device (e.g., via USB). For example, the computing device and the processing device may be connected by a cord with USB connectors at either end. The computing device may transfer the device identification data to the processing device via the physical connection. The computing device may be physically connected to the system controller or other commissioner device via a wired digital communication link (e.g., via an Ethernet link). The processing device may transfer the device identification data to the system controller or other commissioner device via the wired digital communication link. The computing device may transfer the device identification data by transferring (e.g., copying) the device identification data to an external drive (e.g., a removable memory). The external drive may be connected to the processing device and the processing device may transfer (e.g., copy) the device identification data from the external drive to local memory. The processing device may store the device identification data in memory. The processing device may then transfer the device identification data to the commissioner device via the wired digital communication link. The commissioner device may also store the device identification data in memory.

At 412, the control devices that were claimed at 408 may be joined to a wireless communication network (e.g., the communication link 312). The system controller may operate as a commissioner device for joining the control devices to the wireless communication network. For example, the commissioner device may join the control devices to the wireless communication network as part of a joining procedure. After the control devices are joined to the wireless communication network, the control devices may communicate with each other via the wireless communication network during normal operation. In addition, the control devices may stop monitoring the network on which the mobile device beacon message was received, and may communicate on the wireless communication network (e.g., exclusively). At 414, the configuration data may be transferred to the control devices. For example, the system controller may transmit a portion of the configuration database that is relevant to a respective control device to that control device.

Noise sources (e.g., noise-generating devices) may be located in the space in which the network is deployed. For example, noise sources that may be located in the vicinity of the network may be wireless access points (WAPs), microwaves, video cameras, security badge readers, and other noise-generating devices. As noise sources are added to a space that may degrade the quality of communications on a communication link, or other control devices are added that may be able to improve the quality of communications on a communication link, the roles of the devices in the network may be updated to improve the quality of communications. For example, the roles of control devices that are located near noise sources may be assigned in a manner to optimize or otherwise improve the quality of communications in the space in which the network is deployed. Control devices that are located close to a noise source may have a higher chance of experiencing communication errors. As such, networks that assign control devices near a noise source to the role of a router device may fail to be optimized and experience an increased likelihood of communication failures. In networks, such as mesh networks, which rely on router devices for receiving messages, the router devices themselves may be unable to receive messages due to their proximity to the noise source. Furthermore, other children devices may also suffer due to the router devices’ proximity to the noise source because this router does not repeat the messages because it failed to receive the messages in the first place. The control devices that are located near a noise source may be supported by assigning the role of a router device to devices that are far enough from the noise source to experience less communication errors, but close enough to the noise source to provide support for improved network communications to other control devices near the noise source at a strong enough signal strength to potentially overcome the noise source.

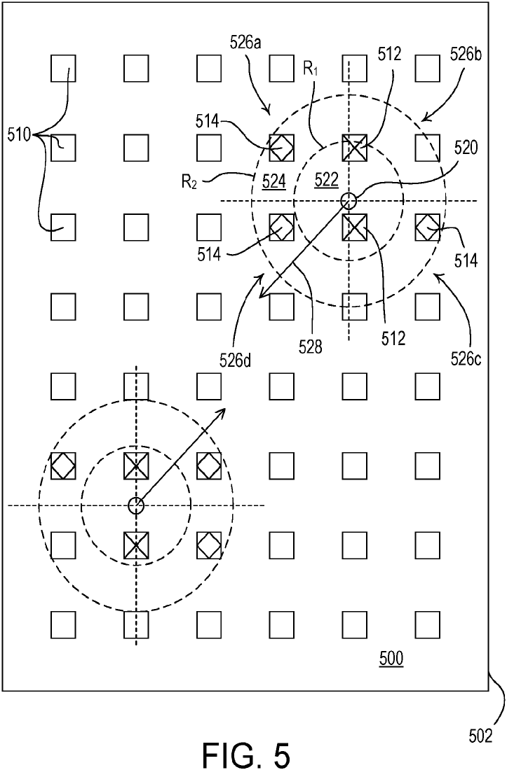

FIG. 5 is a top view of an example space 500 of a building 502. The space 500 may comprise a plurality of lighting fixtures 510. Each of the lighting fixtures 510 may comprise a lighting load (e.g., the LED light source 132) and a lighting control device (e.g., the LED driver 130) for controlling the intensity level and/or color (e.g., color temperature) of the lighting load. The lighting control devices of the lighting fixtures 510 may be configured to transmit and receive messages (e.g., digital messages) via wireless signals (e.g., the RF signals 108, 109). The lighting control devices of the lighting fixtures 510 may be configured to communicate via a network (e.g., via the networks 200, 200a, 200b, 200c and/or via the communication link 312) For example, the fixtures 510 may be square fixtures that are laid out in a grid pattern as shown in FIG. 5. However, the fixtures 510 may be different sizes or shapes, and/or laid out in a different manner.

The space 500 of the building 502 may also comprise one or more noise sources 520 (e.g., noise-generating devices), such as wireless access points (WAPs), microwaves, video cameras, security badge readers, and/or other noise-generating devices. The lighting control devices in the lighting fixtures 510 that are located close to or within a predefined transmission range of the noise sources may have trouble communicating on the network. The communication issues may be worsened when the lighting control devices in the lighting fixtures 510 that are located close to or within a predefined transmission range of the noise sources are operating as router devices in the network.

A router adjustment procedure may be executed to adjust the lighting control devices that are operating as router devices in the network to improve communications on the network. The lighting devices that are within a first range 522 around each of the noise sources 520 may be configured to operate in roles other than as router devices (e.g., may be prevented from operating as router devices). The lighting devices that are within the first range 522 may be configured operate as end devices. The first range 522 may be characterized by a minimum radius Ri. For example, as shown in FIG. 5, the lighting control devices in lighting fixtures 512 located in the first range 522 around each of the noise sources 520 may be configured to operate in roles other than router devices, and may operate (e.g., limited to operate) as end devices in the network.

In addition, some of the lighting devices that are within a second range 524 around each of the noise sources 520 may be configured to operates as router devices (e.g., boundary router devices and/or boundary router-eligible end device). The second range 524 may be between the minimum radius Ri and a maximum radius R₂ that is larger than the minimum radius R₁. For example, as shown in FIG. 5, the lighting control devices in lighting fixtures 514 located in the second range 524 around each of the noise sources 520 may be configured to operate (e.g., limited to operate) as boundary router devices in the network.

The first range 522 and the second range 524 may be characterized by a radio frequency signal strength around the noise sources 520. For example, the distance for the minimum radius Ri and/or the maximum radius R₂ may change according to the transmit power coming from the noise sources 520 (e.g., different WAP transmit power may result in different distances for the minimum radius Ri and/or the maximum radius R₂). Each control device may be determined to be within the minimum radius Ri and/or the maximum radius R₂ based on the noise floor at the control device. A user may adjust the minimum radius Ri and/or the maximum radius R₂ value in design software at a processing device and/or the minimum radius Ri and/or the maximum radius R₂ may be transmitted to the control devices or a system controller. In the design software, the user may choose a type of noise source and/or transmit power for the noise source and the minimum radius Ri and/or the maximum radius R₂ may be set based on the type of noise source and/or the transmit power of the noise source.

The first range 522 may be used to target boundary router devices that are at least a minimum distance from the noise source, so that the impact from the noise source on communications to/from the boundary router devices may be limited. The second range 524 may be used to target boundary router devices that are not further than a maximum distance from the noise source, as the boundary router devices may communicate messages to end devices closer to the noise source at a high enough signal strength to overtake the noise source. The boundary router devices may be located around each of the noise sources at an appropriate distance such that they may be able to communicate with the end devices within the first range 522 (e.g., the lighting control devices in the lighting fixtures 512) as well as other control devices in the network outside of the second range 524. The boundary router devices may be configured to facilitate communications between the lighting control devices located near the noise sources 520 and the lighting control devices located away from the noise sources. The router adjustment procedure may assign a predetermined number of boundary router devices (e.g., 2-4 boundary router devices) around each of the noise sources 520. The number of boundary router devices per noise source 520 may be dependent upon the total area (e.g., square footage) of the space 500 in which the network is to be deployed, the total number of control devices in the network, the noise floor or transmission power of the noise source 520, and/or the total number of noise sources 520 in the space 500. The number of boundary router devices may be increased for noise sources having a stronger transmit power that may cause greater interference. The number of boundary devices may be increased or decreased based on the type of noise source 520 that may be selected as described herein. The boundary router devices may be spaced apart from each other (e.g., by approximately 3-4 feet). For example, the second range 524 may be split into four quadrants 526a, 526b, 526c 526d as shown in FIG. 5. One boundary router device may be located in each of the quadrants 526a-526d. Multiple boundary router devices may also be located in each of the quadrants 526a-526d. For example, more boundary router devices may be located in each of the quadrants 526a-526d when noise sources 520 with a greater transmission power is indicated as being in the space. The boundary router devices may be located on the side of the second range 524 that is directed towards the majority of the control devices of the network (e.g., towards a central location of the network and/or the space 500), for example, as indicated by a direction indicator 528 (e.g., direction arrow) for each of the noise sources 520 in FIG. 5. In addition, the total number of boundary in router devices in the network may be limited, e.g., to approximately 9 boundary router devices. The number of boundary router devices may be limited to a number that leaves enough other router devices for the rest of the network. As described herein, for a given network the total number of router devices that are supported may be limited. As such, the number of boundary router devices may be limited to a defined portion of those router devices, such that the rest of the network has a sufficient number of router devices. The number of boundary router devices may be increased or decreased based on the size of the space.

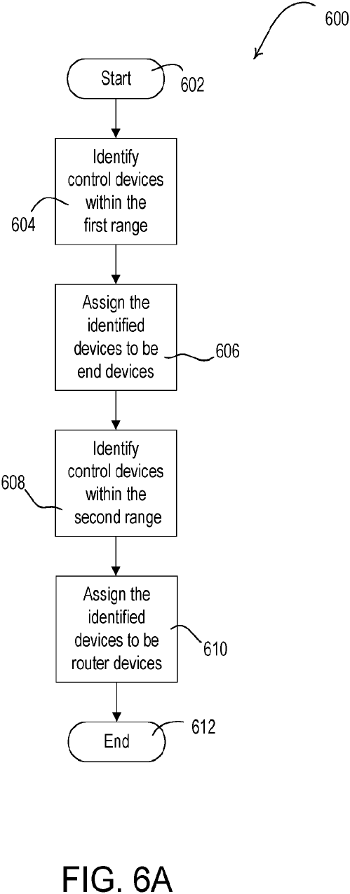

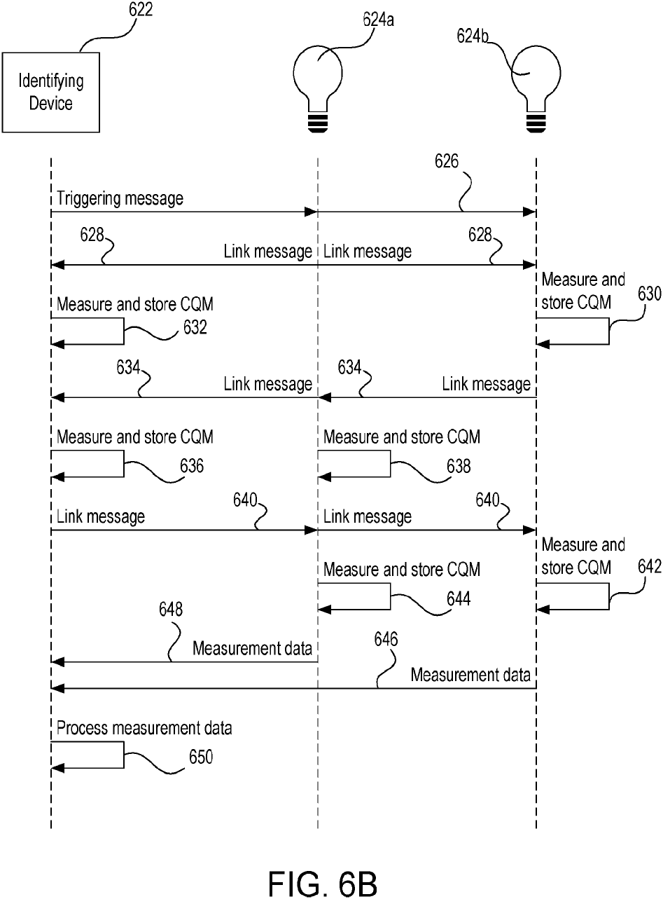

FIG. 6A is a flowchart of an example procedure 600 (e.g., a router adjustment procedure) that may be executed to configure control devices (e.g., the lighting control devices of the lighting fixtures 510) to operate as router devices based on their distance from noise sources (e.g., the noise sources 520) in the space in which the network is deployed (e.g., the space 500). The control devices that are being configured with the role of router devices or end devices may be router-eligible devices (e.g., router-eligible end devices) capable of operating as a router device or an end device.

The procedure 600 may start at 602. Control devices within a first range (e.g., the first range 522 within the minimum radius Ri) may be identified at 604 and the identified control devices may be assigned to be end devices at 606. Control devices within a second range (e.g., the second range 524 between the minimum range Ri and the maximum radius R₂) may be identified at 608 and the identified control devices may be assigned to be router devices at 610. The procedure 600 may exit at 612.

The control devices may be identified as being within the first range and/or the second range at 604 and 608 in various ways. For example, the control devices within the first range and/or the second range may be identified as part of a design procedure prior to installation and/or commissioning of the control devices and/or the network (e.g., as described at 404 of the procedure 400). For example, a control circuit of a processing device (e.g., the processing device 360) may execute a design software that may display a floorplan of the space and/or building in which the network is to be deployed. The floorplan may be displayed in a graphical user interface that looks similar to the top view of the space 500 of the building 502. The graphical user interface being displayed by the design software may display markers or icons on the floorplan indicating the locations of lighting fixtures (e.g., the lighting fixtures 510) and/or noise sources (e.g., the noise sources 520). The graphical user interface being displayed by the design software may also display the first and second ranges around the noise sources (e.g., as indicated by dashed circles having the minimum range Ri and the maximum radius R₂). The graphical user interface may display indicators of sections of the area between the first and second ranges (e.g., the quadrants 526a-526d). The graphical user interface may display a direction towards a central location of the control devices and/or a central location of the floorplan (e.g., the direction indicator 528). A user of the design software may visually identify the control devices within each of the first and second ranges, and/or the design software may automatically identify the control devices that fall within each of the first and second ranges.

In addition, the control devices within the first range and/or the second range may be identified after installation and/or commissioning of the control devices. For example, the control devices may be identified as being with the first range and/or the second range during the configuration procedure (e.g., the claiming procedure and/or the association procedure) at 408 of procedure 400 or after the joining procedure at 412 of the procedure 400. The control devices within the first range and/or the second range may be identified based on their distance from an identifying device located in the space and/or building in which the network is deployed. The identifying device may be a device capable of executing the instructions described herein for performing a router adjustment procedure to identify ranges from a noise source, select control devices for being assigned roles within a network, and/or assigning the roles to the control devices. For example, the identifying device may be a control device (e.g., one of lighting control devices in the lighting fixtures 512 shown in FIG. 5) that has been determined as being located in a noisy environment (e.g., has experienced communication errors due to being located close to or within a predefined transmission range of a noise source) or a mobile device (e.g., the mobile device 190 and/or the mobile device 350) that has been located close to or within a predefined transmission range of a noise source. The identifying device may be a system controller, a mobile device, a control device, or another computing device capable of performing the router adjustment procedures, or portions thereof, that are described herein based on information that is measured locally, or at a mobile device or a control device that is located close to or within a predefined transmission range of a noise source. When the identifying device is a control device, a control device that is located close to the noise source may be selected as the identifying device. The control device that is located closest to the noise source may be selected for identifying control devices that are within range of the noise source. The control device that is located closest to the noise source may have a greater number of communication errors than other control devices. The communication errors may be detected by the control devices identifying a number of lost messages over a period of time. The control device may determine that it is located in a noisy environment by measuring a noise floor or a link quality (e.g., link quality in and/or link quality out) for communications being transmitted to and/or received from the control device. The control devices may share their noise floor, link quality, or number of lost messages with each other or another device (e.g., the system controller) for aggregating the noise floor or link quality from each of the control devices. A control device may identify itself as having the highest noise floor value, lowest link quality value, or highest number of lost messages and become the identifying device. If another device (e.g., the system controller) aggregates the noise floor, link quality information, or number of lost packets from each of the control devices, it may select the identifying device and send a message that causes the selected control device to become the identifying device.

The first range and/or the second range may be identified based on network quality indicators received from the control devices themselves. For example, the control devices may measure background noise from which thresholds for the first range and/or the second range may be calculated at the identifying device. The thresholds for the first range and/or the second range may be determined based on a communication quality metric of measured background noise at one or more devices. The thresholds for the first range and/or the second range may also, or alternatively, be determined based on a communication quality metric (e.g., RSSI value) of messages that are communicated on network communication links between control devices. For example, the control devices that are communicating over the network may transmit (e.g., via unicast messages, multicast messages, and/or broadcast messages) one or more link messages on network communication links with other control devices. The control devices that receive these link messages may measure and store a communication quality metric of the link message along with an indication (e.g., a unique identifier) of the control device that transmitted the link message in communication quality metric data at the control device. This communication quality metric data may identify the number and quality of possible network communication links that a control device could establish on the network. As described herein, the communication quality metric may include or be calculated from an RSSI value at which the link messages are received, a link margin value (e.g., a link margin relative to the noise floor value) associated with the received link messages, and/or a signal-to-noise ratio value for the link messages received from the corresponding control device.

FIG. 6B illustrates a sequence flow diagram 620 illustrating example messages transmitted between an identifying device 622 and control devices 624a, 624b. The identifying device 622 may transmit a triggering message 626 (e.g., in response to entering a router adjustment mode) to trigger the control devices 624a, 624b to transmit link messages on network communication links with other control devices. The identifying device 622 and/or the control devices 624a, 624b may collect measurement data that includes communication quality metrics of the link messages received on the network and/or background noise levels measured at the devices. The measurement data may include background noise levels or noise floor values measured at each device. The background noise levels or noise floor values may include an average communication quality metric value (e.g., RSSI value) for noise generated on the network over a period of time.

After receiving the triggering message 626, a control device may transmit one or more link messages. For example, after receiving the triggering message 626 from the identifying device 622, the control device 624a may transmit a link message 628. A control device that receives the link message from another control device may measure and store a communication quality metric of the link message along with an indication of the device that transmitted the link message (e.g., the network address). The communication quality metric may include the received signal strength identifier (RSSI) of the link message. The communication quality metric may be calculated from the RSSI of the link message. For example, the communication quality metric may include a link margin or a signal-to-noise ratio value. The link margin may be a value relative to a predefined receive level. The link margin may, for example, indicate a relative value above the noise floor value measured at the control device. Each link margin value may indicate whether the link message was received at the control device above or below a link quality threshold. The link margin value and/or the signal-to-noise ratio value of a message may be calculated by subtracting a noise floor value of the noise floor at the control device from a received signal strength (e.g., RSSI) at which the message is received (e.g., the difference between the received signal strength identifier and the noise floor). In addition, or alternatively, the communication quality metric may include a link quality value (e.g., a link quality in or link quality out) itself, which may also be calculated as a predefined value above a noise floor value. The communication quality metric may be a calculated for each link message that is received, or may be averaged for multiple link messages received over time.

At 630, the control device 624b may measure and store the communication quality metric of the link message 628 transmitted by the control device 624a. At 632, the identifying device 622 may measure and store the communication quality metric of the link message 628 transmitted by control device 624a. The communication quality metric of the link message 628 may be measured and stored at the identifying device 622 and the control device 624b for each device to identify the quality of communications being received from the control device 624a. In addition to the communication quality metric, the control device 624b and the identifying device 622 may store an indication of the link message’s source, such as a network identifier for the control device 624a.

In response to the triggering message 626, the control device 624b may transmit a link message 634 that includes its network identifier to the control device 624a and the identifying device 622. At 638, the control device 624a may measure and store the communication quality metric of the link message 634 transmitted by the control device 624b. At 636, the identifying device 622 may measure and store the communication quality metric of the link message 634 transmitted by the control device 624b. The communication quality metric of the link message 634 may be measured and stored at the identifying device 622 and the control device 624a for each device to identify the quality of communications being received from the control device 624b. In addition to the communication quality metric, the control device 624a and the identifying device 622 may store an indication of the link message’s source, such as a network identifier for the control device 624a.

The identifying device 622 may transmit a link message 640 to the control devices 624a, 624b. At 644, the control device 624a may measure and store the communication quality metric of the link message 640 transmitted by the identifying device 622. At 642, the control device 624b may measure and store the communication quality metric of the link message 640 transmitted by the identifying device 622. The communication quality metric of the link message 640 may be measured and stored at the control devices 624a, 624b for each device to identify the quality of communications being received from the identifying device 622. In addition to the communication quality metric, the control devices 624a, 624b may store an indication of the link message’s source, such as a network identifier for the identifying device 622.

As described herein, the control devices that receive link messages may aggregate the communication quality metrics of the received link messages in link quality information and generate measurement data that includes the link quality information. The measurement data from a given control device may indicate the number of control devices from which the link messages are received and the quality of the network links on which the link messages are received. For example, the measurement data may include the network addresses for each control device from which a link message has been received and the corresponding communication quality metrics for the link message received from that control device. Again, the communication quality metric of a link message may be an RSSI of the link message or a value calculated from the RSSI of the link message. For example, the communication quality metric may include a link margin or a signal-to-noise ratio value relative to the noise floor value or background noise level measured at the control device. In addition, or alternatively, the communication quality metric may include a link quality value (e.g., a link quality in or link quality out) itself, which may also be calculated as a predefined value above a noise floor value.

After generating the measurement data, a control device may transmit the measurement data 646, 648 to another control device to process and analyze the measurement data. The measurement data 646, 648 may include the communication quality metric at which the link messages are received at the respective control devices 624a, 624b and/or the noise floor values or background noise levels measured at the respective control devices 624a, 624b. The device to which the measurement data 646, 648 is transmitted may be the same device that transmitted the triggering message 626, or another device. For example, the control devices 624a, 624b may transmit measurement data 646, 648 to the identifying device 622, or to another device (e.g., a system controller, or other computing device). The measurement data 646, 648 may include the network identifier of the devices from which link messages are received, each with a respective communication quality metric of the link messages. The measurement data 646, 648 may include one or more link quality thresholds and/or the noise floor values measured at the respective control devices 624a, 624b.

At 650, the identifying device 622 and/or another device that receives the measurement data may process the measurement data, for example, to determine the quality of the communications experienced at a device. For example, the identifying device may process the communication quality metrics in the measurement data to determine the thresholds for the first range and/or second range of a noise source. The identifying device 622 may determine the noise floor values or background noise levels at each of the control devices 624a, 624b from the measurement data. The identifying device may also, or alternatively, process the communication quality metrics in the data to determine the control devices within one or more ranges of a noise source. In processing the measurement data, the identifying device 622 may determine the control devices capable of communicating with other devices on lower-quality network communication links to be closer to a noise source than control devices capable of communicating on higher-quality communication links. For example, as the communication quality metric data received from each control device identifies communication quality metrics indicating the quality of possible network links that a respective control device can establish with other control devices on the network, the identifying device 622 may identify the relative distance of devices from a noise source for being assigned the role of end device or router device, as described herein. The defined thresholds for establishing the first range and/or second range of the noise source may be set to a communication quality metric value, such as a link quality value or link quality indicator (e.g., link quality of 3, 2, 1, etc.). In another example, the identifying device 622 may receive RSSI values in the measurement data that indicates s signal strength at which the link messages are received and compare the RSSI value to a noise floor value or one or more link quality thresholds to identify a link margin of the link messages relative to the noise floor. The identifying device 622 may then determine the strength of the network communication link based on the link quality indicated by the calculated link margin. As described herein, the identifying device 622 may directly receive a link quality indicator in the communication quality metrics received in the measurement data that indicates the link quality of a network communication link on which link messages are received from a control device, or may perform the calculations based on the noise floor values (e.g., or background noise levels) and the received RSSI values of the measurement data received from the control devices.

Referring again to FIG. 6A, ranges may be identified based on a distance from the identifying device using beacon messages. For example, the router devices may be assigned at 610 based on the distance between the distance between the identifying device and the control devices may be determined using beacon messages transmitted on a short-range wireless communication link (e.g., the wireless communication link 352). The identifying device may periodically transmit locating beacon messages, and those control devices that receive the locating beacon messages may transmit control device beacon messages in response to receiving the locating beacon messages. The control devices may be identified to be within the first or second range based on a signal strength value (e.g., a received signal strength indicator) of either the locating beacon messages as received by the control devices and/or the control device beacon messages as received by the identifying device. For example, the control devices may be identified to be within the first range if an average received signals strength indicator value of the control device beacon messages received by the identifying device is greater than a maximum signal strength threshold. In addition, the control devices may be identified to be within the second range if the average received signals strength indicator value of the control device beacon messages received by the identifying device is between a minimum signal strength threshold and the maximum signal strength threshold.

The control devices that are within the first and/or second range may be configured to provide visible feedback. For example, the lighting control devices in the lighting fixtures 510 may provide visible feedback by blinking the lighting load and/or controlling the light emitted by the lighting load to a particular color. In some embodiments, the control devices that are within the first range may turn off and the control devices that are within the second range may turn blue. The control devices may determine that they are within the first or second range themselves and begin providing visible feedback, or the identifying device may determine that the control devices are within the first or second range and send a message configured to cause the control devices to provide visible feedback.

The identified control devices may be assigned to be end devices or router devices (e.g., boundary router devices and/or boundary router-eligible end devices) at 606 and 610 in various ways. For example, the control devices within the first range and/or the second range may be assigned to be end devices or boundary router devices as part of the design procedure prior to installation and/or commissioning of the control device (e.g., as described at 404 of the procedure 400). For example, a user of the design software may manually select the control devices within the first range to be assigned to be end devices, and the control devices in the second range to be boundary router devices. The user may select a predetermined number of control devices to be assigned to be boundary router devices around each of the noise sources. The user may select one control device in each quadrant of the second range to be boundary router devices. For example, the user may select one device in each quadrant of those quadrants that are located in the direction of the center of the control devices and/or the floorplan to be boundary router devices. In addition, the design software may automatically select the control devices within the first range to be end devices, and the control devices in the second range to be boundary router devices. The control devices that have been assigned to be boundary router devices or end devices may be transmitted configuration data that instructs those control device with their assigned role during the configuration procedure (e.g., the claiming procedure and/or the association procedure) at 408 of procedure 400 or after the joining procedure at 412 of the procedure 400. The control devices may then take on their assigned roles after joining the network (e.g., after the joining procedure at 412 of the procedure 400).

In addition, the control devices within the first range and/or the second range may be assigned to be end devices or boundary router devices after installation and/or commissioning of the control devices. For example, the identified control devices may be assigned to be end devices or router devices during the configuration procedure (e.g., the claiming procedure and/or the association procedure) at 408 of procedure 400 or after the joining procedure at 412 of the procedure 400. The identifying device may be configured to automatically assign the control devices within the first range to be end devices, and to assign a number of devices (e.g., 2-4 control devices) to be boundary router devices, while ensuring that there is a keepout distance (e.g., 3-4 feet) between the boundary router devices around a particular noise source. The keepout distance may allow for a minimum distance between each of the boundary router devices located around the noise source. In addition, the user may manually select the control devices in the first range to be assigned to be end devices and a number of control devices (e.g., 2-4 control devices) in the second range to be assigned to be boundary router devices using the application running on the mobile device. The mobile device may transmit configuration data to the selected control devices to cause the control devices to operate as end devices or boundary router devices.

The boundary router devices may be configured to adjust its configuration from other router devices to better operate in view of the interference from the noise source. For example, the boundary router devices may perform carrier sense multiple access (CSMA) techniques in order to increase reliability of communications on the network. The boundary router devices may perform listen-before-talk (LBT) techniques using a CSMA threshold. The CSMA threshold may be compared to a measured received signal strength indicator (RSSI) to determine whether the frequency channel is “quiet” enough for transmission of a packet. The CSMA threshold used by boundary router devices may be increased by a defined amount (e.g., from -70 dBm to -64 dBm) from a CSMA threshold being used by other router devices. The boundary router devices may increase a number of retransmission attempts from other router devices in response to each instance of LBT failure. For example, the boundary router devices may increase the number of retransmission attempts for multicast messages from 2 to 3. LBT failure may occur when the measured RF traffic on a frequency fails to be equal to or lower than a defined threshold. The CSMA threshold and/or number of retransmission attempts may be different for different types of noise sources.

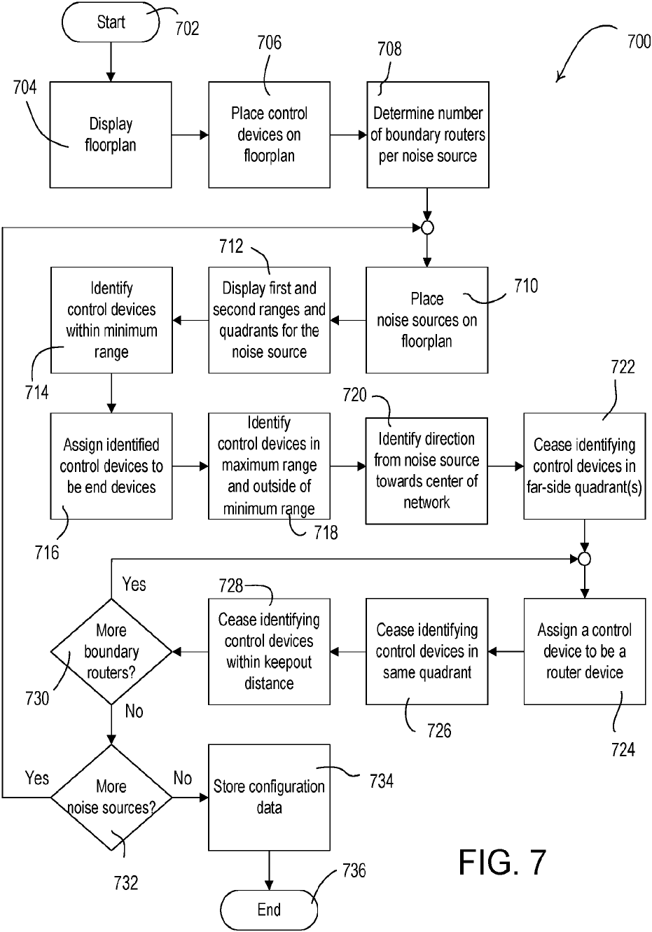

FIG. 7 is a flowchart of an example procedure 700 (e.g., a router adjustment procedure) that may be executed to assign control devices of a network (e.g., that may be located close to or within a predefined transmission range of noise sources) to be end devices or router devices prior to installation and/or commissioning of the control devices. The procedure 700 may be executed by one or more processing devices (e.g., the processing device 360) and/or a mobile device (e.g., the mobile device 350) as part of a design software. For example, the procedure 700 may be executed at 404 of the procedure 400 by one or more control circuits of the processing devices and/or mobile devices. The control devices that are being configured with the role of router devices or end devices may be router-eligible devices (e.g., router-eligible end devices). The procedure 700 may comprise a manual procedure for identifying the control devices within each range for being assigned different roles in the network. Though the procedure 700 may be described as being implemented by a single device, one or more portions of the procedure 700 may be implemented by other devices. For example, the procedure 700 may be distributed across multiple processing devices.

The procedure 700 may start at 702, for example, when a user opens the design software on the processing device and the control circuit of the processing device executes the design software. At 704, the control circuit of the processing device may display a graphical user interface that includes a floorplan of the space and/or building in which the network is to be deployed. The floorplan may be loaded into the design software from an external file, such as, an image file, a blueprint file, a drafting file, or other suitable file. At 706, the user may place icons (e.g., markers) of control devices (e.g., the lighting control devices of the lighting fixture 510) at appropriate locations of on the floorplan. The processing device may store a configuration identifier (e.g., an identifier indicating a fixture, group, zone, area, and/or location of the control device that may be defined by the configuration data generated by the design software) of the control device installed in the location of the icon or to be installed in the location of the icon, such that the configuration identifier can be associated with a role for being transmitted to the control devices. The configuration identifier may be entered by the user or uploaded with the floorplan data. The control circuit of the processing device may also store in memory location data indicating the location of the control devices on the floorplan relative to one another within the space when the control device is placed on the floorplan at 706. At 708, the control circuit of the processing device may determine a number of boundary router devices to place around each noise source. For example, the number of boundary router devices per noise source may be approximately 2-4 boundary router devices. The number of boundary router devices may be predetermined and stored in memory on the processing device. In addition, the number of boundary router devices per noise source may be manually entered by the user through the design software, e.g., by choosing from 2, 3, or 4 boundary router devices. Further, the processing device may be configured to automatically select the number of boundary router devices per noise source based on other configuration data regarding the network and/or space in which the network is to be deployed, such as, for example, the total area (e.g., square footage) of the space in which the network is to be deployed, the total number of control devices in the network, the type of noise source, and/or the total number of noise sources in the space. For example, the additional configuration data regarding the network and/or space in which the network is to be deployed may be retrieved from a database in the cloud and/or manually entered by the user through the design software.

Next, the user may place icons (e.g., markers) of noise sources (e.g., the noise sources 520) on the floorplan. The icons of noise sources may represent the locations of wireless access points (WAPs), microwaves, video cameras, security badge readers, and other noise sources in the space in which the network is to be deployed. At 710, the user may place an icon of a noise source on the floorplan, and the processing device may store location data indicating the location of the noise source on the floorplan in memory. At 712, the processing device may display first and second ranges and quadrants for the noise source. For example, the control circuit of the processing device may display circles representing the first and second ranges around the noise source (e.g., as represented by the dashed circles indicating the minimum radius Ri and the maximum radius R₂ in FIG. 5). In addition, the control circuit of the processing device may display lines between the quadrants (e.g., as represented by the dashed lines between the quadrants 526a-526d in FIG. 5).

At 714, the control circuit of the processing device may identify the control devices that are within the first range of the noise source (e.g., within the range defined by the minimum radius R₁). The processing device may identify the control devices using a configuration identifier for the control device (e.g., an identifier indicating a fixture, group, zone, area, and/or location of the control device that may be defined by the configuration data generated by the design software). For example, the user may manually select the control devices that appear in the circle having the minimum radius Ri on the floorplan to allow the processing device to identify the control devices that are within the first range. If a control device icon overlaps the boundary of the first range and the second range, the control device may be selectable to be within the first range or the control device may be selectable to be within the second range, or may default to one of the first range or the second range. If the control device icon overlaps the boundary of the first range and the second range, the control device may be selectable in the first range or second the second range based on the center point of the icon that represents the fixture. If the center point of the control device icon is on the boundary of the first range and the second range, the control device may be selectable to be within the first range or the control device may be selectable to be within the second range.

The control circuit of the processing device may also, or alternatively, automatically identify the control devices that are within the first range using the stored location of the control devices (e.g., relative location in the space), the stored location of the noise source, and the minimum radius Ri. The control circuit of the processing device may highlight or otherwise indicate the control devices that are within the first range of the noise source on the graphical user interface. At 716, the control circuit of the processing device may assign the identified control devices to be end devices. For example, the processing device may store the configuration identifier along with an indication that the control device has been assigned to be an end device in the configuration data at 716.

At 718, the control circuit of the processing device may identify the control devices that are within the second range of the noise source (e.g., within the range defined between the minimum radius Ri and the maximum radius R₂). The processing device may identify the control devices using the configuration identifier for the control device. For example, the user may manually select the control devices on the graphical user interface that appear in the circular band between the minimum radius Ri and the maximum radius R₂ on the floorplan to allow the processing device to identify the control devices that are within the second range. In addition, the processing device may automatically identify the control devices that are within the second range using the stored location of the control devices, the stored location of the noise source, the minimum radius Ri, and the maximum radius R₂. The processing device may highlight or otherwise indicate the control devices that are within the second range of the noise source on the graphical user interface.

At 720, the control circuit of the processing device may identify a direction indicator representing a direction from the noise source towards the network (e.g., towards most of the control devices of the network and/or the central location of the space in which the network is to be deployed). For example, the user may manually set the direction indicator by drawing or selecting the direction indicator at the icon for the noise source on the floorplan (e.g., the direction indicator 528 shown in FIG. 5). In addition, or alternatively, the processing device may automatically set and display the direction indicator using the location of the noise source on the floorplan and either a location representing a center of the group of control devices of the network or a location indicating a center of the space.

At 722, the control circuit of the processing device may cease identifying the control devices in the far-side quadrants (e.g., those quadrants on the opposite side of the second range from the direction indicator determined at 720). For example, the processing device may cease identifying the control devices by no longer highlighting those control devices or otherwise preventing those control devices from being selected to be a router device. If the number of boundary router devices per noise source was determined to be two at 708, the processing device may cease identifying control device in two quadrants on the opposite side of the second range as the direction indicator. If the number of boundary router devices per noise source was determined to be three at 708, the processing device may cease identifying control device in a single quadrant on the opposite side of the second range as the direction indicator. If the number of boundary router devices per noise source was determined to be four at 708, the processing device may not cease identifying any of the control devices (e.g., may skip 722).

At 724, the control circuit of the processing device may assign one of the identified control devices to be a router device (e.g., a boundary router device). For example, the user may manually select one of the identified control devices within the second range to be assigned to be a boundary router device. In addition, the processing device may automatically select one of the control devices in one of the quadrants to be assigned to be a boundary router device. For example, the processing device may automatically select one of the control devices in the quadrant in which the direction indicator is located to be assigned to be a boundary router device the first time that 724 is executed for a particular noise source (e.g., the control device closest to the a direction indicator 528 shown in FIG. 5). The processing device may store the configuration identifier along with an indication that the control device has been assigned to be a boundary router device in the configuration data at 724. At 726, the control circuit of the processing device may cease identifying the control devices in the same quadrant as the assigned boundary router device. At 728, the processing device may cease identifying control devices that are within a keepout distance (e.g., approximately 3-4 feet) from the assigned boundary router device. The processing device may be configured to determine the control devices that are within the keepout distance from the assigned boundary router device using the stored location of the assigned boundary router device, the stored locations of the other control devices, and the keepout distance. At 726 and 728, the processing device may cease identifying the control devices by no longer highlighting those control devices or otherwise preventing those control device from being selected to be a boundary router device.

If there are more boundary router devices to assign for the noise source at 730 (e.g., the number of boundary router devices determined at 708 has not been reached), the processing device may assign one of the control device devices (e.g., that is still being identified as being a potential boundary router device) to be a boundary router device at 724. If there are not more boundary router devices to assign for the noise source at 730, but there are more noise sources to place in the space in which the network is to be deployed at 732, the user may place an icon indicating another noise source at 710.

When there are no more noise sources to identify at 732, the control circuit of the processing device may store the configuration data in memory that identifies which control devices should be boundary router devices and end devices (e.g., based on their configuration identifiers) at 734, and the procedure 700 may end at 736. For example, the configuration data may be transmitted to the control devices from the mobile device during the configuration procedure (e.g., the claiming procedure and/or the association procedure) at 408 of procedure 400.

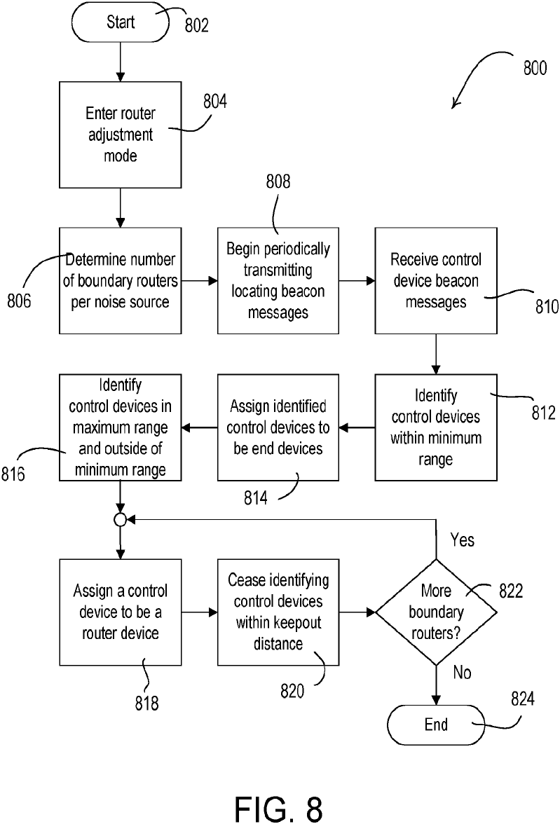

FIG. 8 is a flowchart of an example procedure 800 (e.g., a router adjustment procedure) that may be executed to assign control devices of a network (e.g., that may be located close to or within a predefined transmission range of noise sources) to be end device or boundary router devices after installation and/or commissioning of the control device. For example, the procedure 800 may be executed during the configuration procedure (e.g., the claiming procedure and/or the association procedure) at 408 of procedure 400 or after the joining procedure at 412 of the procedure 400. The control devices that are being configured with the role of router devices or end devices may be router-eligible devices (e.g., router-eligible end devices) capable of operating as a router device or an end device on the network. The procedure 800 may be executed by a control circuit of an identifying device (e.g., the control circuit 131 of the device 130 and/or the control circuit 181 of the load control device 180) that may be used to locate the center of first and second ranges around the noise source in which the control devices may be located. For example, the identifying device may be a control device that has been identified as having communication errors (e.g., may be located close to or within a predefined transmission range of a noise source) or a mobile device that has been located close to or within a predefined transmission range of a noise source (e.g., by a user physically positioning the mobile device near (e.g., above, below, or adjacent to) the noise source). The distance between the mobile device and the noise source may be used in determining the wireless range of the control devices from the noise source. For example, the ceiling height may be entered into the mobile device and the distance between the floor and the ceiling may be used to determine the range of the control devices from the noise source, as the control devices and/or the noise source may be located in the ceiling. Though the procedure 800 may be described as being implemented by a single device, one or more portions of the procedure 800 may be implemented by other devices. For example, the procedure 800 may be distributed across multiple identifying devices.

The procedure 800 may start at 802, for example, when a user opens the design software on the mobile device and the mobile device executes the design software. When the identifying device is a control device, the procedure 800 may be triggered at the control device in response to a message received from another device in the load control system, such as the mobile device or the system controller. The control device may also automatically start the procedure 800 at 802 for entering the router adjustment mode at 804 in response to expiration of a timer or in response to changes in network conditions.. At 804, the control circuit of the identifying device may enter a router adjustment mode. For example, when a control device identifies that it is located in a noisy environment as described herein (e.g., has experienced communication errors due to being located close to or within a predefined transmission range of a noise source), the control circuit of the control device may automatically enter the router adjustment mode at 804. The communication errors may be detected by the control device identifying that it has a number of lost messages greater than a threshold over a period of time. The control device may determine that it is located in a noisy environment by having a high noise floor (e.g., above a threshold) or low link quality (e.g., link quality in and/or link quality out below a threshold) for communications being transmitted to and/or received from the control devices. When the identifying device is a control device, it may be the control device having the highest noise floor or lowest link quality of the control devices within wireless range of the noise source. The control devices may each communicate their noise floor and link qualities to other control devices for determining the control device having the highest noise floor or lowest link quality. In addition, when the identifying device is a mobile device, the control circuit of the mobile device may enter the router adjustment mode in response to an actuation of a button in an application running on the mobile device. At 806, the control circuit of the identifying device may determine a number of boundary router devices to place around each noise source. The number of boundary router devices per noise source may be stored in memory in the identifying device and may be transmitted to each of the control devices in the network during commissioning of the network (e.g., from the system controller 110, 340 and/or the mobile device 190, 350). For example, the number of boundary router devices per noise source may be approximately 2-4 boundary router devices. The number of boundary router devices may be predetermined and stored in memory on the identifying device. For example, the additional configuration data regarding the network and/or space in which the network is to be deployed may be retrieved from a database in the cloud and/or manually entered by the user through the design software. The number of boundary router devices per noise source may be selected (e.g., by the mobile device and/or the system controller) based on other configuration data regarding the network and/or space in which the network is to be deployed, such as, for example, the total area (e.g., square footage) of the space in which the network is to be deployed, the total number of control devices in the network, the noise floor or transmission power of the noise source, and/or the total number of noise sources in the space. Further, when the identifying device is a mobile device, the number of boundary router devices per noise source may be manually entered by the user through the application running on the mobile device, e.g., by choosing from 2, 3, or 4 boundary router devices.

At 808, the identifying device may begin to transmit (e.g., periodically transmit) locating beacon messages on a short-range wireless communication link (e.g., the wireless communication link 352). The locating beacon message may be triggered from the mobile device in response to a user actuation on the mobile device. The locating beacon message may be triggered at a control device in response to a message from the mobile device. The control devices that receive the locating beacon messages may begin to transmit (e.g., periodically transmit) control device beacon messages. For example, each control device may be configured to begin to transmit the control device beacon messages when a signal strength value (e.g., a received signal strength indicator value) of the locating beacon messages is greater than a signal strength threshold that may be stored in memory at the control device and/or included in the locating beacon message received by the control device. At 810, the identifying device may receive one or more control device beacon messages from the control devices. For example, the identifying device may store the unique identifier and a signal strength value (e.g., a received signal strength indicator value) of the control device beacon messages.

At 812, the control circuit of the identifying device may identify the control devices within the first range, for example, based on the signal strength value of the control device beacon messages. For example, the identifying device may identify the control device as being in the first range if the signal strength value is greater than a maximum signal strength threshold. The signal strength value that is greater than a maximum signal strength threshold may indicate that the control devices are within the defined rage of the identifying device. At 814, the control circuit of the identifying device may assign the control devices in the first range to be end devices, for example, by transmitting configuration data to the control device, where the configuration data indicates that the control devices should operate as end devices. For example, the identifying device may automatically transmit the configuration data for causing the control devices to be end devices at 814 after the identifying device identifies those control devices as being in the first range at 812.

In addition, when the identifying device is a mobile device, the mobile device may transmit a feedback message configured to cause the control device to provide visible feedback of a first feedback type (e.g., by controlling the light emitted by a lighting load to a first color) at 812, and the user may select the control devices in the first range to be assigned to be end devices at 812. For example, the mobile device may determine the control device within the first range from which control device beacon messages have been received at the mobile device with the highest signal strength value and transmit a feedback message configured to cause that control device to provide visible feedback of a second feedback type (e.g., by controlling the light emitted by the lighting load to a second color). The second feedback type may indicate to the user the control device that has the strongest signal strength to the mobile device in the first range, such that the control device may be identified and/or the location of the mobile device may be adjusted within the space to measure the signal strengths of different control devices relative to the noise source for being identified. The user may confirm that the control device providing the visible feedback of the second feedback type should be assigned to be an end device through the application running on the mobile device, and the mobile device may transmit the configuration data to the control device to cause the control device to operate as an end device. The control devices may stop providing the visible feedback after being configured to be end devices. Further, the control devices may automatically decide to become end devices and/or automatically provide visible feedback of the first feedback type based on the signal strength value of the locating beacon messages. For example, the control devices may receive the locating beacon messages, compare the locating beacon messages to a maximum signal strength threshold (e.g., predefined at the control devices or received in the locating beacon messages), and decide to become an end device when the signal strength value of the locating beacon message is greater than the maximum signal strength threshold.

At 816, the identifying device may identify the control devices within the second range, for example, based on the signal strength value of the control device beacon messages. For example, the identifying device may identify the control device as being in the second range if the signal strength value is between a minimum signal strength threshold and the maximum signal strength threshold. At 818, the identifying device may assign one of the control devices in the second range to be a boundary router device, for example, by transmitting configuration data to the control device, where the configuration data indicates that the control devices should operate as a boundary router device. For example, the identifying device may automatically select a first control device for being a boundary router device and transmit the configuration data for causing the selected control device to be a boundary router device at 818 as soon as the identifying device identifies the control devices that are in the second range at 816. The identifying device may select the control device within the second range, that is also outside of the first range, having the strongest received signal strength value of the control device beacon messages to be assigned as the boundary router device. The identifying device may select the control device within the second range, that is also outside of the first range, based on the noise floor or link quality to other router devices in the network. For example, the control devices may transmit their noise floor and/or link quality to other router devices to the identifying device (e.g., in response to a query message). The identifying device may select the first boundary router device by choosing the control device with the lowest noise floor or highest link quality to one or more other router devices. The boundary router device may begin transmitting a control device beacon for assigning other boundary router devices around the noise source.

At 820, the control devices within the second range that are also within a keepout distance of the control device that was just assigned to be a boundary router device at 818 may cease identifying as being available to be a potential boundary router device. For example, the identifying device may transmit a message including the unique identifier of the new boundary router device and/or the new boundary router device may be configured to transmit a message indicating that it has been assigned to be a boundary router device. The message may be the control device beacon message of the new boundary router device. The control devices may be configured to determine that they are within the keepout region of the new boundary router device at 820 based on a signal strength value of the control device beacon messages transmitted by the new boundary device and received at the various control devices (e.g., prior to the assignment of the new boundary router device at 818). For example, each control device may be configured to determine that it is within the keepout region if the signal strength value of the control device beacon messages received from the new boundary router device is greater than a keepout signal strength threshold. The signal strength at which the control device beacon signal is received may be sent to the identifying device for selecting the next boundary router device that is outside of the keepout signal strength threshold of the previously selected boundary router device(s). The identifying device may select the next boundary router device by choosing the control device with the lowest noise floor or highest link quality to one or more other router devices that is outside of the keepout signal strength threshold of the previously selected boundary router device(s).

In addition, when the identifying device is a mobile device, the mobile device may transmit a feedback message configured to cause the control device to provide visible feedback of a third feedback type (e.g., by controlling the light emitted by the lighting load to a third color) at 816 and the user may select one of the control devices in the second range to be assigned to be a boundary router device at 818. For example, the mobile device may determine the control device within the second range from which control device beacon messages have been received at the mobile device with the highest signal strength value and transmit a feedback message configured to cause that control device to provide visible feedback of a fourth feedback type (e.g., by controlling the light emitted by the lighting load to a fourth color). The fourth feedback type may indicate to the user the control device that has the strongest signal strength to the mobile device in the second range, such that the control device may be identified and/or the location of the mobile device may be adjusted within the space to measure the signal strengths of different control devices relative to the noise source for being identified. The user may confirm that the control device providing the visible feedback of the fourth feedback type should be assigned to be a boundary router device through the application running on the mobile device. A single control device may be limited to providing visible feedback of the fourth feedback type at one time. The user may move the mobile device around the space and/or actuate buttons on the app running on the mobile device to select other control devices in the second range to be assigned to be a boundary router device. After one of the control devices in the second range is selected, the mobile device may transmit the configuration data to the control device to cause the control device to operate as a boundary router device. The control devices may stop providing the visible feedback after being configured to be a boundary router device. Further, the control devices may automatically provide visible feedback of the third feedback type based on the signal strength value of the locating beacon messages (e.g., if the signal strength value between minimum and maximum signal strength thresholds). Each control device may stop providing visible feedback and/or otherwise prevent itself from being selected to be a boundary router device during the rest of the procedure 800 in response to determining that it is within the keepout region of the control device at 820.

If there are more boundary router devices to assign for the noise source at 822 (e.g., the number of boundary router devices determined at 806 has not been reached), the processing device may assign one of the control devices (e.g., that is still being identified as being a potential boundary router device) to be a boundary router device at 818. If there are not more boundary router devices to assign for the noise source at 822, the procedure may end at 824.

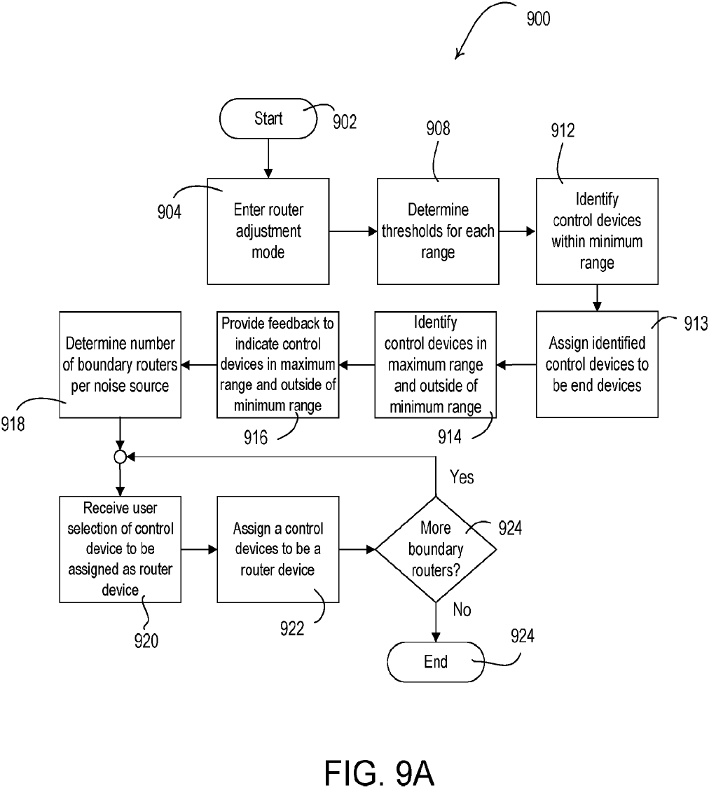

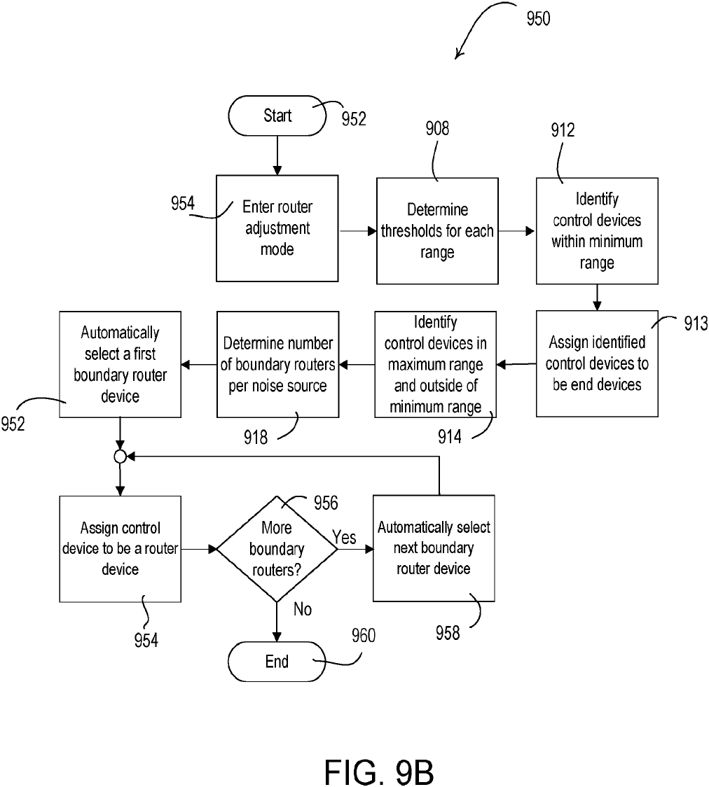

FIG. 9A is a flowchart of an example procedure 900 (e.g., a router adjustment procedure) that may be executed to assign roles to control devices of a network (e.g., that may be located close to or within a predefined transmission range of a noise source). For example, the procedure 900 may be executed during the configuration procedure (e.g., the claiming procedure and/or the association procedure) at 408 of procedure 400 or after the joining procedure at 412 of the procedure 400. The control devices that are being configured during the procedure 950 may be router-eligible devices (e.g., router-eligible end devices) capable of being assigned the role of router device or end device in the network. The procedure 900 may be executed by a control circuit of an identifying device (e.g., the control circuit 131 of the device 130, the control circuit 181 of the load control device 180). For example, the identifying device may be a mobile device or another computing device (e.g., a system controller or another computing device) capable of identifying control devices to be assigned as boundary router devices based on noise floor values measured at the control devices. Though the procedure 900 may be described as being implemented by a single device, one or more portions of the procedure 900 may be implemented by other devices. For example, the procedure 900 may be distributed across multiple identifying devices. The boundary router devices may be assigned using the procedure 900, which may be a partially-automated procedure, that allows for selection of boundary router devices based on measurement data received from the control devices.

The procedure 900 may start at 902. The identifying device may start the procedure 900 at 902 in response to input received from a user. At 904, the control circuit of the identifying device may enter a router adjustment mode. When the identifying device is a mobile device, the control circuit of the mobile device may enter the router adjustment mode in response to an actuation of a button in an application running on the mobile device. When the identifying device is another computing device (e.g., a system controller) the input may be received in a message from the mobile device in response to an actuation of a button in an application running on the mobile device.

At 908, the control circuit of the identifying device may determine a threshold for the first range and/or the second range. The thresholds may be set to communication quality metrics of background noise levels. The thresholds may be set to communication quality metrics of received messages at control devices. The thresholds may be determined by being calculated from measurements performed on the network, or may be predefined. For example, the thresholds may be based on measurement data generated at the identifying device and/or received from the control devices themselves. The measurement data may include a communication quality metric of background noise levels and/or a communication quality metric value of messages received from other devices on the network. As described herein, the communication quality metric may include the received signal strength identifier (RSSI) of the link messages received or the background noise levels. The communication quality metric may be calculated from the RSSI values. For example, the communication quality metric may include a link margin or a signal-to-noise ratio value. The link margin may be a value relative to a predefined receive level. The link margin may, for example, indicate a relative value above the noise floor value measured at the control device or the identifying device. Each link margin value may indicate whether a message (e.g., link message) was received at the control device above or below a link quality threshold. The link margin value and/or the signal-to-noise ratio value of a message may be calculated by subtracting a noise floor value of the noise floor at the control device or the identifying device from a received signal strength (e.g., RSSI) at which the message is received (e.g., the difference between the received signal strength identifier and the noise floor). In addition, or alternatively, the communication quality metric may include a link quality value (e.g., a link quality in or link quality out) itself, which may also be calculated as a predefined value above a noise floor value. The communication quality metric may be calculated for an individual message or for background noise levels at an instant in time, or may be averaged over time.

When the ranges are identified based on a communication quality metric of background noise levels, the control circuit of the identifying device may determine a baseline background noise level. For example, the baseline background noise level may be measured at the identifying device. When the identifying device is a mobile device, the mobile device may be located close to or within a predefined transmission range of a noise source (e.g., by a user physically positioning the mobile device near (e.g., above, below, or adjacent to) the noise source). The baseline background noise level may be measured as a communication quality metric value (e.g., RSSI value) of the measured background noise. The baseline background noise level may include a noise floor value that is set to an average communication quality metric value (e.g., RSSI value) for noise generated on the network over a period of time.

The baseline background noise level may be determined from one or more messages received from another device. For example, the control circuit of the identifying device may receive one or more messages from a control device from which the baseline background noise level is measured. The baseline background noise level may be measured at the control device or another device on the network and transmitted to the identifying device for establishing the baseline background noise level at the identifying device. The baseline background noise level may be transmitted from a control device that has been identified as having communication errors (e.g., may be located close to or within a predefined transmission range of a noise source) greater than a threshold. In another example, a user may select a control device on a graphical user interface for reporting one or more communication quality metric values from which the baseline background noise level may be determined at the identifying device. The control circuit of the identifying device may transmit a message via the communication circuit requesting the communication quality metric values from one or more devices and determine the baseline background noise based on the communication quality metric values received in messages in response. The control circuit of the identifying device may collect the communication quality metric values from multiple control devices and determine the baseline based on the communication quality metric values (e.g., control device having worst background noise). In another example, the baseline background noise level may be predefined at the identifying device.

The thresholds may be determined at 908 based on predefined values or an N^{th} percentage value of the baseline background noise level. For example, the control circuit of the identifying device may calculate a threshold TH_{R1} for a first range based on an N^{th} percentage value (e.g., a 95^{th} percentage value) of the baseline background noise level. The control circuit of the identifying device may calculate a threshold TH_{R2} for a second range based on another N^{th} percentage value (e.g., a 75^{th} to 85^{th} percentage value) of the baseline background noise level. In another example, the control circuit of the identifying device may calculate the first threshold TH_{R1} and/or the second threshold TH_{R2} by adding or subtracting a respective margin value (e.g., 2 dB, 10 dB, etc.) to the previously calculated baseline background noise level. The control circuit of the identifying device may calculate the first threshold TH_{R1} as an N^{th} percentage value of the baseline background noise level and calculate the second threshold by adding or subtracting a respective margin values (e.g., 2 dB, 10 dB, etc.) to the previously calculated threshold. The percentage values and/or the margin values may vary based on network size, the size of the space, the number of control devices, the strength of the noise source, and/or the number of available boundary router devices. Though described as being calculated at the identifying device, the thresholds for the first range and the second range may be calculated at the control devices themselves and may be transmitted to the identifying device.

When the ranges are based on measurement data generated at the control devices themselves, the thresholds may be determined at 908 as predefined values or an N^{th} percentage value of the communication quality metrics in the measurement data received from control devices. For example, the control circuit of the identifying device may calculate the threshold TH_{R1} for the first range and/or the threshold TH_{R2} for the second range as a predefined RSSI threshold, a predefined link margin or a signal-to-noise ratio value (e.g., a relative value above a noise floor value), a predefined link quality threshold, or another predefined threshold. The control circuit of the identifying device may calculate the threshold TH_{R1} for the first range and/or the threshold TH_{R2} for the second range based on the measurement data received from the control devices. For example, the threshold TH_{R1} for the first range may be set to a first averaged value or a first percentage of the communication quality metrics received from the control devices, or a subset of the control devices. For example, the threshold TH_{R2} for the second range may be set to a second averaged value or a second percentage of the communication quality metrics received from the control devices, or a subset of the control devices. The control circuit of the identifying device may set the threshold TH_{R1} for the first range and/or the threshold TH_{R2} for the second range as a percentage value at which messages (e.g., link messages) are received at the control devices relative to the noise floor or background noise level measured at the device. For example, the threshold TH_{R1} for the first range may be set to a first N^{th} percentage value (e.g., a 95^{th} percentage value) of the noise floor or background noise level that is measured at each control device. The threshold TH_{R2} for the second range may be set to a second N^{th} percentage value (e.g., a 75^{th} to 85^{th} percentage value) of the noise floor or background noise level that is measured at the control device.

In another example, the threshold TH_{R1} for the first range may be predefined. The threshold TH_{R2} for the second range may calculated as a function of the threshold TH_{R1} for the first range. For example, the threshold TH_{R2} for the second range may calculated as a multiple of the threshold TH_{R1} for the first range. The thresholds (e.g., TH_{R1} and/or TH_{R2}) may be scalable. The user may select or grab the thresholds on the graphical user interface displayed by the identifying device and move the location of the thresholds. The user may change each threshold independently. In another example, as the thresholds may be set based on a function of one another, the user may change the location of one threshold and the second threshold may be updated based on the function.

At 912, the control circuit of the identifying device may identify the control devices within the first range, for example, based on the threshold TH_{R1} for the first range that is determined at 908 and the measurement data that is received from the control devices. For example, the control circuit of the identifying device may receive the measurement data from the control devices and compare the channel quality metrics in the measurement data to the threshold TH_{R1} for the first range. The measurement data may be received via a separate communication network and/or protocol than the network on which the roles are being assigned. For example, the measurement data may be received via a short-range or direct wireless communication link that implements a short-range wireless communication protocol.

When the ranges are identified based on a communication quality metric of background noise levels, the identifying device may identify the configuration identifier of the control devices in the first range when the communication quality metric for the background noise levels in the measurement data is greater than the threshold TH_{R1} for the first range. In an example, the communication quality metric (e.g., RSSI) of the noise levels measured at the control device may be compared to threshold TH_{R1} for the first range that is based on the baseline background noise level to identify the control devices within the threshold TH_{R1} for the first range. When the ranges are identified based on a communication quality metric of messages received by control devices on the network, the identifying device may identify the configuration identifier of the control devices in the first range when the communication quality metric for the messages (e.g., link messages) received by the control devices on the network is less than the threshold TH_{R1} for the first range. The communication quality metric of the messages (e.g., link messages) measured at the control device may be compared to the threshold TH_{R1} for the first range to identify the devices within the threshold TH_{R1} for the first range.

At 913, the control circuit of the identifying device may assign the control devices in the first range to be end devices, for example, by storing and/or transmitting configuration data to the control device, where the configuration data indicates that the control devices should operate as end devices. The configuration data may include one or more configuration identifiers for the control devices identified as being in the first range and the configuration identifier may be associated with a role of end device or have a router-eligibility flag that is set to false. The identifying device may automatically transmit the configuration data for causing the control devices to be end devices at 913 after the identifying device identifies those control devices as being in the first range at 912. In another example, the identifying device may await additional configuration (e.g., user selection of the control devices to be assigned end devices, assignment of the roles of router devices, and/or other configuration) before transmitting the configuration data. The identifying device may provide feedback to a user on a graphical user interface to identify the control devices within the first range at 912, and the user may select the control devices in the first range to be assigned to be end devices at 913. The user may confirm that the control devices being identified as being within the first range should be assigned to be an end device through the application running on the mobile device, and the mobile device may transmit the configuration data to the control device to cause the control device to operate as an end device.

At 914, the control circuit of the identifying device may identify the control devices within the second range, for example, based on the threshold TH_{R1} for the first range, the threshold TH_{R2} for the second range, and the measurement data that is received from the control devices. For example, the control circuit of the identifying device may receive the measurement data from the control devices and compare the communication quality metrics in the measurement data to the threshold TH_{R1} for the first range and the threshold TH_{R2} for the second range. When the ranges are identified based on a communication quality metric of background noise levels, the identifying device may identify the configuration identifier of the control devices in the second range when the communication quality metric for the background noise levels in the measurement data is less than the threshold TH_{R1} for the first range and greater than the threshold TH_{R2} for the second range. In an example, the communication quality metric (e.g., RSSI) of the noise levels measured at the control device may be compared to the threshold TH_{R1} for the first range and the threshold TH_{R2} for the second range to identify the control devices within the thresholds. When the ranges are identified based on a communication quality metric of messages received by control devices on the network, the identifying device may identify the configuration identifier of the control devices in the second range when the communication quality metric for the messages (e.g., link messages) received by the control devices on the network is greater than the threshold TH_{R1} for the first range and less than the threshold TH_{R2} for the second range. The communication quality metric of the messages (e.g., link messages) measured at the control device may be compared to the threshold TH_{R1} for the first range and the threshold TH_{R2} for the second range to identify the devices within the threshold TH_{R1} for the first range and the threshold TH_{R2} for the second range.

At 916, feedback may be provided to a user to indicate the control devices that are identified as being within the second range and outside of the first rage, which may be eligible as being router devices. For example, the identifying device may provide feedback to a user on a graphical user interface to identify the control devices within the second range and outside of the first rage. In one example, the control circuit of the identifying device may execute software that causes a graphical user interface to display a floorplan of a space, as described herein. The floorplan may include icons (e.g., markers) of control devices at appropriate locations of on the floorplan. The identifying device may store a configuration identifier (e.g., an identifier indicating a fixture, group, zone, area, and/or location of the control device that may be defined by the configuration data generated by the design software) of the control device installed in the location of the icon, such that the configuration identifier can be associated with a role for being transmitted to the control devices. The control circuit of the identifying device may have stored in memory location data indicating the location of the control devices on the floorplan relative to one another within the space. The graphical user interface may highlight or otherwise indicate the control devices that are within the first range and/or the second range of the noise source. The graphical user interface may display the first range and/or second range (e.g., represented as dashed lines or another indicator of the control devices within the ranges) based on the devices identified as being within the first range and/or second range from the measurement data that is received from the control devices. In addition, the control circuit of the identifying device may display lines between the quadrants (e.g., represented by dashed lines between the quadrants). The control circuit of the identifying device may calculate a central location of the devices within the first range and/or second range on the graphical user interface the display lines between the quadrants from the calculated central location. The graphical user interface may include an icon (e.g., marker) of the noise source that is placed in the central location. The graphical user interface may display a direction indicator representing a direction from the noise source towards the network (e.g., towards most of the control devices of the network and/or the center of the space in which the network is to be deployed). The identifying device may automatically set and display the direction indicator starting at the central location of the control devices in the first range and/or the second range of the noise source on the floorplan indicate the direction of the center location of the group of control devices in the network or the center location of the space. The identifying device may display the keepout distance to allow the user to identify devices that are within a predefined range of one another.

Visible feedback may also, or alternatively, be provided by the control devices themselves to indicate the control devices that are identified as being within the first range and/or within the second range and outside of the first rage. For example, the identifying device may transmit one or more feedback messages configured to cause the identified control devices (e.g., the control devices that are identified within the first range and/or within the second range and outside of the first range) to provide visible feedback. The visible feedback may be provided by the message instructing the identified control devices to control the light emitted by a lighting load to a color or intensity, or flash the lighting load. A different type of feedback (e.g., different color, intensity, rate of flashing) may be used to indicate the control devices in the first range and the control devices in the second range that are outside of the first range.

The visible feedback may be provided with the graphical user interface that includes the floorplan, or with another graphical user interface that includes the configuration identifiers of the identified devices within each range and/or icons representing the control devices that are identified within each range. It may be difficult for the user to identify the control device in the space that corresponds to the icons or configuration identifiers of the control devices on the graphical user interface. The user may select the configuration identifier or corresponding icon on the graphical user interface and actuate a button on the graphical user interface that causes the identifying device to transmit one or more messages to the selected control device or devices that causes them to separately identify themselves in the space. The control device or devices that are identifying themselves may use a different type of feedback (e.g., different color, intensity, rate of flashing) to indicate the control device that is identifying itself in the space.

The number of router-eligible devices capable of being assigned around a noise source may be limited, as the number of router devices on the network may be limited. As such, the number of router-eligible control devices that are within the second range and outside of the first rage may exceed the number of router devices that may be assigned around a noise source. Providing the feedback to the user at 916 may allow the user to select router-eligible devices to be assigned the role of router devices, which may allow the user to select the positioning of the boundary router devices around the noise source (e.g., spacing between boundary router devices, positioning on the side of the second range that is directed towards the majority of the control devices of the network, etc.). If the number of router-eligible devices within the second range and outside of the first range does not exceed the number of router devices that may be assigned around a noise source, each of the router-eligible devices may be selected and/or assigned as boundary router devices by the identifying device.

As described herein, the control circuit of the identifying device may determine the number of boundary router devices per noise source, at 918. The number may be determined to prevent the number of boundary router devices that are assigned around a noise source from exceeding a predefined number of router devices. The number of boundary router devices may vary based on network size, the size of the space, the number of control devices, and/or the strength of the noise source. At 920, the identifying device may receive a user selection of one or more control devices to be assigned as a boundary router device. For example, when the mobile device is the identifying device, the user selection may be received via an actuation on the graphical user interface. When the system controller is the identifying device, the system controller may receive the configuration identifier of the one or more selected control devices from the mobile device.

At 922, the control circuit of the identifying device may assign the one or more selected control devices within the second range and outside of the first range to be a router device in the configuration data. The configuration data may include one or more configuration identifiers for the control devices identified as being within the second range and outside of the first range, and the configuration identifier may be associated with a role of router device or have a router-eligibility flag that is set to true. The identifying device may automatically transmit the configuration data in one or more message for causing the one or more control devices to store the role of router device in local memory. In another example, the identifying device may await additional configuration (e.g., user selection of other control devices to be assigned as router devices, assignment of the roles of other control device to be end devices, and/or other configuration) before transmitting the configuration data. The configuration data may be transmitted to a control device operating as a leader device on the network for communicating the roles to the control devices for enabling the control devices to operate in the assigned roles. The configuration data may be transmitted directly to the control devices themselves for enabling the control devices to operate in the assigned roles. The configuration data may be broadcast to the control devices in a list of control devices (e.g., indicating the roles of just the router devices, or assigning both router device and end device roles) for the control devices to identify their device role based on the list. In another example, the roles assignments may be communicated directly to the control devices from the identifying device. The roles may be communicated via the same communication link from which the control devices transmit the measurement data. After the control devices receive the messages that assign their respective roles, each control device may transmit a confirmation message to the identifying device and/or provide visible feedback indicating that the role has been stored (e.g., by controlling the light emitted by a lighting load to a color and/or intensity, or flashing the lighting load). The control devices may stop providing the visible feedback after storing the role in memory.

If there are more boundary router devices to assign for the noise source at 924 (e.g., the number of boundary router devices determined at 918 has not been reached), the identifying device may continue to assign the role to one or more control devices within the second range and outside of the first range to be a boundary router device in response to user selections at 920. If there are not more boundary router devices to assign for the noise source at 924, the procedure 924 may end at 924. If there are more noise sources in the space, the user may perform a similar procedure 900 to configure the roles of the control device around the next noise source.

Though FIG. 9A illustrates a procedure 900 that may be performed to identify control devices for being assigned certain roles (e.g., router device or end device) around a noise source based on user selection, a similar type of procedure may be performed by automatically selecting control devices and assigning roles to the control devices around the noise source. FIG. 9B is a flowchart of another example procedure 950 (e.g., a router adjustment procedure) that may be executed to assign roles to control devices of a network (e.g., that may be located close to or within a predefined transmission range of noise sources). For example, the example procedure 950 may be implemented to automatically select and/or assign roles to the control devices, as described herein. The procedure 950 may be executed during the configuration procedure (e.g., the claiming procedure and/or the association procedure) at 408 of procedure 400 or after the joining procedure at 412 of the procedure 400. The control devices that are being configured during the procedure 950 may be router-eligible devices (e.g., router-eligible end devices) capable of being assigned the role of router device or end device in the network. The procedure 950 may be executed by an identifying device. For example, the identifying device may be a mobile device or another computing device (e.g., a system controller or another computing device) capable of identifying control devices to be assigned as boundary router devices based on measurements performed at the control devices. Though the procedure 950 may be described as being implemented by a single device, one or more portions of the procedure 950 may be implemented by other devices. For example, the procedure 950 may be distributed across multiple identifying devices.

The procedure 950 may start at 952. The identifying device may start the procedure 950 at 952 in response to input received from a user. At 954, the control circuit of the identifying device may enter a router adjustment mode. When the identifying device is a mobile device, the control circuit of the mobile device may enter the router adjustment mode in response to an actuation of a button in an application running on the mobile device. When the identifying device is another computing device (e.g., a system controller) the input may be received in a message from the mobile device in response to an actuation of a button in an application running on the mobile device.

Steps 908-914 of the procedure 950 may be similar to the steps 908-914 of the procedure 900 illustrated in FIG. 9A. At 908, the control circuit of the identifying device may determine the thresholds (e.g., TH_{R1} and/or TH_{R2}) for the first range and/or the second range. As described herein, the thresholds may be determined by being calculated from measurements performed on the network, or may be predefined. For example, the thresholds may be based on measurement data at the identifying device and/or received from the control devices themselves. When the ranges are identified based on a communication quality metric of background noise levels, the control circuit of the identifying device may determine a baseline background noise level and calculate the thresholds (e.g., TH_{R1} and/or TH_{R2}) for the first range and/or the second range based on the background noise levels, as described herein. The thresholds (e.g., TH_{R1} and/or TH_{R2}) for the first range and/or the second range may also, or alternatively, be calculated based on the communication quality metrics of messages received on the network, as also described herein. For example, the thresholds (e.g., TH_{R1} and/or TH_{R2}) for the first range and/or the second range may be determined at 908 as a predefined values or an N^{th} percentage value of the communication quality metrics of messages received at the control devices on the network.

At 912, the control circuit of the identifying device may identify the control devices within the first range, for example, based on the threshold TH_{R1} for the first range that is calculated at 908 and the measurement data that is received from the control devices. In an example, the communication quality metric (e.g., RSSI) of the noise levels measured at the control device may be compared to threshold TH_{R1} for the first range to identify the control devices within the threshold TH_{R1} for the first range. When the ranges are identified based on a communication quality metric of background noise levels, the identifying device may identify the configuration identifier of the control devices in the first range when the communication quality metric for the background noise levels in the measurement data is greater than the threshold TH_{R1} for the first range. In another example, the communication quality metric of the messages (e.g., link messages) measured at the control device may be compared to the threshold TH_{R1} for the first range to identify the devices within the threshold TH_{R1} for the first range. When the ranges are identified based on a communication quality metric of messages received by control devices on the network, the identifying device may identify the configuration identifier of the control devices in the first range when the communication quality metric for the messages (e.g., link messages) received by the control devices on the network is less than the threshold TH_{R1} for the first range.

At 913, the control circuit of the identifying device may assign the control devices in the first range to be end devices, as described herein. As further described herein, the control circuit of the identifying device may identify the control devices within the second range at 914, for example, based on the threshold TH_{R1} for the first range, the threshold TH_{R2} for the second range, and the measurement data received from the control devices. When the ranges are identified based on a communication quality metric of background noise levels, the identifying device may identify the configuration identifier of the control devices in the second range when the communication quality metric for the background noise levels in the measurement data is less than the threshold TH_{R1} for the first range and greater than the threshold TH_{R2} for the second range. When the ranges are identified based on a communication quality metric of messages received by control devices on the network, the identifying device may identify the configuration identifier of the control devices in the second range when the communication quality metric for the messages (e.g., link messages) received by the control devices on the network is greater than the threshold TH_{R1} for the first range and less than the threshold TH_{R2} for the second range.

As the number of router-eligible control devices that are within the second range and outside of the first rage may exceed the number of router devices that may be assigned around a noise source, the identifying device may automatically determine the control devices that may be selected for being assigned as boundary router devices around the noise source. As described herein, the control circuit of the identifying device may determine the number of boundary router devices per noise source, at 918. The control circuit of the identifying device may automatically select a first boundary router device at 952.

The control circuit of the identifying device may automatically select the first boundary router device at 952 based on a signal strength of messages received from the router-eligible control devices that are within the second range and outside of the first range. For example, the identifying device may transmit a message to the router-eligible control devices that are within the second range and outside of the first range that causes the router-eligible control devices to respond with a message transmission. The messages may be communicated on a separate communication network and/or protocol than the network on which the roles are being assigned. For example, the messages (e.g., beacon messages) may be communicated via a short-range or direct wireless communication network that implements a short-range wireless communication protocol. The message that is transmitted by the identifying device may trigger the router-eligible control devices that are within the second range and outside of the first range to transmit one or more beacon messages. The identifying device may select the first boundary router device at 952 based on the communication quality metric values (e.g., RSSI values) at which the messages are received on the short-range or direct wireless communication network. For example, the control circuit of the identifying device may select the control device from which one or more messages are received with the highest value of the communication quality metric to be the first boundary router device at 952. This selection may enable the end devices that are within the first range and that are being affected by the noise source to attach to the closest router device or the router device capable of transmitting the strongest communications to devices within the first range around the noise source.

At 954, the control circuit of the identifying device may assign the selected control device within the second range and outside of the first range to be a router device in the configuration data. The configuration data may include a configuration identifiers for the control devices identified as being within the second range and outside of the first range, and the configuration identifier may be associated with a role of router device or have a router-eligibility flag that is set to true. The identifying device may automatically transmit the configuration data in one or more message for causing the one or more control devices to store the role of router device in local memory. In another example, the identifying device may await additional configuration (e.g., other control devices to be automatically assigned as router devices and/or other configuration) before transmitting the configuration data. After the control devices receive the messages that assign their respective roles, each control device may transmit a confirmation message to the identifying device and/or provide visible feedback indicating that the role has been stored (e.g., by controlling the light emitted by a lighting load to a color and/or intensity, or flashing the lighting load).

If there are more boundary router devices to assign for the noise source at 956 (e.g., the number of boundary router devices determined at 918 has not been reached), the identifying device may continue to automatically assign the role to one or more control devices within the second range and outside of the first range to be a boundary router device at 954. The next boundary router device may be automatically selected by the control circuit of the identifying device at 958, and the identifying device may assign the selected control device to be a router device at 954. For example, the control circuit of the identifying device may select the control device from which one or more messages (e.g., beacon messages) are received on the short-range or direct wireless communication network with the next highest value of the communication quality metric to be the next boundary router device at 958. The control circuit of the identifying device may continue to select and assign the boundary router devices based on the strength of the communication quality metric of the messages received on the short-range or direct wireless communication network.

The control circuit of the identifying device may attempt to separate the boundary router devices that are selected within the second range and outside of the first range. For example, the control devices that are within the second range and outside of the first range may receive the messages that are being transmitted by the other control devices on the short-range or direct wireless communication network. The control devices may generate a communication quality metric value (e.g., RSSI value) for the messages that are received from each of the other control devices and report these communication quality metric values to the identifying device. After selecting the first boundary router device at 952, the control circuit of the identifying device may user the communication quality metric values received from the first boundary router device to identify the next device that is selected as a boundary router device at 958. For example, the identifying device may select the control device from which the first boundary router device receives messages at the weakest communication quality metric value to be the next boundary router device at 958. The identifying device may continue to select the next boundary router device using the weakest communication quality metric values at the previously assigned boundary router device to space the boundary router devices around the noise source.

The control devices may be selected in an order of priority based on a device type. For example, certain types of control devices may have greater transmission capabilities than others and may be prioritized for being selected as a boundary router device at 952 and 958. For example, a system controller may have greater transmission capabilities over lighting control devices based on the hardware and/or location of the device. The lighting control devices may be assumed to be located near and/or surrounded by more metal due to being installed in the ceiling, which may reduce the success rate of transmissions. The prioritization based on device type may be combined with other embodiments described herein for selecting boundary router devices. For example, control devices having a highest priority of device type may be selected according to the communication quality metric of the messages that are received at the identifying device on the short-range or direct wireless communication network. If there are more boundary router devices to be selected after the highest priority devices have been assigned to be router devices, the control devices having the next highest priority of device type may be selected according to the communication quality metric of the messages that are received at the identifying device on the short-range or direct wireless communication network, until the boundary router devices have been assigned around the noise source.

If there are not more boundary router devices to assign for the noise source at 956, the procedure 950 may end at 960. If there are more noise sources in the space, the user may perform a similar procedure 950 to configure the roles of the control device around the next noise source.

When configuring the boundary router devices around different noise sources using an automated procedure, the identifying device may be capable of communicating with one or more of the same control devices. Such communications may cause issues with the selection and/or assignment of the roles of devices on the network. For example, the identifying device may receive the measurement data (e.g., including a communication quality metric of background noise levels and/or a communication quality metric of link messages received at the control devices) from the same control device when configuring a first noise source and a second noise source. Though the background noise levels measured at a control device may be caused by the first noise source, the identifying device may configure the role of the control device and/or other control devices based on background noise levels measured at the second noise source. To limit the devices being configured for a given noise source, the identifying device may be configured with the threshold for a third range TH_{R3} that defines the control devices capable of being assigned roles during the procedures (e.g., procedures 900 and/or 950) described herein. In an example, before or after the identifying device enters the router adjustment mode at 904 in FIG. 9A or at 954 in FIG. 9B, the identifying device may transmit a message to the router-eligible control devices that includes the threshold for the third range TH_{R3}. The control devices that receive the message above the threshold for the third range TH_{R3} may respond with a message comprising their configuration identifier. These control devices may be the devices that are considered by the identifying device when selecting and assigning the roles of the control devices at the identifying device. The messages may be communicated on a separate communication network and/or protocol than the network on which the roles are being assigned. For example, the messages (e.g., beacon messages) may be communicated via a short-range or direct wireless communication network that implements a short-range wireless communication protocol. In another example, the threshold for the third range TH_{R3} may be transmitted in the same message as the request for the background noise information from the control devices, such that the control devices that receive the message above the threshold for the third range TH_{R3} may respond with their background noise levels.

Although features and elements are described herein in particular combinations, each feature or element can be used alone or in any combination with the other features and elements. The methods described herein may be implemented in a computer program, software, instructions, or firmware stored on one or more non-transitory computer-readable media or other machine-readable media for execution by a computer or machine, or portion thereof. For example, the computer-readable or machine-readable media may be executed by a control circuit, such as a processor. Examples of computer-readable media or machine-readable media include electronic signals (transmitted over wired or wireless connections) and computer-readable storage media. Examples of computer-readable storage media include, but are not limited to, a read only memory (ROM), a random access memory (RAM), removable disks, and optical media such as CD-ROM disks, and digital versatile disks (DVDs). The control circuit may access the computer program, software, instructions, or firmware stored on the computer-readable media or machine-readable media for being executed to cause the control circuit to operate as described herein, or to operate one or more devices as described herein.

What is claimed is:

1-30. (canceled)

31. A device comprising:
a control circuit configured to:
identify at least one control device outside of a first range from the noise source and within a second range from the noise source; and
assign the at least one control device outside of the first range and within the second range to operate as a router device in the network.

32. The device of claim 31, wherein the control circuit is configured to:
identify at least one control device within the first range; and
assign at least one control device within the first range to operate as an end device in the network.

33. The device of claim 32, wherein the control circuit is configured to assign the role of the router device and the role of the end device in response to a user selection on a graphical user interface.

34. The device of claim 33, wherein the device further comprises a display, and wherein the control circuit is further configured to:
display, via the display, the first range and the second range on the graphical user interface, wherein the first range has a first radius, and wherein the second range is defined by the first radius and a second radius.

35. The device of claim 33, wherein the control circuit is further configured to store the role of the router device and the role of the end device in configuration data for being uploaded to control devices during a commissioning procedure.

36. The device of claim 35, wherein the control circuit is configured to transmit the configuration data to a mobile device configured to utilize the configuration data during the commissioning procedure.

37. The device of claim 32, wherein the control circuit is configured to automatically assign the role of the end device after identifying the at least one control device as being within the first range.

38. The device of claim 37, wherein the control circuit is configured to automatically assign the role of the router device after identifying the at least one control device as being closer to other control devices in the network that are outside of the second range than other control devices in the network that are also outside of the first range and within the second range.

39. The device of claim 32, further comprising:
a communication circuit configured to receive respective control device beacon messages from the at least one control device within the first range and the at least one control device that is within the second range and outside of the first range, and wherein the control circuit is configured to identify the at least one control device in the first range based on a received signal strength of the control device beacon messages, and wherein the control circuit is configured to identify the at least one control device in the second range based on a received signal strength of the control device beacon messages.

40. The device of claim 39, wherein the control circuit is further configured to:
transmit, via the communication circuit, a locating beacon message configured to trigger the transmission of the control device beacon messages.

41. The device of claim 39, wherein the control circuit is further configured to:
transmit, via the communication circuit, a first feedback message configured to cause the at least one control device within the first range to provide a first feedback type; and
transmit, via the communication circuit, a second feedback message configured to cause the at least one control device within the second range to provide a second feedback type.

42. The device of claim 41, wherein the control circuit is further configured to:
determine a control device beacon received from a control device in the first range at a greatest signal strength of the control device beacons in the first range; and
transmit the first feedback message to the control device.

43. The device of claim 41, wherein the control circuit is further configured to:
determine a control device beacon received from a control device in the second range at a greatest signal strength of the control device beacons in the second range; and
transmit the second feedback message to the control device.

44. The device of claim 31, wherein the control circuit is further configured to:
identify a direction from the noise source toward a center of the network; and
identify the at least one control device as being in the direction from the noise source toward the center of the network before assigning the role of router device to the at least one control device.

45. The device of claim 43, wherein the number of boundary router devices is greater than one, and wherein the control circuit is further configured to:
identify the at least one control device as being in one of a predefined number of sections in the direction from the noise source toward the center of the network before assigning the role of router device to the at least one control device.

46. The device of claim 31, wherein the at least one control device that is assigned the role of the router device comprises a first control device and a second control device, and wherein the control circuit is further configured to:
identify a keepout distance from the first control device; and
identify the second control device as being at least the keepout distance from the first control device before assigning the role of the second control device as the router device in the network.

47. The device of claim 45, further comprising a display configured to display the first control device, the second control device, and a third control device, wherein the third control device is within the keepout distance from the first control device, and wherein the control circuit is further configured to:
enable user selection of the second control device for being assigned the role of the router device based on the second control device being at least the keepout distance from the first control device; and
disable user selection of the third control device for being assigned the role of the router device based on the third control device being within the keepout distance from the first control device.

48. The device of claim 31, further comprising memory and a communication circuit, and wherein the control circuit is further configured to:
store, in the memory, the role of the at least one control device in configuration data with an identifier of the at least one control device; and
transmit, via the communication circuit, the configuration data to the at least one control device.

49-67. (canceled)
